(19) United States
(12) Patent Application Publication
(10) Pub. No.: US 2019/0160529 A1
(43) Pub. Date: May 30, 2019

(54) Furnace For Sintering Printed Objects

(71) Applicant: Desktop Metal, Inc., Burlington, MA (US)

(72) Inventors: Aaron Silidker, Guilford, CT (US); Richard Remo Fontana, Cape Elizabeth, ME (US); Brian Kernan, Andover, MA (US); Mark Sowerbutts, Townsend, MA (US); Tomek Brzezinski, Lynnfield, MA (US); Ricardo Fulop, Lexington, MA (US); Leon Fay, Lexington, MA (US); Daniel R. Jepeal, Andover, MA (US)

(21) Appl. No.: 16/204,835

(22) Filed: Nov. 29, 2018

Related U.S. Application Data
(60) Provisional application No. 62/592,196, filed on Nov. 29, 2017.

(51) Int. Cl. B22F 3/00; B33Y 40/00; F27D 7/06; F27D 19/00; F27D 17/00

(52) U.S. Cl. CPC B22F 3/003; B33Y 40/00; B22F 3/225; F27D 19/00; F27D 17/008; F27D 7/06

(57) ABSTRACT

A materials processing furnace provides for debinding and sintering objects and treating effluent generated by the sintering. A heating chamber maintains a controlled atmosphere for sintering the object. A vacuum pump evacuates an effluent from the heating chamber, and an injector adds a reagent to the evacuated effluent to form a mixed gas. A catalytic converter receives the mixed gas and catalyzes one or more hazardous or offensive compounds of the effluent, thereby converting the effluent to a safer and less offensive exhaust. As a result, the furnace is suitable for operation in an office environment.

### RELATED APPLICATION

This application claims the benefit of U.S. Provisional Application No. 62/592,196, filed on Nov. 29, 2017. The entire teachings of the above application are incorporated herein by reference.

### BACKGROUND

Metal injection molding (MIM) is a metalworking process useful in creating a variety of metal objects. In an embodiment of MIM, a mixture of powdered metal and binder (e.g., a polymer such as polypropylene) can form a “feedstock” capable of being molded, at a high temperature, into the shape of a desired object. The initial molded part, also referred to as a “green part,” can then undergo a chemical preliminary debinding process to remove primary binder while leaving secondary binder intact, followed by a sintering process. During sintering, the part can be brought to a temperature near the melting point of the powdered metal, which thermally decomposes any remaining binder and forms the metal powder into a solid mass, thereby producing the desired object.

Additive manufacturing, also referred to as 3D printing, includes a variety of techniques for manufacturing a three-dimensional object via a process of forming successive layers of the object. 3D printers can in some embodiments utilize a feedstock comparable to that used in MIM, thereby creating a green part without the need for a mold. The green part may then undergo debinding and sintering processes to produce the object.

In addition to MIM based additive manufacturing, there are systems using powder beds, optical resin curing, and others. Many such methods require a furnace process to produce the final part or enhance the properties of the part. The materials making up the part may include ceramics and composites as well as metals. Additionally, there are conventional materials that can benefit from furnace processing.

### SUMMARY

Example embodiments may include a materials processing furnace comprising a sintering chamber, an exhaust assembly, and an oxidizing catalyst. The sintering chamber may be configured to maintain a controlled atmosphere, the controlled atmosphere being substantially free of oxygen. The exhaust assembly may be configured to 1) evacuate effluent from the sintering chamber, the effluent including at least one compound produced by sintering an object within the sintering chamber, and 2) limit oxygen backflow from the exhaust assembly into the sintering chamber. The oxidizing catalyst may be configured to 1) receive a mixed gas comprising the effluent and oxygen, and 2) catalyze the at least one compound.

The exhaust assembly may include a vacuum pump configured to evacuate the effluent from the sintering chamber, the evacuating contributing to limiting the oxygen backflow. The controlled atmosphere may have a pressure of approximately 1 atm, or a pressure greater than 1 atm. Alternatively, the controlled atmosphere may be a vacuum or a partial vacuum having a pressure less than 1 atm. The exhaust assembly may include a channel configured to convey the effluent at a range of flow rates, the channel having a length and cross-sectional area sufficient to limit the oxygen backflow by preventing the oxygen backflow during the evacuation of the effluent at least for the range of flow rates.

The furnace may further include a process gas injection arrangement configured to inject a process gas into the sintering chamber, the exhaust assembly evacuating the process gas with the effluent from the sintering chamber. The exhaust assembly may include an isolator configured to 1) convey the effluent from an entrance to the exhaust assembly toward the catalyst, and 2) limit the oxygen backflow by preventing flow of the mixed gas into the sintering chamber. The controlled atmosphere may have an oxygen content below 1000, 100, 10 or 1 ppm.

The furnace may further include an injector configured to add the oxygen to the effluent to form the mixed gas. A heater may be configured to heat the mixed gas prior to entry into the oxidizing catalyst. A controller may be configured to control the heater as a function of a temperature of the mixed gas before entry into the oxidizing catalyst. The controller may be further configured to detect the temperature of the mixed gas based on a measured property of a heating element of the heater. An insulated housing may at least partially encompass the oxidizing catalyst.

The furnace may further include a vacuum pump having a pump inlet into which the effluent is evacuated, a pump outlet, and a ballast arrangement disposed therebetween, the ballast being configured to introduce ballast gas including the oxygen within the pump. The furnace may also include a gas sensor configured to detect a quantity of oxygen in the mixed gas, and a flow controller configured to control a volume of the oxygen added to the effluent as a function of a quantity of the oxygen detected by the gas sensor. A condensate trap may be configured to condense and collect at least one binding agent from the effluent. A flow controller may be configured to selectively direct the effluent through the condensate trap. At least one filter may be configured to trap at least one additional compound of the effluent.

A vacuum pump may be configured to output the effluent at a maximum rate of 2 CFM, and may be configured to receive the effluent at a temperature of less than 300 C. A heater may be configured to increase the temperature of the mixed gas to at least 200 C, and/or may heat the oxygen prior to addition to the effluent. The oxidizing catalyst may be configured to receive the mixed gas at a temperature of less than 50 C and catalyze the at least one compound. The oxidizing catalyst may be a first oxidizing catalyst, and a second oxidizing catalyst may be configured to receive the effluent before the effluent is mixed with the oxygen. A controller may be configured to adjust a temperature of the controlled atmosphere based on a temperature at the oxidizing catalyst. The furnace may further include a catalytic converter including the oxidizing catalyst, the catalytic converter being configured to store the oxygen and release the oxygen into the effluent.

Further embodiments may include a catalytic converter comprising an entrance channel, a heater, a catalyst channel, and an outlet. The entrance channel may be configured to receive an effluent from a furnace. The heater may be configured to heat the effluent. The catalyst channel may be in fluid communication with the entrance channel and may be configured to 1) receive a mixed gas comprising the oxygen and the effluent and 2) catalyze at least one compound of the effluent, the catalyst channel conducting heat from the entrance channel via a lateral edge adjacent to the entrance channel and the catalyst channel. The outlet may be configured to expel an exhaust gas from the catalyst channel.

The catalyst channel may extend parallel to a lateral portion of the entrance channel. The catalyst channel may surround the lateral portion of the entrance channel. The catalyst channel may include an inner channel extending adjacent to the entrance channel at the lateral wall, and an outer channel extending adjacent to the inner channel at an outer wall opposite of the lateral wall. The inner channel may include a first catalyst to catalyze the at least one compound of the effluent.

The outer channel may include a second catalyst to catalyze an additional compound of the effluent. The outer wall may be further configured to conduct heat from the inner channel to the outer channel. The inner channel may direct the mixed gas in a first direction parallel to the lateral wall, and the outer channel may direct the mixed gas in a second direction opposite of the first direction. An insulated housing may encompass the heater and the catalyst. The catalytic converter may include a catalyst upstream of the oxygen injection point. The catalytic converter may further include an exhaust assembly configured to 1) evacuate the effluent from the furnace to the entrance channel, and 2) limit oxygen backflow from the exhaust assembly into the furnace.

Further embodiments may include a catalytic converter comprising an inner channel, a heater, a catalyst, and outer channel, and an outlet. The inner channel may be configured to receive a mixed gas including an effluent from a furnace and oxygen. The heater may be configured to heat the mixed gas in the inner channel. The catalyst may be configured to catalyze at least one compound of the effluent in the inner channel. The outer channel may surround at least a portion of the inner channel. The outlet may be configured to expel an exhaust gas from the outer channel.

The outer channel may direct the exhaust gas along at least a portion of a wall common to the inner channel and outer channel. The outer channel directs the exhaust gas in a direction counter to a direction of the mixed gas through the inner channel. The outer channel may form a shell around the inner channel and defines a volume adjacent to the inner channel, and the outer channel may direct the exhaust gas substantially away from the volume and toward the outlet. The catalytic converter may further include an exhaust assembly configured to 1) evacuate the effluent from the furnace to the entrance channel, and 2) limit oxygen backflow from the exhaust assembly into the furnace.

Example embodiments may further include a materials processing furnace comprising a heating chamber, a vacuum pump, an injector, and a catalytic converter. The heating chamber may be configured to maintain a controlled atmosphere. The vacuum pump may be configured to evacuate an effluent from the heating chamber, where the effluent includes at least one compound. The injector may be configured to add a reagent to the effluent evacuated by the vacuum pump to form a mixed gas including the reagent and the at least one compound. The catalytic converter configured to receive the mixed gas and catalyze the at least one compound.

The catalytic converter may include a heater, or a heater may be included in one or more gas streams. The heater may be further configured to heat gas prior to entry into a catalyst of the catalytic converter. A controller may be configured to control the heater as a function of a temperature of the mixed gas before entry into a catalyst of the catalytic converter. A controller may be configured to control the heater as a function of the catalyst temperature. The catalytic converter may further include an insulated housing at least partially encompassing a catalyst. The vacuum pump may include a pump inlet into which the effluent is evacuated, a pump outlet, and a ballast arrangement disposed therebetween. The ballast may be configured to introduce ballast gas within the pump, and the injector may add the reagent as a portion of the ballast gas such that the mixed gas is formed within the pump and exits the pump through the pump outlet.

The furnace may further comprise a gas sensor and a flow controller, where the gas sensor may be configured to detect a quantity of reagent in the mixed gas. The flow controller may be configured to control a volume of the reagent added by the injector as a function of a quantity of the reagent detected by the gas sensor. A condensate trap may be configured to condense and collect at least one binding agent from the effluent. The flow controller may be configured to selectively direct the effluent through the condensate trap.

The furnace may further comprise at least one filter configured to trap at least one additional compound of the effluent. The vacuum pump may be configured to output the effluent at a maximum rate of 2 CFM, and configured to receive the effluent at a temperature of less than 300 C. The heater may be configured to increase the temperature of the mixed gas to at least 200 C. Alternatively, or in addition, the heater may be configured to heat the reagent prior to addition to the effluent. The catalytic converter may include a catalyst configured to receive the mixed gas at a temperature of less than 50 C and catalyze the at least one compound. The catalytic converter may also include a catalyst upstream of the reagent injection point.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a block diagram illustrating a conventional furnace system.

FIG. 2 is a block diagram of a furnace system in which example embodiments may be implemented.

FIG. 3 illustrates an external view of an embodiment of a furnace system.

FIG. 4A is a block diagram of an embodiment of a furnace system.

FIG. 4B is a block diagram of an embodiment of a furnace system.

FIG. 4C is a block diagram of an embodiment of a furnace system.

FIG. 5 is a block diagram of an effluent treatment stage implementing a catalytic converter.

FIG. 6 illustrates an embodiment of an effluent system including a catalytic converter and air injection.

FIG. 7 illustrates an embodiment of an effluent system including a vacuum pump with a ballast gas stream.

FIG. 8A-B is a diagram of an embodiment of a vacuum pump with a ballast gas stream.

FIG. 9 is a block diagram of an embodiment of a furnace effluent system.

FIG. 10 is a block diagram of an embodiment of a catalytic converter and pump.

FIG. 11A-C illustrate embodiments of systems having catalytic converters and vacuum pumps in further configurations.

FIG. 12 illustrates an embodiment of a catalytic converter.

FIGS. 13A-C are diagrams of embodiments of systems having a catalytic converter.

FIGS. 14A-B are diagrams of embodiments of systems having a catalytic converter.

FIGS. 15A-D are diagrams of embodiments of furnace effluent systems.

FIG. 16A-E are diagrams of embodiments of furnace effluent systems.

FIG. 17 is a diagram of an embodiment of a catalytic converter.

FIG. 18 is a block diagram of an embodiment of a furnace system.

FIGS. 19A-B shows portions of an embodiment of a catalytic converter.

FIG. 20 shows portions of an embodiment of a catalytic converter.

FIGS. 21A-B are diagrams illustrating embodiments of catalytic converters.

FIG. 22 is an embodiment showing the catalyst located within the furnace.

FIG. 23 is a graph of temperature vs. time for an embodiment of a furnace with an embodiment of an effluent system having a catalytic converter.

FIG. 24 is a graph of temperature vs. time for an embodiment of a furnace with an embodiment of an effluent system having a catalytic converter.

FIG. 25 is an embodiment with interlaced flow passages

FIG. 26 is an embodiment of a catalyst structure.

FIG. 27 is an embodiment of a catalyst structure.

FIG. 28 is an embodiment of a catalytic converter structure.

FIG. 29 is a block diagram of an embodiment of a furnace system.

### DETAILED DESCRIPTION

A description of example embodiments follows.

An additive manufacturing process can produce a “green” (unsintered) part, which can undergo further processing to provide a finished part. This processing can include debinding, which can include chemical debinding (removing various binding agents through the use of solvents), reactive debinding (exposing the parts that are green or partially debinded to material such as a gas that reacts or causes a reaction with binding agent(s) or other materials present in the part or with the metal or other particles that make up the part to cross-link or otherwise render the binder or other materials more easily removed), and/or thermal debinding (utilizing heat to evaporate or decompose binding agents and other materials present within the part). In some embodiments of debinding processes, one type of debinding can be combined with another type, such as where heat and reaction are used together during a debinding step, such as when heat is applied while reactive moieties are present that can react with binding agents or other species present in the part. The processing can also include sintering, wherein the part is heated in a furnace to bring its temperature near the melting point of the powdered metal, which thermally decomposes any remaining binder and forms the metal powder into a solid mass, thereby producing the finished part.

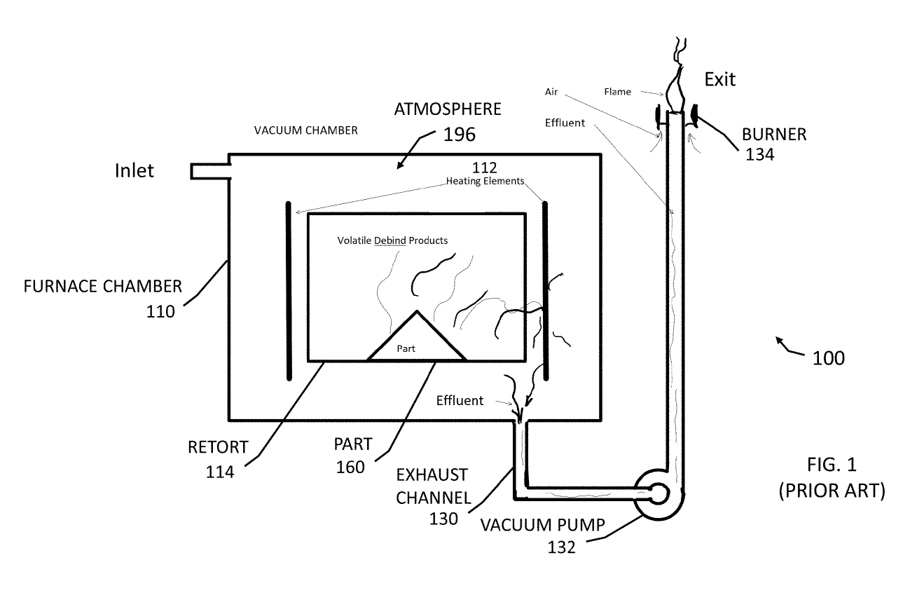

FIG. 1 illustrates a conventional furnace system 100 implemented in a lab or industrial setting. A furnace chamber 110 encloses a controlled atmosphere that is heated by heating elements 112. A retort 114, positioned between the heating elements 112, defines a volume in which a part 160 is placed for processing. For purposes of this disclosure, controlled atmosphere can be regarded as being controlled for one or more of temperature, composition and pressure and in various embodiments can comprise gas and/or effluent. As the part 160 is heated during sintering, it releases volatile debind products as a gaseous effluent into the atmosphere 196 of the chamber 110. A vacuum pump 132 directs this effluent through an exhaust channel 130, which terminates with a gas burner 134 to form an open-flame burn-off stack. Here, the effluent passes through the gas burner 134 and is combusted.

Furnaces for processing metal powders, such as the conventional furnace system 100 and embodiments described below, can provide for internal atmosphere control by way of processing gases that are circulated through the furnace and exhausted. A gas inlet system can provide for relatively pure gases at controllably variable flow rates that can vary from one process to another and may be variable during the course of a given process. Some such systems can also require there to be exhaust flow out from the furnace to remove process gases as well as any effluent products that can arise as by-products of the processing. Some furnace systems can produce various effluent products including hydrocarbons, carbon monoxide, hydrogen and other gases at least some of which can be at best merely unpleasant or at worst harmful and/or flammable and/or explosive in certain conditions. Industrial furnaces may exhaust to the exterior of the building and/or utilize a flame on the furnace exhaust stream to burn at least some gasses. In some cases, it may be acceptable to ventilate directly into the interior of a well-ventilated and large industrial building. Such industrial approaches are generally not suitable for an office environment where air quality in the office and local outdoor environments have stringent standards and where occupants might not wear protective safety gear.

Furnaces and furnace chambers can be sealed, for example, to allow vacuum operation, to exclude outside contaminants, to contain reactive species, to contain a controlled atmosphere, and/or to maintain a positive pressure. Furnace chambers can be sealed by any appropriate method, depending upon the degree of sealing desired, location of seal, temperature and environmental conditions, and sealing methods can include, but are not limited to elastomeric seals, metal seals, gaskets, weld joints, and labyrinth seals. Sealed furnace chambers can be fabricated from a variety of materials including metal (including but not limited to steel, stainless steel, aluminum), ceramic such as mullite, or alumina.

Many powder metal processing furnaces require or utilize two stages of processing that are typically performed sequentially, where both steps can be completed in one operational cycle. The first stage includes heated decomposition of the binder material, which produces a variety of heated effluents. After cooling when being evacuated, some of the effluent remains gaseous, and some of the effluent condenses into liquid and/or solid. Many of the effluent gasses are hydrocarbons, some of which can be hazardous; thus, it may be advantageous to limit exposure to personnel. Treatment or capture options might be considered for exhaustion into an office environment. The second stage includes sintering of the metal, which typically occurs at high temperatures and produces primarily a gas effluent. Generally, a mix of gaseous species are produced, often including oxygenated molecules. When certain species such as CO, which is toxic, are emitted, control measures should be considered prior to exhausting into an office environment in high concentrations. Under some conditions, hydrogen gas can be present in the effluent. H2 and CO can also be flammable under some conditions, and suitable control measures can be considered prior to release in an office environment for fire safety as well as health concerns. In large industrial systems, the effluent products can be combusted in a flame or burner to reduce hazardous hydrogen, hydrocarbon, and CO concentrations before they are exhausted to outside the building, as shown in FIG. 1.

Example embodiments described herein include a furnace system more amenable to an office environment. Such embodiments can include systems and methods of managing effluent that reliably produce a safer and less offensive effluent. An office-friendly system, as described herein, can be operated indoors without special ventilation while maintaining a safer and less offensive office environment, and, in some embodiments, have potential for being used without further effluent control systems.

Equipment and techniques described herein for additive manufacturing can, in some embodiments, also be applicable to MIM-based additive manufacturing as well as other forms of manufacturing, such as methods that involve powder beds, optical resin curing, sintering and heat treatment and others. Many such methods require a furnace process to produce the final part or enhance the properties of the part. The materials making up the part can, in various embodiments, include ceramics and composites as well as metals.

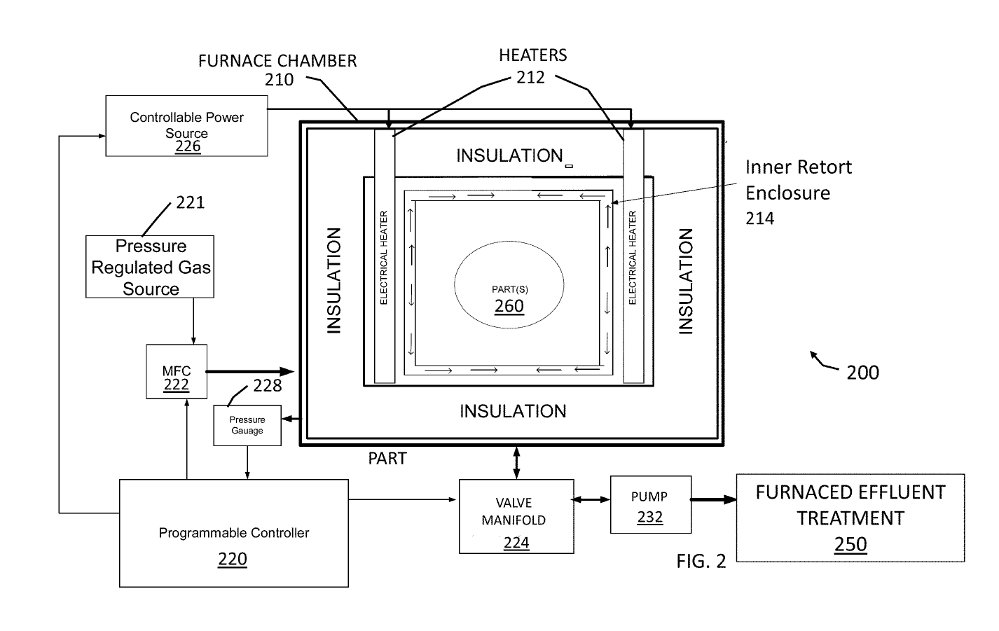

FIG. 2 is a block diagram of a furnace system 200 in which example embodiments may be implemented. A sealable, insulated furnace chamber 210 encloses a controlled atmosphere that can be heated by heaters 212. A retort 214 may define a volume in which a part 260 is placed for processing, and may include heat-conductive walls (e.g., graphite) to spread the heat generated by the heaters 212 throughout the volume, enhancing temperature uniformity in the region where the part 260 are placed and/or shelved. The retort 214 may also be utilized as a microwave applicator and, in an example embodiment, may define a graphite box with walls partially or fully enclosing the region accommodating the part 269.

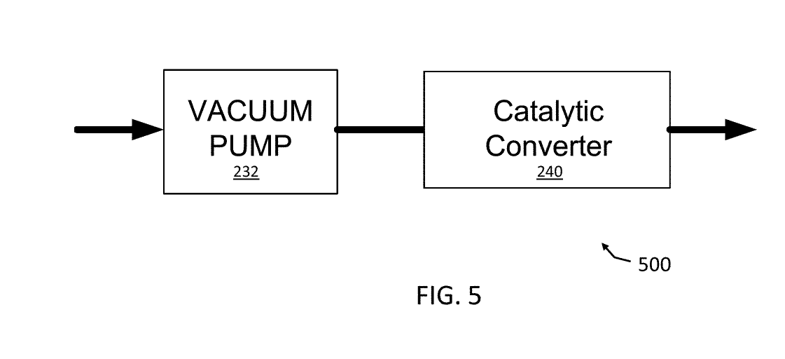

To carry out a sintering process to sinter the part 260, a programmable controller 220 may control a power source 226 to engage the heaters 212 in accordance with a heating profile and/or measured conditions of the furnace chamber (e.g., temperature and pressure). As the part 260 is heated during sintering, it may release volatile debind products as a gaseous effluent into the atmosphere of the chamber 210. To evacuate this effluent from the chamber 210, the controller 220 may control a valve manifold 224 and a vacuum pump 232. The valve manifold 224 may selectively enable flow of the effluent to an exhaust channel, and the vacuum pump 232 may direct this effluent to an effluent treatment assembly 250. The effluent treatment assembly 250 may operate to capture, neutralize and/or chemically convert one or more compounds of the effluent. Example effluent treatment assemblies are described in further detail below, with reference to FIGS. 5-29.

The furnace system 200 may also control the atmosphere within the furnace chamber, the pressure within the furnace chamber (vacuum, atmospheric, positive pressure) and/or partial pressure of species present inside the furnace chamber in a variety of ways. For example, the system 200 may implement component gas lines, pumps, and a mass flow controller (MFC) 222, under control of the controller 220, to adjust or toggle vacuum pumping action against the inlet gas flow from a gas source 221. The controller 220 may operate the MFC 222 to maintain a target pressure within the furnace chamber 210 based on the detected pressure (indicated by a pressure gauge 228) and or a detected temperature. It is also possible to operate the furnace system 200 with no gas flow and to achieve desired vacuum pressure by balancing the pumping action against gas that emanates from the part itself. For example, during debinding a substantial amount of gas (e.g., one or more of hydrocarbons, carbon monoxide, and/or other compounds) can emanate from the part itself In either case, pumping rate can be regulated by one or more of (i) continuously by using an adjustable valve, (ii) with on-off control by toggling a vacuum valve on and off, (iii) controlling furnace power/temperature, and (iv) controlling inflow gas pressure. One or more modes can be used to establish and hold a desired pressure at any given time. In general, pressure can be controlled by maintaining a balance between total gas flow, the difference between pumping speed, and the combination of inlet gas flow and off gassing produced by the part and water vapor in the furnace chamber, which can be affected by the temperature and heating rate of the material being processed.

Process gas can be required for many furnace processing operations. During such operations, the process gas can be routed from a source, such as a tank (either centralized or portable), to the point of use, and flow can be regulated (e.g., through a MFC 222). Even when no process gas is utilized, there is often substantial gas production from volatilization and/or chemical reactions involved in furnace operation, which, in turn, can be exhausted as effluent. With or without inlet process gas, in many applications the effluent exiting from the vacuum pump can be unpleasant and/or hazardous. As described above, in some furnace systems, such as those found in industrial settings, the effluent can be vented or burned (as shown in FIG. 1) in a manner that may be highly unsuitable to office operation.

Although vacuum operation can be used for various embodiments described herein, and is described with reference to example embodiments presented herein, embodiments of processes and steps of processes described herein can also be run successfully at or above atmospheric pressure.

Example embodiments described below include a furnace and effluent conversion system that can reduce or eliminate the aforementioned hazardous or undesirable limitations and can render a system more suitable for an office environment.

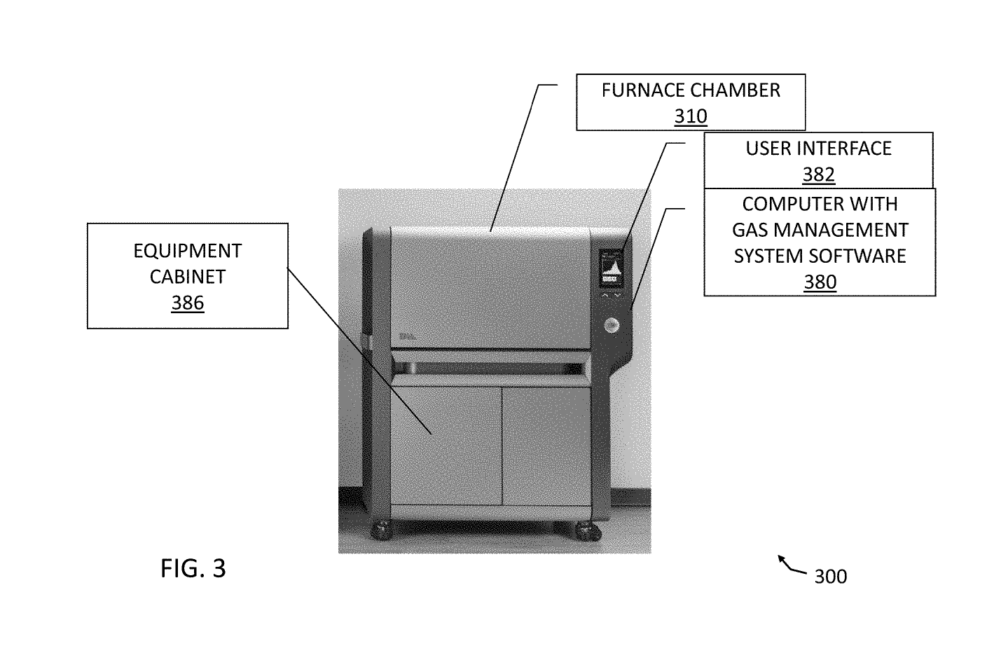

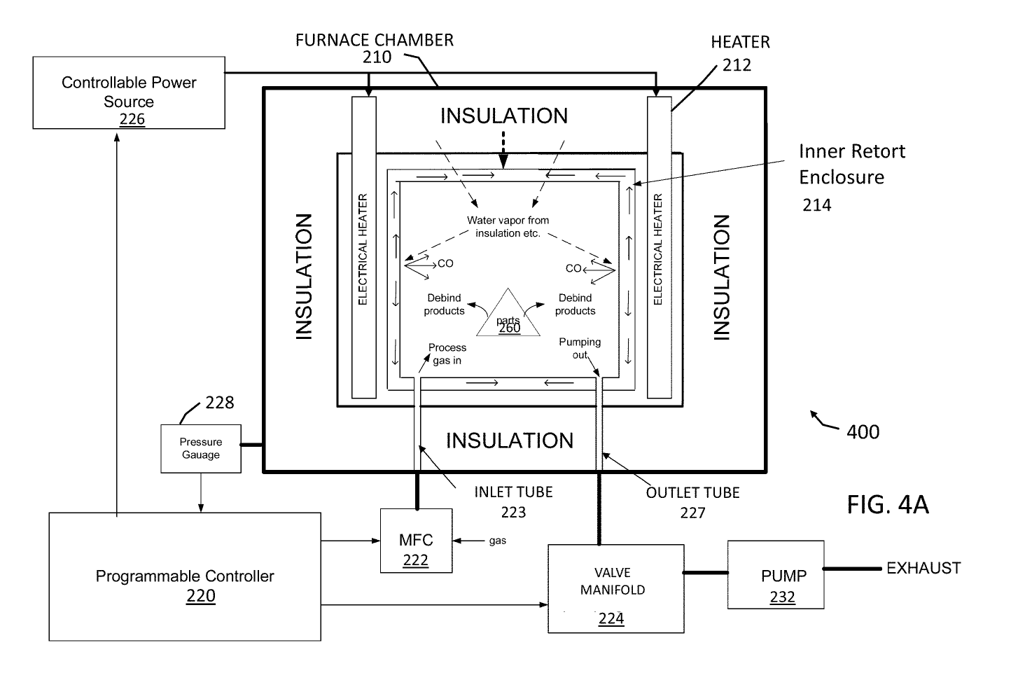

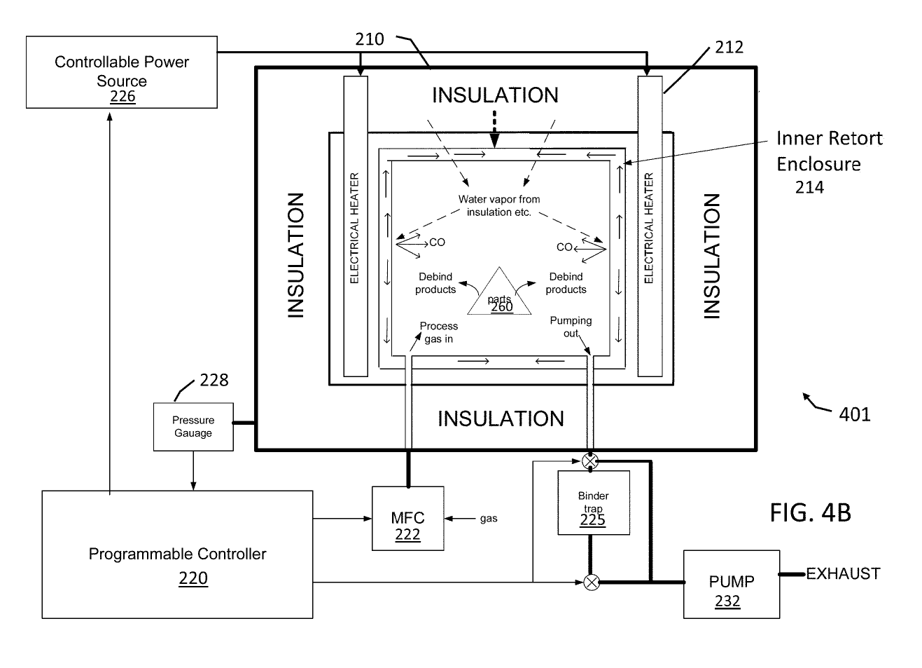

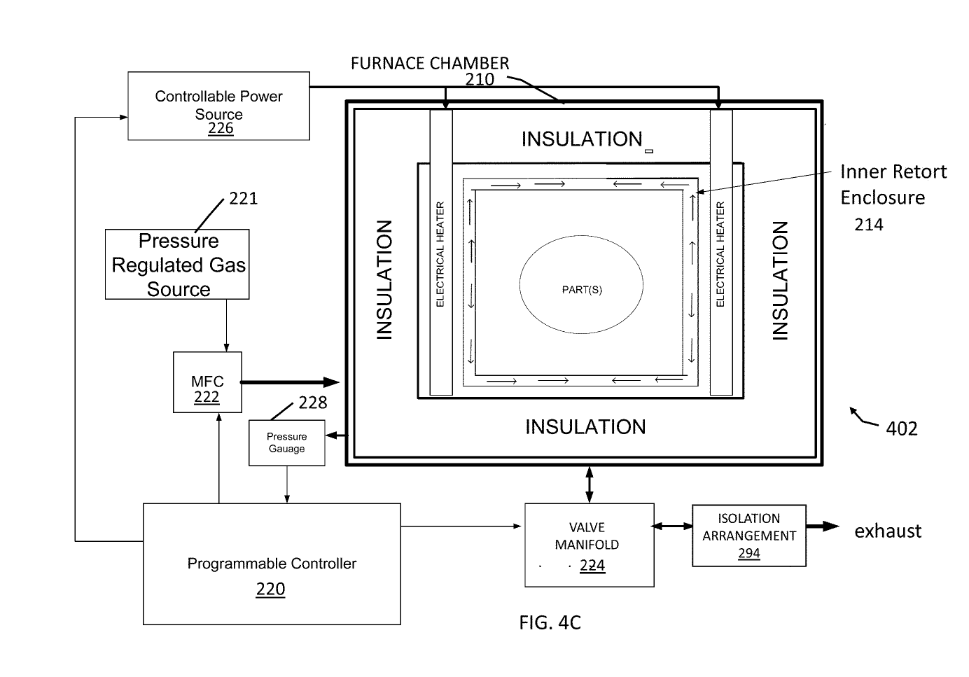

FIG. 3 illustrates an external view of a furnace system 300 in one embodiment. This system 300, also referred to as an office-friendly furnace system, can be a compact, self-contained unit. The system 300 may incorporate some or all of the features of the furnace system 200 described above with reference to FIG. 2, or may incorporate any of the features described below with reference to FIGS. 4-29. A furnace chamber 310 is positioned within an upper enclosure. An equipment cabinet 386, below the furnace chamber 310, may house some or all of the components external to the furnace chamber 310, including components to provide effluent control, vacuum pumps, and gas supply tanks. A user interface 382 may include a display and/or touchscreen to enable a user to manage a sintering operation and view the status of the operation. A computer system 380 may interface with the user interface 382, and may implement a controller, such as the controller 220 described above, to control operation of the furnace system 300.

In some embodiments, an effluent control system as implemented in the furnace system 300 can reduce undesirable species and/or conditions, and in some embodiments, an effluent control system can produce a reliably safe effluent that is safe and comfortable for office occupants and meets appropriate regulatory requirements. A furnace system in example embodiments can reliably convert effluent species primarily into water and CO2 and, in some embodiments, the furnace may output only trace and safe amounts of offensive gas content and would not utilize a flame for treatment of the effluent species.

FIGS. 4A-C illustrate furnace systems 400, 401 in example embodiments, which may be implemented in the furnace system 300 described above with reference to FIG. 3. The furnace systems 400, 401 may also include some or all features of the system 200 of FIG. 2. Referring to FIG. 4A, in addition to the components described above with reference to FIG. 2, the furnace system 400 includes an internal inlet tube 223 connected to the MFC 222 to guide inlet gases directly into the retort 214 (e.g., a graphite box) and an internal outlet tube 227 for expelling gasses (e.g., effluent) from the retort 214. The tubes 223, 227 can be of any material suitable for the temperatures and conditions that the tube would experience when in use, such as tubes comprising ceramics (such as alumina, mullite, other silicates, zirconia, or other oxides), carbon-based materials (such as graphite, carbon-carbon composite, or other carbon containing matrices), metals such as high temperature alloys or metals (such as Inconel, Hastelloy, molybdenum, and tungsten) or some other high-temperature material suitable for the temperatures and environmental conditions that they would experience when in use. There is no requirement with respect to this embodiment that the tube should be particularly well sealed to the retort walls, or that the retort itself is sealed, but the tube and/or retort can be so sealed. In many cases, the components inside the furnace chamber 210 (e.g., portions of the retort 214, the tubes 223, 227, and the interface therebetween) can fit together somewhat loosely and that there can be a substantial amount of gaseous communication between the inside of the retort where the parts are placed and/or shelved, and the outside of the retort where the insulation is disposed such as through joints, contacting surfaces or through porosity of the relevant parts, or the parts can be non-porous and/or sealed.

In various embodiments, at least a portion of any water vapor emitted from the insulation can make its way inside the retort 214, whether due to the gaseous communication described above or by way of other mechanisms. At temperature of roughly about 600 C, at least a portion of water vapor that contacts graphite (or other carbon-containing materials) within the furnace chamber 210 can result in production of CO and hydrogen (and a comparatively small amount of CO2). Sintering often requires temperature ranges well above 800 C. This water-graphite (or water-carbon) reaction is one chemical reaction in which various gases present can contribute in complex ways to the composition of the hazardous effluent. Experienced practitioners will understand that at temperatures typical of metal processing (e.g., 800 C-1800 C), and at even lower temperatures, many species otherwise viewed as relatively inert materials can become chemically interactive such that there can be many chemical reactions that contribute to effluent.

Even at moderate temperatures, undesired effluent can be produced. For example, during embodiments of a thermal debind step (such as that described above), material can be heated under vacuum to a temperature sufficient to release and/or decompose at least a portion of the binder present. In various embodiments, the temperature can be related to the composition of the binder, the non-binder composition of the parts, the interaction between the binder and non-binder compositions, the processing environment (e.g. gas composition, vacuum, and pressure) and can in some embodiments be 100-200 or 200-300 or 300-400 or 400-500 or 500-600 C or higher. This debind temperature in some embodiments can be low enough to avoid substantial metallurgical activity such as grain size changes, migration of alloying species into or out of grains or changes of crystal form of metal species as well as chemical reactions with the metallic particles and chemical reactions between retort materials and gaseous species and be high enough to cause the binder to thermally volatilize and/or decompose and exit the part at rates that depend, at least in part, on temperature. At least a portion of the binder can in various embodiments thermally decompose into lower hydrocarbons or other compounds when exiting the part. Hydrocarbon chains can be thermally cracked into shorter chains when contacting heating elements at appropriate temperature. Some debinding processes can utilize an oxidizing gas such as air in processing/debinding; the composition of the resulting products can contain oxidation products and/or combinations of hydrocarbons and oxidation products. The composition of hydrocarbon effluent is specific to many aspects of the thermal debind and sintering process. During a thermal debind with no process gas, the hydrocarbon decomposition products of the binder polymer as well as volatilized binder components themselves are the primary components and source of effluent.

Adding process gas can sweep binder products and any of the process gas components and any products from reactions to the effluent. Without adding process gas, the binder or process products can drift, diffuse or otherwise flow to form an effluent. In many industrial settings, effluent can be burned before venting to the outdoors. A binder trap, which condenses some less volatile constituents of the effluent can be configured to trap or otherwise remove molecules of binder material and binder material breakdown products present in the effluent (for example, with a polypropylene binder, there can be polypropylene and polypropylene decomposition products in the effluent, other binders can have effluent components related to the binder being used) such as by condensation and/or filtration.

A typical operation of a furnace may include the following: (i) initial pump down, (ii) establish controlled vacuum pressure based on injected process gas, and/or pumping speed, (iii) elevate temperature to 250 C-550 C range for a period of time sufficient for thermal debinding of parts, (iv) elevate the temperature for a period of time sufficient for sintering, and (v) allow to cool while maintaining process gas atmosphere at controlled vacuum or pressure. During any stage of a given process cycle, the vacuum or pressure, the temperature, the duration, and the type of process gas can all be controllably varied.

FIG. 4B is a block diagram of a furnace system 401 in a further embodiment. In addition to the features described above with reference to FIG. 4B, the furnace system 401 may further include a binder trap 225 (also referred to as a condensate trap). The binder trap 225 can be used to condense and collect some of the less volatile components of the effluent (e.g., various binder compounds) before they go through the vacuum pump. The binder trap 225 can be employed or by-passed based on controllable valve settings in surrounding valve and vacuum manifold. Inserting the binder trap 225 as close as possible to the furnace collects the condensable materials that would otherwise accumulate on valves, pipes, fittings, sensors, and pump/pump oil. Vapors can be pumped through the vacuum pump, where a portion of the vapor may be absorbed by the vacuum pump oil in cases where oil pump is employed. It can be advantageous to collect as much effluent as possible in the binder trap 225 so that the least amount possible travels through the remainder of the system.

Although vacuum operation can be used for various embodiments described herein, embodiments of processes and steps of processes described herein can, in many cases, also be run successfully at, near or above atmospheric pressure. In such cases, the process gas and/or the effluent can build up pressure in the furnace chamber in a manner that can be controllable for example by a gas regulator, a back-pressure valve, or as a result of the furnace chamber temperature or a controlled rate of pumping of the effluent. Control of the rate of pumping can be provided for example by including and controlling proportional valve at the system outlet. In some cases, one approach can include using the process gas regulator to pressure the chamber. Many inert gas and/or controlled atmosphere furnace embodiments (such as tube furnaces, box furnaces, etc.) can be operated at or near atmospheric pressure and/or positive pressure.

As illustrated in FIG. 4C, a non-vacuum furnace system 402 employing no vacuum pump and suited to operation near or above atmospheric pressure can be configured having no vacuum pump and with an isolation arrangement 294 disposed between the furnace chamber and the exhaust to atmosphere. The isolation arrangement 294 serves to isolate the furnace work zone from back-diffusion of oxygen present in the outside atmosphere that is present at the exhaust outlet. In one embodiment, the isolation arrangement 294 could be a tube that is sufficiently long and sufficiently narrow such that the flow of process gas and effluent sufficiently restricts back flow of oxygen, such as where the velocity of the flow of process gas through the tube is sufficiently high to limit the back diffusion of oxygen from the exhaust outlet into the furnace chamber to an acceptable level, or where the length of the tube, the flowrate of the tube, and the diameter (or characteristic dimension for non-circular cross-section) are varied depending upon the diffusivity of the oxygen (or oxidizing agent) through the process gas such as in a relationship of flux to chamber concentration as a function of Peclet number. In many sintering applications, at least in order to achieve desired material properties and/or surface finishes, the presence of oxygen in the controlled furnace atmosphere should be limited—especially during sintering—such as by an isolation arrangement 294, to an acceptable level such as where the resulting oxygen in the furnace chamber is limited to result in a concentration of less than 100 parts per million (ppm) relative to the controlled atmosphere. In many cases such as in sintering various stainless-steel alloys, it has been established that oxygen levels should be maintained below 15 ppm. The requirement for oxygen content can vary widely depending on various factors including but not limited to metal composition, binder composition, amount of metal loaded into the furnace, operating pressure and the type of forming gas being utilized.

In some less sensitive applications, the acceptable level of oxygen concentration may be less than 1000 or less than 300 or less than 200 or less than 100 ppm depending, for example, upon the materials present and processing conditions. In more sensitive applications acceptable level of oxygen concentration in the furnace may be less than 50 or less than 40 or less than 30 or less than 20 or less than 10 or less than 5 ppm depending, for example, upon the materials present and processing conditions. In particularly sensitive applications the maximum allowable concentration may be less than 4 or less than 3 or less than 2 or about 1 ppm depending, for example, upon the materials present and processing conditions. In extreme cases, the maximum may be less than 1 ppm.

As described immediately above, in some embodiments, the back diffusion of oxygen can be limited by an isolation arrangement to an acceptable level such as where the resulting oxygen in the furnace chamber is maintained well below 100 ppm. On one such embodiment, an isolation arrangement can comprise an isolator such as a tube, which can be sufficiently narrow and long to limit or prevent transport of oxygen upstream to the furnace chamber. In one such embodiment, the tube can be sufficiently narrow to provide for process flow velocity therein at speeds greater than 10 feet per minute, which for a long enough tube (several feet for example) can provide for sufficient isolation. In another embodiment, a choked flow orifice of small enough cross section may serve as an isolator that may be sufficient by itself or may serve as part of a series arrangement of other isolators. In another embodiment, an isolator can be or comprise a porous material, such as a fritted disk or a flow snubber, can be used alone or in combination with other isolators. In yet another embodiment, a valve or check valve may serve as an isolator that may be sufficient on its own or may contribute as part of a series arrangement of other isolators. In still another embodiment various pumps and or blowers could be utilized for purposed of isolation including but not limited to various gas displacement pumps as well as various gas dynamic pumps. Gas displacement pump embodiments can include piston, diaphragm and rotary pumps, and gas dynamic pump embodiments could include axial flow, mixed flow peripheral, jet and electromagnetic gas pumps. In some embodiments, an isolation arrangement can be or comprise a reactor that reacts oxygen with other species to render at least a portion of the oxygen (or other oxidizer non-reactive or less-reactive toward materials being processed in the furnace chamber, such as by being reacted to CO₂ and/or CO, and the reaction zone can be used alone or in combination with other isolators. In some embodiments, the reactor can comprise a catalyst, such as an oxidizing catalyst.

In some embodiments, comparatively large quantities of hydrocarbons are off gassed during thermal debinding (e.g., a processing stage prior to high-temperature sintering), and smaller quantities are exhausted during sintering. In general, there can be comparatively lesser amounts of CO during debinding and comparatively large amounts during sintering (either on a mass basis or as a percentage of total gas produced during the step). During sintering, a significant amount of the CO can be produced by reaction of water vapor (in some embodiments, a substantial portion or a majority of the water occurs by release of water from the insulation) and graphite or otherwise carbon-based retort or carbon-based insulation. In addition to the hydrogen commonly included as a component of the process gas, hydrogen can in some embodiments be produced by reactions during both thermal debinding and sintering. In some embodiments where thermal debinding can occur at relatively low temperature, including temperatures lower than that used for sintering, at least a portion of the hydrogen produced during thermal debinding can be from decomposition of the hydrocarbons. Hydrogen can also be produced during sintering (generally a higher temperature than debinding). During sintering, as well as during debinding, hydrogen can be produced by water vapor reacting with graphite or other primarily carbon-composed materials such as the retort. (Typically, water reacts with carbon at high temperature to produce hydrogen, CO, and CO2). In many cases the process gas can include hydrogen (e.g. up to 100% H2 can be used in some embodiments), while mixtures of hydrogen and other gases, such as inert gases can also be successfully used in some embodiments, and non-explosive mixes of forming gas, such as those having 2%-5% H2 in Nitrogen or Argon can be utilized in some embodiments such as those for office-friendly applications. (As used herein, percent as used in designating gas concentrations are on a molar basis, except where context indicates otherwise.) Although the office-friendly process gas concentration is below the explosive limit, hydrogen produced by reactions in the furnace can produce higher concentrations, with mitigation being desirable, such as by dilution with other gases, exclusion of oxidizing agents such as air or oxygen, cooling and/or protection from ignition sources.

A range of compounds can be generated during sintering depending upon the species decomposing and the conditions used for the decomposition. In some embodiments a number of hydrocarbons can be generated and in some embodiments, various halogenated organic compounds, such as chlorinated species, as well as other species can be present. Generally, it can be desirable to reduce the quantity of these compounds by reacting them to water, CO2 and other species.

A furnace system in example embodiments can reduce or prevent release of the aforementioned compounds and others into an external environment in quantities that might present various risks or hazards.

FIG. 5 illustrates an effluent treatment assembly 500 in one embodiment. The assembly may be implemented in the furnace systems 200, 300, 400, 401 described above, and may process effluent from the furnace systems to mitigate the aforementioned hazards associated with the effluent. The assembly 240 may include the aforementioned vacuum pump 232 in gaseous communication with a catalytic converter 240 in an exhaust system, where the catalytic converter 240 is configured to catalyze reactions to decompose various compounds in the furnace exhaust to safer compounds, such as water and CO2. Vacuum pumps typically cannot run at temperatures exceeding 120 C, and so the effluent at the vacuum pump 232 can desirably be at a low temperature relative to the temperature of the catalytic converter 240 and to the temperature of the connected furnace chamber (not shown).

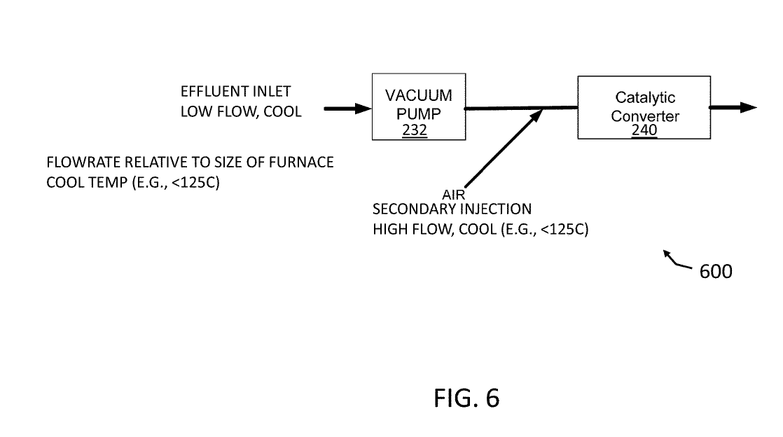

FIG. 6 illustrates an effluent treatment assembly 600 in further embodiment, which may be comparable to the assembly 500, and further implements a gas (e.g., air) injection between the vacuum pump 232 and the catalytic converter 240. As with the effluent flow, the gas may include a reagent, such as an oxidizer, to facilitate reaction at the catalytic converter 240. The gas injection can provide a low and widely variable flow rate compared to other embodiments involving catalytic converters. In some embodiments of furnaces, such as some units suitable for use in an office-type environment as described herein, a maximum expected effluent inlet flow rate to the vacuum pump can be 10 CFM or less, with some embodiments being substantially less than 10 CFM, and often less than 0.5 CFM, but some embodiments can have somewhat higher maximum effluent flow rates as well. Some embodiments of an office-type furnace can have a maximum effluent inlet flow rate to the vacuum pump of 8-10, 10-12, 12-14 CFM. (As used herein, volumetric gas flow rates including those stated in CFM are referenced to 1 atm and 0 C, unless the context indicates otherwise.) “Effluent inlet flow rate” as used herein is the flow rate leaving the furnace and entering the pump prior to addition of secondary gas or air flow. In contrast, other catalytic converter systems can frequently process gas streams at far greater flow rates.

This low flow rate can create challenges to catalytic converter systems. For example, at low flow rates it can be difficult to maintain internal catalytic converter temperature to within a well-controlled range as is needed for complete catalysis. With low flow rates, a heater configured to heat effluent prior to entry into the catalyst can tend to overheat due to insufficient gas flow cooling of the heater. Additionally, exothermic heat generated by the catalytic reactions can require additional flow to ensure adequate cooling of the catalyst. Low flow rates are also conducive to laminar flow, whereas catalytic converters perform better with turbulent flow because turbulence promotes better mixing and subsequent contact with catalytic converter surfaces. In preferred embodiments, the converter system can operate properly over the entire range of effluent conditions to be generated by the furnace, which typically includes periods of low effluent production and periods with high effluent production.

Example embodiments include features and combinations of features that address these challenges. For example, as shown in FIG. 6, air may be mixed with the effluent prior to the catalytic converter inlet at low flow and/or low temperature. (The mix air may be supplied by a fan or air injection pump for the case of a non-vacuum furnace.) The total air flow, including the injected air flow, may be substantially lower than industrial-sized systems and methods.

Example embodiments can be distinctive in additional ways. For example, most catalyst applications, such as automotive applications, involve: 1) a well-defined minimum and maximum flow to design around, 2) constituents of the flow that fall within a well prescribed range, and 3) a control system that can control the characteristics of the exhaust, often based on measurements, to ensure that the converter sees a digestible input. In example embodiment, in contrast, there may be essentially no effluent flow at all for parts of the furnace cycle and rapid changes to high or low flow that may vary from run to run. Constituents of the furnace effluent can vary widely and change quickly. Thermal inertia in furnaces is typically high, limiting the ability to rapidly adjust production rates. There may be little instrumentation for monitoring and no substantial control over the effluent of the furnace, meaning that the sintering process cannot be quickly modified to suit the catalyst. Consequently, embodiments of catalytic converters for sintering furnaces can be subject to a very high turndown in the throughput, variation in the composition of the feed material (where the individual molecules that make up the feed can vary in kind and throughput), rapid swings in throughput and composition of feed, and/or little opportunity to control the feed to the catalytic converter.

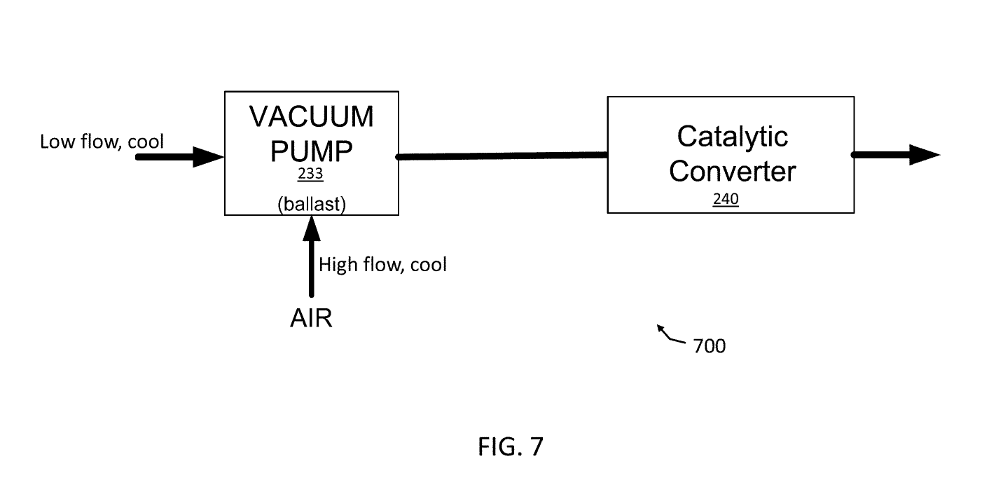

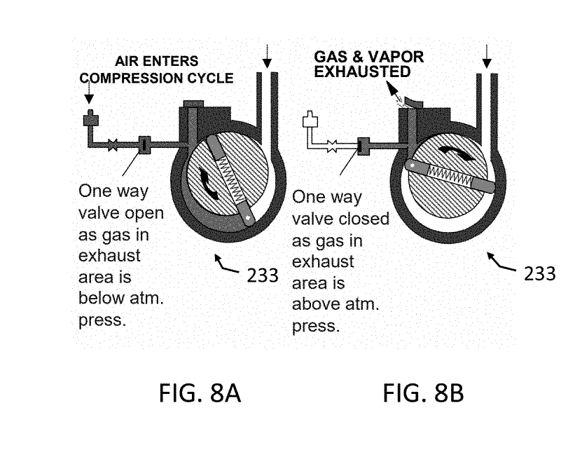

FIGS. 7 and 8A-B illustrate an effluent treatment assembly 700 in a further embodiment, implementing a vacuum pump with a ballast 233 to provide an air injection. As shown in FIG. 8A, a gas stream comprising a reagent (e.g., air comprising oxygen) is introduced through a ballast port 233 to the vacuum pump, such as at the pump chamber or discharge port of the vacuum pump (discharge port connection shown) via a valve such as a 1-way valve, and is mixed with the effluent. As shown in FIG. 8B, with the 1-way valve is then closed, and as the ballast drum rotates, the mixed gas is expelled from the ballast tank.

Vacuum pumps often include ballast systems to reduce condensation in the pump and/or contamination of the pump oil. The ballast pump can adjustably introduce air into the pump exhaust. In an example furnace system, the ballast valve in the vacuum pump can provide a convenient source of air/oxygen to react (such as react catalytically) with the effluent products. Setting the ballast pump air flow to match the requirements of the catalytic converter, or vice versa, allows the air injection pump to be eliminated as separate part of the effluent handling system by using a standard feature of the vacuum pump. In some embodiments, the gas ballast rate can be used to control the operation of the catalytic converter.

In some embodiments, the gas ballast rate at the pump (and/or other gas additions to the effluent stream) can be operated to bring concentrations of some, any and/or all flammable effluent constituents to below their lower flammability/explosive limits. (If these flammable species leave the pump in a non-diluted state and then are exposed to oxygen, they can combust unless diluted below the respective explosive limits. Diluting with a non-combustible, non-oxidizing gas one alternative, but such a gas would likely incur cost and require storage. Diluting to below the explosive limit with air is a non-trivial operation as, at some point in the process, the mixture transitions through the explosive range. One approach to such dilution can utilize a spark free and/or flame quenching environment. In some embodiments of utilizing a pump ballast air injection, a spark free and/or flame quenching environment can be provided while the gas passes through the explosive range of the gas while mixing with diluent. Additionally, this dilution can occur in a location having a measure of safety due to the proximity to an oxygen free (and therefore noncombustible) environment. For example, in some embodiments it is possible to perform dilution through the explosive limits in the furnace chamber, where there can be a lack of oxygen (or other reactive compound) and a reduced pressure (vacuum) to at least partially offset an increase of pressure due to ignition. In the case of oxygen/air/reactant addition at a vacuum pump ballast, it is possible to inert the surrounding zone of the mixing zone of the vacuum pump. An embodiment can include inerting of a region surrounding the mixing zone such that any flame event results in adequate dilution or quenching.

The ballast vacuum pump 233 therefore can serve a number of purposes:

1) In some embodiments, the ballast vacuum pump 233 can provide the effluent flow with additional mass to more effectively transfer heat from the effluent heater to the catalyst. Without additional mass flow rate, the effluent becomes a less effective medium for heat transfer to the catalyst due to less energy being carried by the flow and the catalyst would have to be heated by other methods. Further, higher flow rates can enhance the mixing and reduce the amount of catalyst required.

2) In some embodiments, the ballast vacuum pump 233 can provide the effluent flow with an oxidizing agent (e.g. oxygen) that is necessary for the oxidation catalyst to eliminate harmful constituents from the furnace exhaust. Without oxygen or suitable reagent, the catalyst will not oxidize species in the effluent, such as harmful and offensive components in the effluent. While there are oxygen-storing catalysts that do not require oxygen be supplied simultaneously with the effluent, there still may be provision for resupplying the oxygen for the next use, such as in a pulsed flow technique, alternating use and refreshing, or otherwise. Further, an oxygen storing catalyst with sufficient oxygen storage capacity for operation over the entire cycle without adding oxygen to the flow may be very large, incurring further difficulties of heat loss, reactor control, cost and fit within limited confines.

3) In some embodiments, the dilution of the flammable effluent flow constituents below their lower flammability/explosive limits can occur at a point in the system that is as close as possible to the oxygen free vacuum portion of the system, at the point of increasing the pressure. Therefore, the ballast vacuum pump 233 can reduce the possibility of flammable leaks from the system.

4) In some embodiments, the ballast vacuum pump 233 can dilute the oxidable components of the effluent below a point where the exothermic energy of the oxidation reaction provides excessive heat input to the catalyst (the gas or air provides an additional heat sink). Thus, a “runaway” scenario, in which the catalyst overheats from a rich “fuel” mixture, is prevented. By using a high dilution, the catalyst temperature and activity and the reaction rate can ultimately be controlled by additional heat provided by external heat input, such as by controlled resistive heaters, and is not sensitive to sudden swings in effluent flow that can occur in furnaces. In automobiles and other systems, engineers have control over fuel concentrations and can control catalyst temperature by changing fuel concentration which in some embodiments is not possible to the same extent in furnace systems (effluent is the fuel in the case of the furnace).

One or more or all of the above benefits can be realized in some embodiments without adding any additional pumping hardware or plumbing, and in additional embodiments with some hardware or plumbing, by using a system that is already in place on a vacuum pump. Further, examples of the above embodiments can be accomplished with a system that is passively controlled in that it runs when the pump is running.

In many embodiments, a catalytic converter will have catalytic activity that is a function of temperature resulting in an operating temperature range for the reactions of interest. In typical applications such as an automotive application, this range can be achieved by balancing the heat present in the gas input and the heat of the catalytic reactions against the heat of the exhaust gas exiting the catalytic converter and the heat loss through the body of the catalytic converter. The particular inlet temperature and exothermic catalytic reaction generates a heat output via an exhaust and a conduction/convection via the sides of the device. The catalytic converter operates in a predetermined temperature range based on the balance between heat in and heat generated by the reactions vs. heat out, such as a range of 300 C-500 C. In embodiments of automotive applications, a catalytic converter can be heated by a high flow of inlet gas that is sufficiently hot to maintain 300 C to 500 C within the catalytic converter. Substantial insulation around an automotive catalytic converter is typically not required because the high flow rate and particular inlet conditions makes it unnecessary. Heat entering with the inlet flow can exceed thermal heat loss (radiative and convective) out the sides of the catalytic converter, so continuous heating is not necessary in embodiments of automotive catalysts. In contrast, in example embodiments of systems for furnaces, the gas and secondary injected air may enter the catalytic converter at low temperature (lower than the catalyst operating conditions) and may require heating for the catalyzed reactions to proceed. Because the flow rate can be low and the surface area of the catalytic converter relative to the flow can be high, the system should be well insulated due to a lack of thermal mass and subsequent available heating energy. It is generally important that the temperature of the outermost gas passages in a catalytic converter be maintained within the operating range so that unprocessed effluent does not exit the system, or that any such gasses be remixed or rerouted so that they are processed before exit. In fact, the furnace system effluent system may require good insulation to operate effectively at reasonable heater power levels.

Catalytic conversion requires oxygen or other oxidizing agent to react with the effluent products. Modern automotive catalytic converters can operate without secondary air injection for either or both of two reasons: 1) The engine control system burns a lean mixture, which has enough excess O2 to react the pollutants in the catalytic converter without additional “secondary” air injection. 2) The modern automotive catalytic converter includes a catalyst ingredient(s) that stores excess O2 when the engine is under light load and running very lean and releases the O2 when the exhaust stream becomes low on O2 so that there is adequate O2 for reactions in the converter.

The exhaust of a metal processing furnace can be very low on O2 content once the initial pump out is complete. Introduction of oxygen into a metal processing furnace operating at vacuum can be problematic in that a primary objective is to minimize oxygen in the furnace; thus, the primary path to implementation is to locate the catalyst after the vacuum pump, which isolates the furnace chamber from any oxygen introduced into the effluent stream for the purposes of catalysis. Air can be used to provide the oxygen to avoid the need for a gas supply and the hazard of dealing with bottled or compressed oxygen. The techniques of this invention utilize what would in automotive terms be called secondary air injection, also referred to as reaction air. In the case of effluent conversion, all of the exothermic heat energy is released in the catalyst. At high effluent concentrations, this heat input can overheat the catalyst. Overheating can be prevented by substantial oversupply of air, which provides enough specific heat based energy absorption to limit the temperature to acceptable levels. A substantial excess of reaction air can be used to control the temperature, simplify the system, and improve performance.

Furnace effluent often consists of unreacted compounds. During the thermal debind process, the furnace effluent can comprise or consist primarily of hydrocarbons. During sintering, the furnace effluent can contain CO and H2. Thus, at times, the furnace catalyst can be fed an effluent that is nearly all combustible reactions products that are uncombusted, meaning that the catalyst is comparable to an engine with no energy extraction in which the catalyst is reacting all the fuel instead of the very small unreacted percentage in the case of an automotive engine. This results in the potential for very high temperatures that in some cases can result in undesirable overheating. At other times, there is very little effluent flow, or the flow might consist almost entirely of non-reactable compounds (such as N2 or Argon process gasses). Yet the converter, in example embodiments, should still react the traces of toxic compounds present. The transition between these conditions might be slow or relatively fast. The furnace catalytic converter may handle a much wider range of operating conditions than typical catalytic converters. Accordingly, the varying composition and flowrate of the effluent as well as the change in composition from debinding to sintering, the differing heat load, potential for overheating and underheating, presence of and at times the high concentration of non-reactable compounds, variable rate of change in conditions, and the variability of the part load in the furnace (with associated binder and particular processing conditions) across a processing cycle as well as from process batch to process batch, and/or the requirements of the final discharge point of the exhaust leads to challenges for a furnace catalytic converter not found elsewhere.

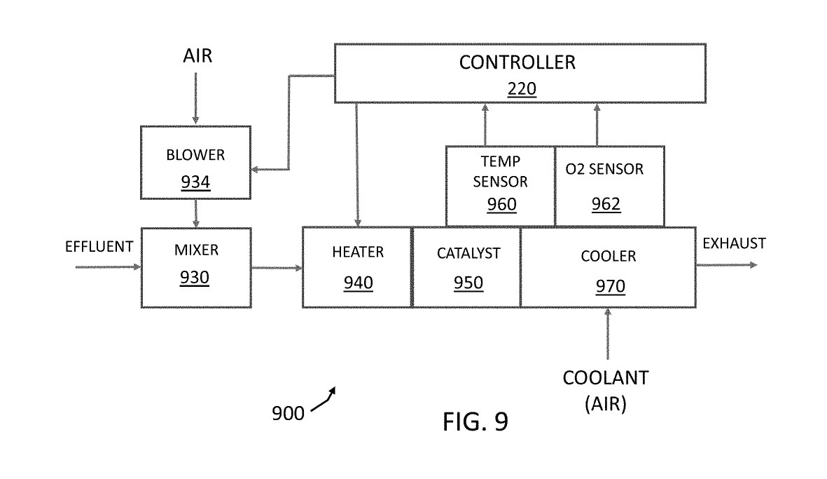

FIG. 9 illustrates an effluent treatment assembly 900 in a further example embodiment. The assembly 900 may incorporate one or more features of the assemblies described above, and may be implemented in any of the furnace systems described above. The assembly 900 may include a gas mixer 930 (e.g., a vacuum pump incorporating a ballast) that receives and combines furnace effluent and a reagent (e.g., air) received from a blower 934 to form a mixed gas. A heater 940 may raise the temperature of the mixed gas to a temperature more advantageous for catalysis, and the catalyst 950 receives the heated mixed gas and catalyzes one or more compounds of the effluent. A cooler 970 receives the converted gas output by the catalyst 950 and lowers the temperature by suitable means, such as by mixing it with a coolant (e.g., air). The resulting exhaust output by the cooler 970 may be substantially absent of offensive or hazardous compounds, or may contain such compounds in quantities below respective thresholds for safety or offensiveness, and thus may be acceptable to disperse into an office or other environment. A temperature sensor 960 and oxygen sensor 962 may monitor temperature and oxygen content, respectively, at one or more stages of the assembly 900. The controller 220, in turn, may control and adjust operation of the blower 934, mixer 932, heater 940 and/or cooler 970 based in part on the monitored temperature and oxygen content to maintain acceptable operating parameters.

The assembly 900 may operate over a wide range of conditions. Operation can include one or more of the following basic modes:

Mode 1: Low effluent combustibility energy. The heater 940 provides most of the operating heating power to maintain catalyst temperature/reaction temperature.
a) Catalytic converter temp. in the low operational range.
b) Heater on; maintaining operating temp.
   (An optional O2 sensor 962 located on outlet of the catalytic converter reads excess O2 even at minimum flow setting. Reaction air flow can be set to target correct values for excess O2 or a minimum setting.)

Mode 2: Medium effluent combustibility energy; balanced heat load/loss with the reaction providing significant heating power.
a) Catalytic converter temp. medium.
b) Heater on, partial, or off; maintain operational temperature. Alternatively, the heater 940 may be operating constantly.
c) (An optional O2 sensor on outlet of the catalytic converter reads just enough excess O2 to be sure effluent exits sufficiently reacted.)
d) Reaction air flow: set to target excess O2.

Mode 3: High effluent combustibility energy; balanced heat load/loss with the reaction providing the bulk or all of the heating power.
a) Catalytic converter temp. high.
b) Heater off; operating temp. near highest level.
c) (Optionally, an optional O2 sensor on outlet of the catalytic converter reads high excess O2.)
d) Reaction air flow: set to limit maximum temperature; excess air is cooling catalyst/limiting temperature rise in the catalytic converter.

There can be several ways to achieve the above operating modes, including the following:

Method 1: Supply a very high air flow rate and heat the mixture to the lower reaction temperature at all times. With adequate high air flow rate, catalyst size, and heater power, this mode can accommodate all levels of effluent production, reacting low effluent conditions at the lower range of operating temperature and high levels at a flow rate high enough to keep the operating point below the maximum allowable temperature

Method 2: Supply a very high air flow rate and operate as in Method 1 above, except turn down or off the heater as the effluent concentration rises. This allows a bit more temperature rise to be produced by the reaction heat and provides a bit more operating capacity for a given system.

Method 3: Supply an air flow rate that is matched to the operating conditions. This method allows lower air flows at lower effluent flows, which can reduce power consumption, ventilation requirements and noise.

In a catalytic converter employed in example embodiments, the effluent gasses can be uncombusted because the furnace operates in an oxygen free or a reducing environment. If the effluent gases were directly injected into a reactor and reacted adiabatically and stoichiometrically with air (without extra dilution air) in the catalytic converter, the temperature rise could be on the order of 2000 C and can potentially lead to overheating of the catalyst, which in various embodiments can be typically degraded at temperatures above 600 C to 800 C, depending on materials. Therefore, it can be advantageous for the effluent to be diluted with enough excess air (well above stochiometric ratio) so that the adiabatic temperature rise does not produce temperatures above the safe temperature for the catalyst. In some embodiments, the calculated temperature rise can be adjusted for heat losses to determine the amount of dilution air. Additionally, the addition of excess reaction air ensures that there is plenty of oxygen available for the catalytic reaction, which, in turn, helps drive the fraction of unreacted effluent components down to very low levels. This approach can require that the portions of the system and/or feed streams be heated, such as the effluent, reaction air and catalyst surfaces, to reach the proper operating temperature for the catalyst.

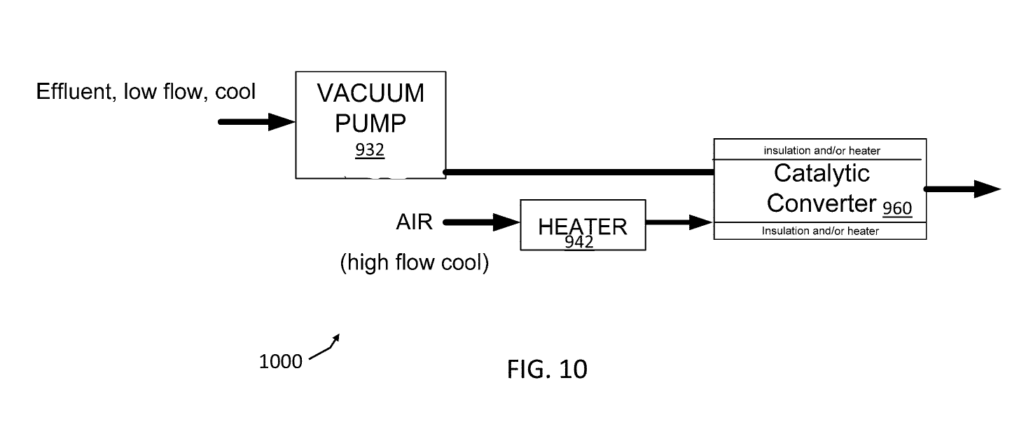

FIG. 10 illustrates an example effluent treatment assembly 1000 having a catalytic converter 960 and a vacuum pump 932 in a further configuration, which implements a heater 942 to heat the injected air before being combined with the effluent at the catalytic converter 960. This assembly 1000 can have one or more of the following characteristics: (i) temperature of the effluent is significantly lower than the operating temperature of the catalytic converter, (ii) the additional inlet air is heated, (iii) the sum of both flows is low, especially for lab or office-type systems, as described herein, with insulation and/or heating optionally being implemented in and/or around the catalytic converter to achieve operating temperature. In the furnace application, the injected air flow can be relatively high in comparison to effluent flow rates, as labeled in the figure. The heater can be driven by any means, including combustion; however, for office use the preferred embodiment can be an electric heater. This additional air flow can be high enough that the temperature from the catalytic reactions does not rise above the temperature limits of the catalytic converter.

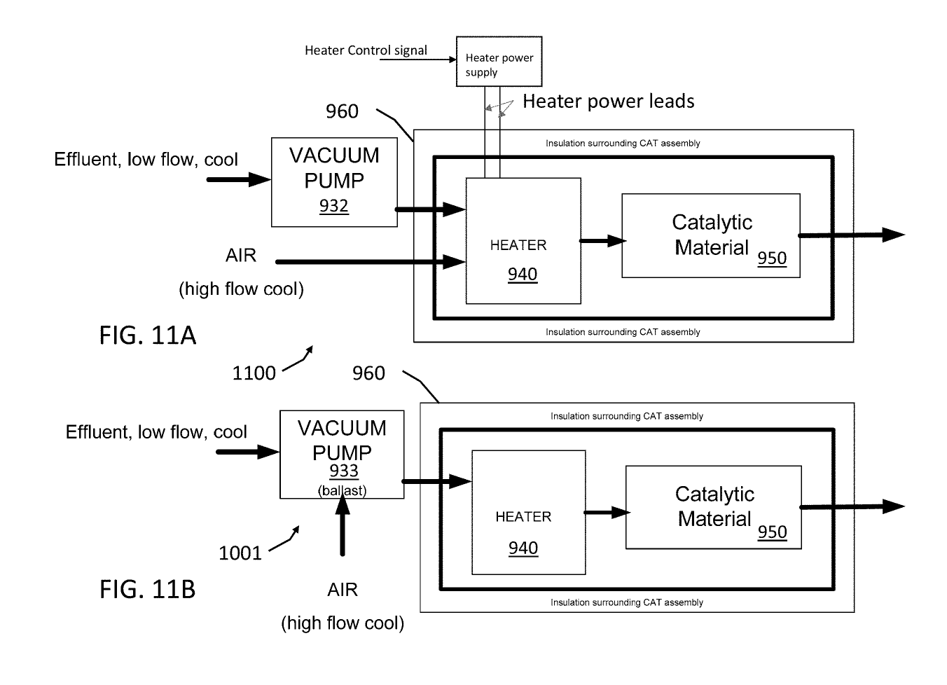

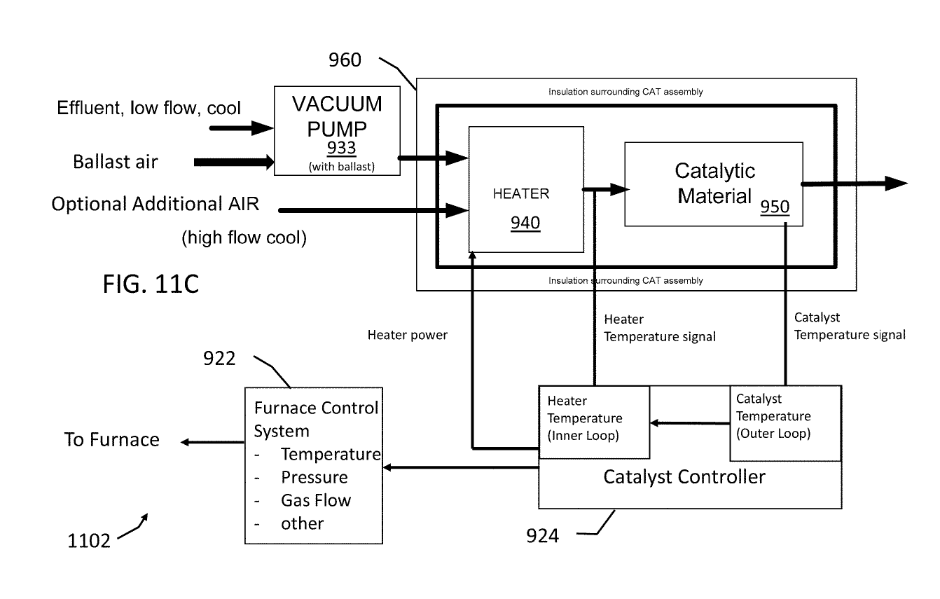

FIGS. 11A-B illustrate effluent treatment assemblies 1100, 1101 in further embodiments. In FIG. 11A, the effluent and air (including a reagent such as oxygen) is combined at a heater 940 within the catalytic converter 960 before being transferred through the catalyst 950. The heater can be an electrical heater that receives heating power through two or more heater power leads that are in electrical communication with a controllably variable heater power supply that receives a heater control signal from a controller. In further embodiments throughout this disclosure explicit illustration of the heater controller is often omitted for purposes of brevity and too avoid cluttering the drawings. However, for any heater embodiment described herein, the heater can be a controllable electrical heater as described with respect to this figure. Furthermore, it should be understood that unless context or text indicates otherwise the power to the heater can be provided by a heater power supply that can be controllable in relation to a control signal originating from either some overall system controller that controls some portion of the entire furnace system and/or can originate from some other more specialized controller that controls only a part of the system, including in some embodiments a dedicated heater controller.

With ongoing reference to FIG. 11A, a catalyst heater may optionally be provided and configured for directly heating the catalyst. The catalyst heater can be an electrical heater that receives catalyst heating power through two or more catalyst heater power leads that are in electrical communication with a controllably variable catalyst heater power supply that receives a catalyst heater control signal from a controller. It should be understood that, unless context or text indicates otherwise, the power to the catalyst heater can be provided by a catalyst heater power supply that can be controllable in relation to a catalyst control signal originating from either some overall system controller that controls some portion of the entire furnace system and/or can originate from some other more specialized controller that that controls only a part of the system, including in some embodiments a dedicated catalyst heater controller. While not illustrated in this figure, a single heater could be configured to heat both the catalyst and the inlet gas.

In FIG. 11B, the effluent and air is combined at a ballast at the vacuum pump 933 before being transmitted to the heater 940 within the catalytic converter 960. Because the effluent input gas is at low temperature (prior to heating), it (along with the secondary air injection) is heated at the catalytic converter inlet by a flow through heater. The heater in some embodiments can also be used to heat the catalyst material. Some embodiments can incorporate both air injection in the pump and a later air injection such as by combining features of the assemblies 1100, 1101.

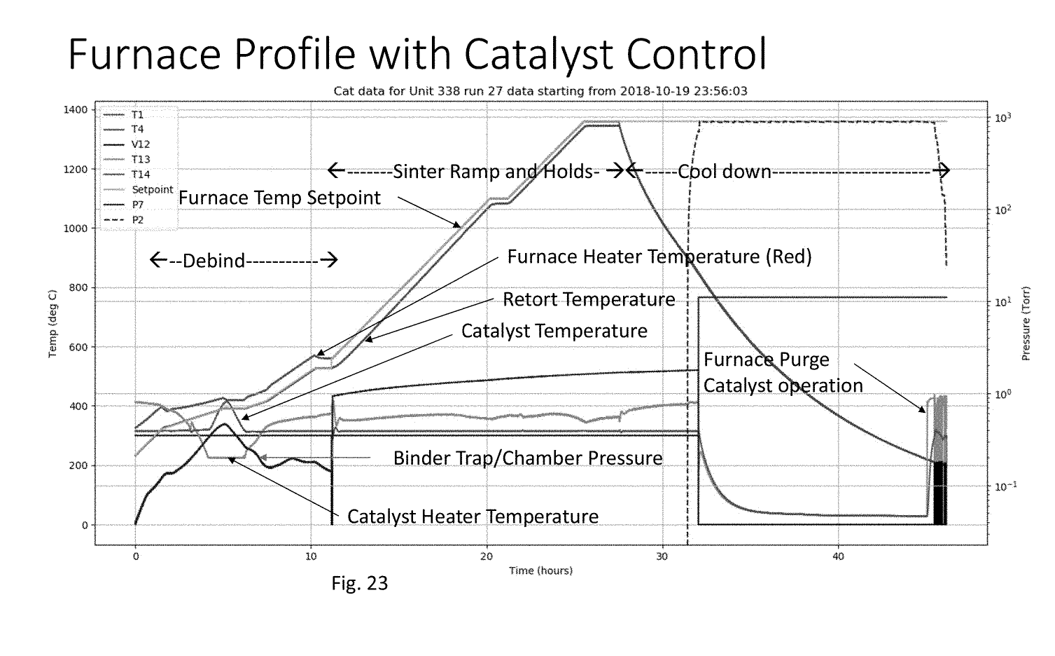

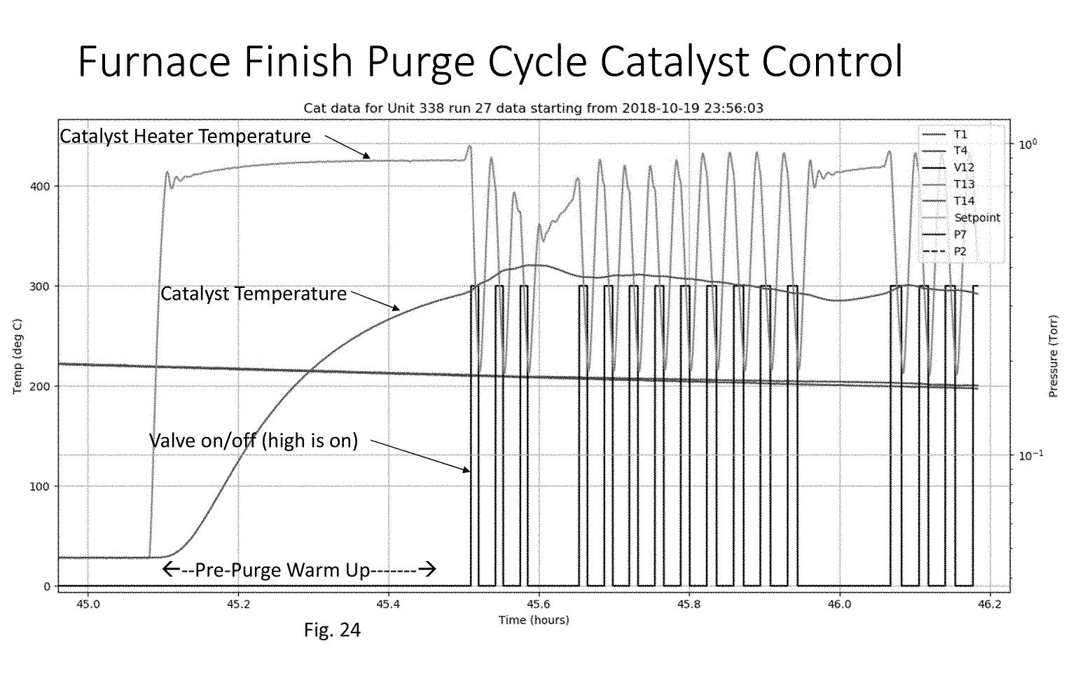

FIG. 11C is a block diagram of the embodiment of a catalytic effluent processing system 1102 that may be implemented in the furnace system of FIG. 3, with example data from a demonstration run shown in FIGS. 23 and 24. The system 1102 may include a vacuum pump 933 with ballast air and an additional air pump (not shown) for added dilution air (high flow cooling air pump). A catalyst controller 924 can implement a catalyst heater thermocouple located between the catalyst heater and catalyst to measure the temperature of the gas entering the catalytic converter body. A catalyst body temperature thermocouple can measure the temperature of the catalyst body. These temperature measurements can be used by the catalyst controller 924 to form an inner loop control for heater temperature to hold a set point. The setpoint is adjusted by an outer control loop based on the catalyst body temperature. The catalyst controller 924 can also supply a control signal to a furnace controller 922, which controls the power to the furnace heating elements to maintain the setpoint temperature for the furnace as measured by the furnace temperature measurement system.

At the lowest of the range of flow rates, the heat loss through the walls of catalytic converter can become significant. In a high-flow catalytic converter, such as in automobiles, this loss mechanism is inconsequential due to high mass flow and available energy in said flow, but in a low-flow furnace, catalytic converters losses through the walls can be a dominant heat load. Insulation can mitigate this heat loss. Example embodiments can be configured such that the heater power is properly balanced against inlet flow and temperature for staying within a predetermined range for acceptable catalyst operation. If excessive variation occurs, then a pre-heater (not shown) can be installed at the inlet and controlled via temperature feedback. Embodiments can implement a closed loop temperature control at the catalytic converter, or may operate in quasi-steady state for at least some periods of time with no feedback control. Alternatively, multiple heaters may be used over a range of locations in the system to achieve operational temperature.

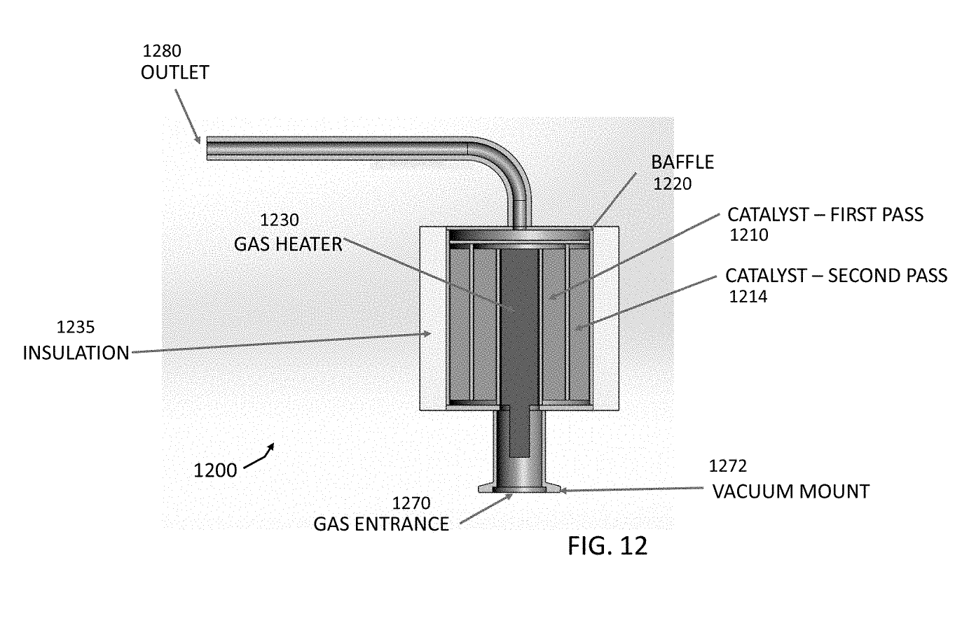

FIG. 12 illustrates a catalytic converter 1200 in a further embodiment. The catalytic converter 1200 can have a coaxial structure that includes a central core comprising a heater 1230 (e.g., a heater comprising an electrical coil, but other types of heaters that provide sufficient heat at an appropriate temperature can be used as well) that receives the effluent and injected air from a gas entrance 1270, which may be connected to upstream components of a furnace system via a vacuum mount 1272. The effluent and injected air can be mixed at the catalytic converter 1200 or upstream from the catalytic converter. From the heater 1230, the mixed gas first enters an inner (or “first pass”) catalyst 1210, which may surround the heater core, and receive heat from the heater 1230 via conduction (e.g., through a shared wall) and convection of the mixed gas. The mixed gas then enters an outer (or “second pass”) catalyst 1214 that surrounds the inner catalyst 1210, before exiting through an outlet 1280. Alternatively, the outer catalyst 1214 may be omitted if the inner catalyst 1210 provides sufficient conversion. A layer of insulation 1235 can encompass the outer wall of the outer catalyst 1214 to retain heat within the catalytic converter. The catalytic converter 1200 provides a highly efficient profile because the heat from the heater 1230 passes through the catalytic material in order to escape radially through the cylinder. The flow of the hot gas exiting the inner catalyst 1210 can be directed back around the inner catalyst 1210 to help maintain the outer passages at operational temperature. This compact coaxial embodiment can be mounted to the vacuum pump outlet via the vacuum mount 1272, such as near or at the point where ballast air (air injected by the vacuum pump) is added for example at adequate levels to dilute below the explosive/flammability limits and to provide O2 for reaction.

The concentric arrangement conserves heat, reducing heater power and helping to prevent cold spots in the catalyst. The insulation can conserve heat in the outer catalyst, but can be removed or reduced such as for cases in which outer catalyst is not needed in which case the flow can begin cooling on this pass up the outside or for other reasons as desired.

The heater of the embodiment of FIG. 12 can serve a dual role of heating the inlet gas (for example effluent plus injected air) while simultaneously heating the catalyst itself. Many embodiments throughout this disclosure can be configured such that a single heater heats both the inlet gas and the catalyst. As will be discussed below, for many embodiments in this overall disclosure separate heaters can be used with a first heater primarily heating the inlet gas and a second heater serving as a catalyst heater for heating the catalyst.

Generally, conversion of hydrogen containing effluent produces water. With the temperature sufficiently high, the water will not condense in the catalyst. However, under some conditions, as the exhaust from the catalytic converter cools, there may be condensation as the treated effluent cools in the exit tube. This tube can be tilted down relative to gravity and the water collected or dispersed if it is desirable for the water to leave rather than collect in the converter. Continued heating of the catalyst and pumping by the ballasted vacuum pump, which is generally running to keep the furnace under vacuum even when not in use, will dry the catalyst and effluent path so that the water vapor from catalytic reactions gets purged from the system and does not create a problem and is evacuated from the system entirely into the surrounding air.

There can be many variations on the design of the catalytic system ranging from a single long cylinder with heater followed by catalyst to a short cylinder, or several stages of catalytic activity optionally separated by non-catalytic zones and/or gas injection zones. Many heating options exists.

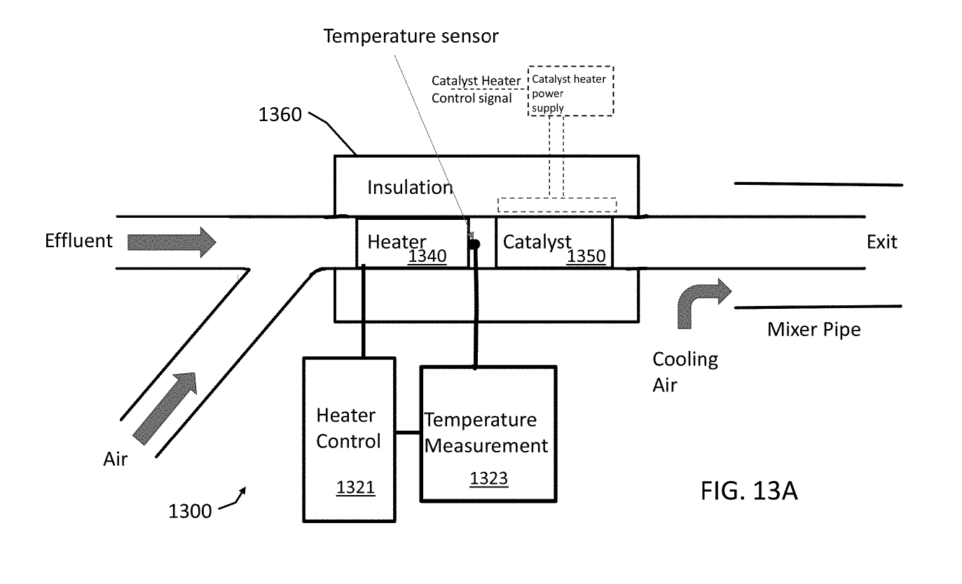

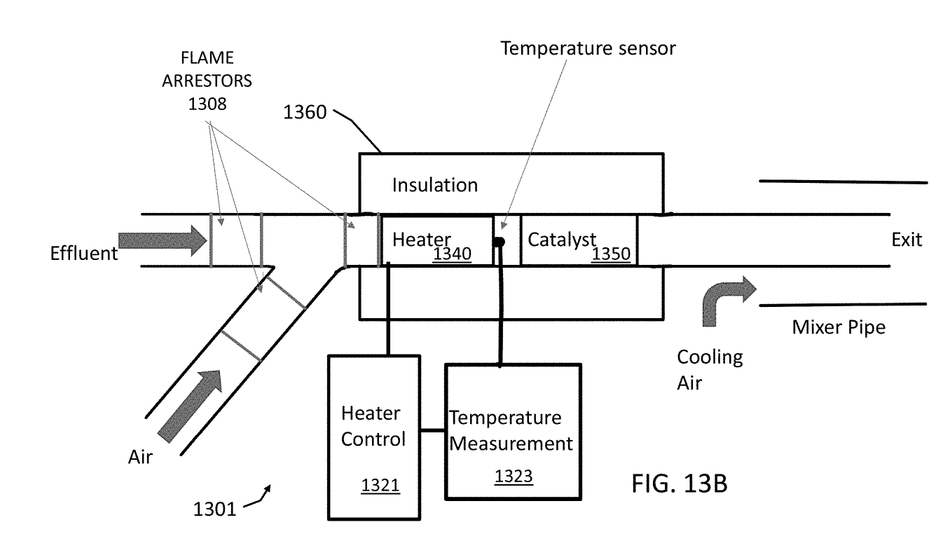

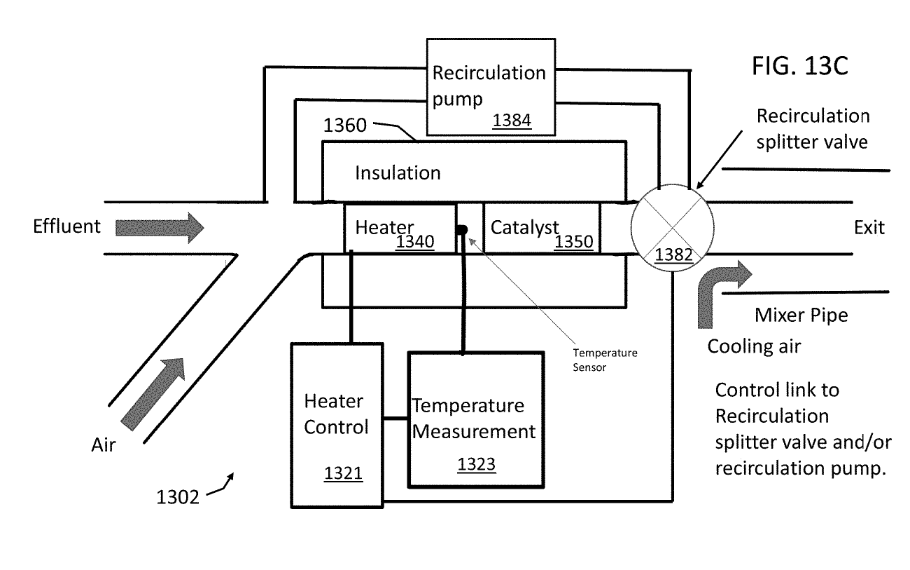

FIGS. 13A-C, 14A-B, 15A-D and 16A-D illustrate effluent treatment assemblies in further example embodiments. These assemblies may be implemented in any of the furnace systems described above with reference to FIGS. 2-4B, and may incorporate one or more features of the effluent treatment assemblies and constituent components described above with reference to FIGS. 5-12. Components of the assemblies described below may incorporate some or all features of the comparable components described above, or may differ in one or more aspects as described below. Further, various features and components of the effluent treatment assemblies described below may be assembled in further combinations, based on the principled described herein, to provide an effluent treatment assembly in a further embodiment not shown.

FIG. 13A illustrates an effluent treatment assembly 1300 including a catalytic converter 1360 in a further embodiment, which employs a temperature detector 1323 and a heater controller 1321 in a control loop that measures gas temperature at or near the entrance to the catalyst 1360 and responsively adjusts a heater 1340 to control this temperature. The temperature can be monitored in various additional locations, and one or more such additional temperatures can be incorporated into a heater control system. This feature may benefit overall performance by holding the catalyst temperature within a selected or preferred range. Such a control loop may also be implemented in any of the embodiments described below with reference to FIGS. 13B-16D.

With ongoing reference to FIG. 13A a catalyst heater may optionally be provided and configured for directly heating the catalyst. The catalyst heater can be an electrical heater that receives catalyst heating power through two or more catalyst heater power leads that are in electrical communication with a controllably variable catalyst heater power supply that receives a catalyst heater control signal from a controller. As was the case for the heater of FIG. 11A it should be understood that the catalyst heater control signal can be provided by a catalyst heater power supply that can be controllable by a catalysts heater control signal originating from either some overall system controller that controls some portion of the entire furnace system and/or can originate from some other more specialized controller that is more specialized such as a catalyst heater controller that is specialized strictly for purposes of heater control. As is illustrated in this figure, a single heater could be configured to heat both the effluent and air. While not explicitly indicated in the figure, the heater could optionally be configured to also simultaneously heat the catalyst.

In operation, effluent and reaction air enter as labeled on the left side, and are heated by the heater. The temperature of the gas flow out of the heater (or at a location to provide a temperature relevant to the chemical reactions or physical phenomena taking place within the effluent system or in the exhaust line from the catalytic converter, such as the temperature of the catalyst) is measured. The temperature of the heater can be controlled by a heater controller measuring the temperature, for example, of the mixed and heated gas flow through the catalyst where it is reacted before, within or after the catalytic converter. The reacted gas can then be mixed with ambient air to reduce the temperature, if desired. An O2 sensor may not be required under such an embodiment, and, in some embodiments, the heater may be run in an open loop configuration, such as when the heater is so sized, meaning that no sensors or controllers are required.

FIG. 13B illustrates an effluent treatment assembly 1301 comparable to the assembly 1300, except that it further includes flame arrestors, which can be positioned at one or more of the inlet to the heater, the effluent line prior to connection to the air line, the air line prior to connection to the effluent line, or elsewhere such as the system exit, if required.

FIG. 13C illustrates an effluent treatment assembly 1302 that incorporates a recirculation circuit, which in some embodiments can include a flow splitter and a recirculation pump 1384 to route at least a portion of the discharge from the catalytic converter to the inlet zone in front of the heater for example to heat the inlet stream. This configuration may allow some of the heat generated by the catalytic converter to be used for preheating the gas flow or equipment, reducing the heater load. The assembly 1302 may also include an optional recirculation splitter valve 1382 at the point where the catalytic converter discharge flow is split.

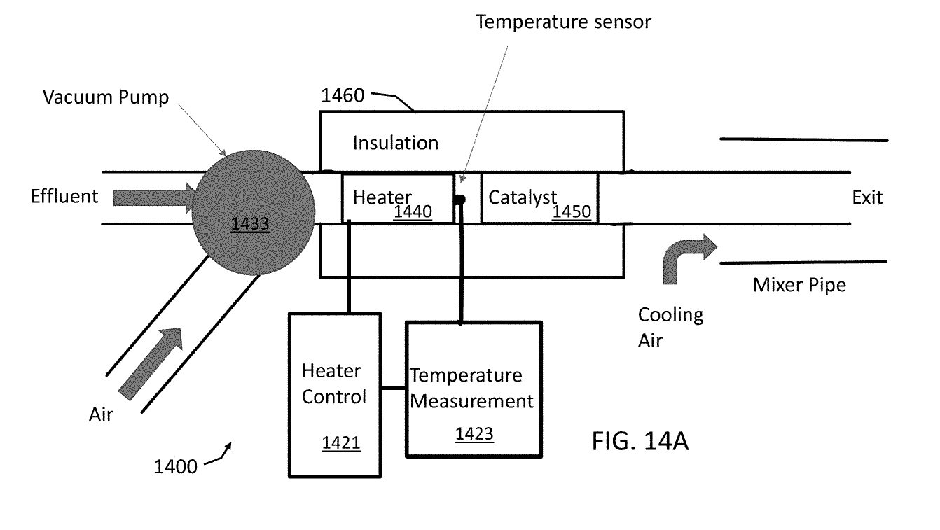

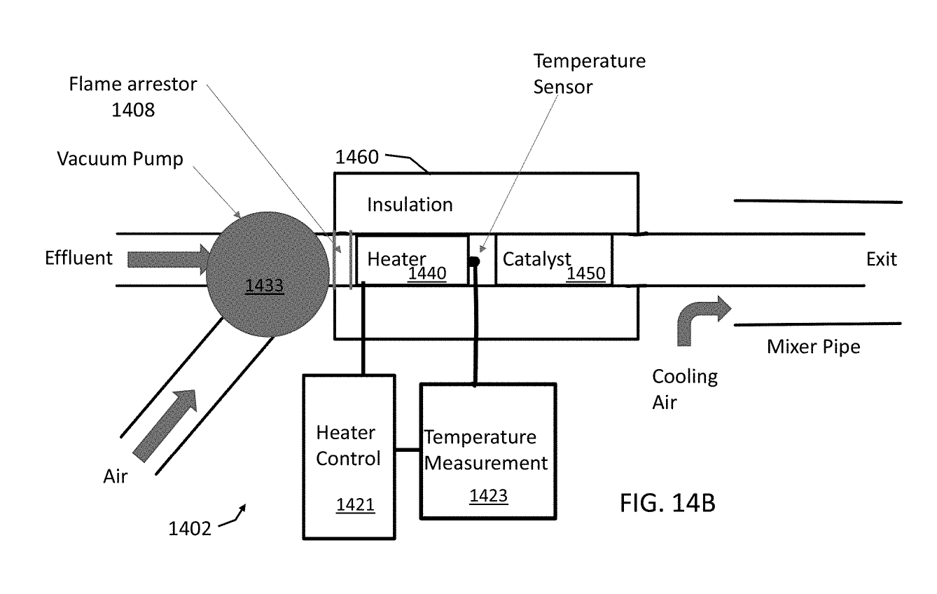

FIG. 14A illustrates an effluent treatment assembly 1400 with a catalytic converter, which may be comparable to the assembly 1300 of FIG. 13A, with the addition of a vacuum pump with a ballast system 1433 to combine the effluent and air into the mixed gas. The assembly 1400 can operate as follows: effluent and reaction air are mixed in the vacuum pump 1433 via the ballast system, and then heated by the heater 1440. The temperature at the outlet of the heater (or at a location to provide a temperature related to the temperature of the gas exiting the heater or entering the catalyst bed) can be measured by the temperature gauge 1423. The temperature of the heater can be controlled using the measured temperature using the heater controller 1421. The mixed and heated gas flow through the catalyst 1450, where it is reacted. The reacted gas may then be mixed with ambient air to reduce the temperature and/or to prevent condensation. In alternative embodiments, the temperature can be monitored at various locations. In addition, the heater may be divided up into a temperature controlled section (such as a pre-heater) and a constant heat input heater.

FIG. 14B illustrates an effluent treatment assembly 1401 comparable to the assembly 1400, with the addition of a flame arrestor 1408 located between the vacuum pump and the heater. A gas heater suitable for use in the catalytic converters described above may include a heating element with high surface area exposed to the air and an optional control system to close the loop on temperature of the exiting air. In some embodiments, the temperature controller can serve to control air temperature and to prevent the catalyst from overheating. There may be costs in terms of reliability, serviceability, capital cost, space, and complexity associated with the control system components and development.

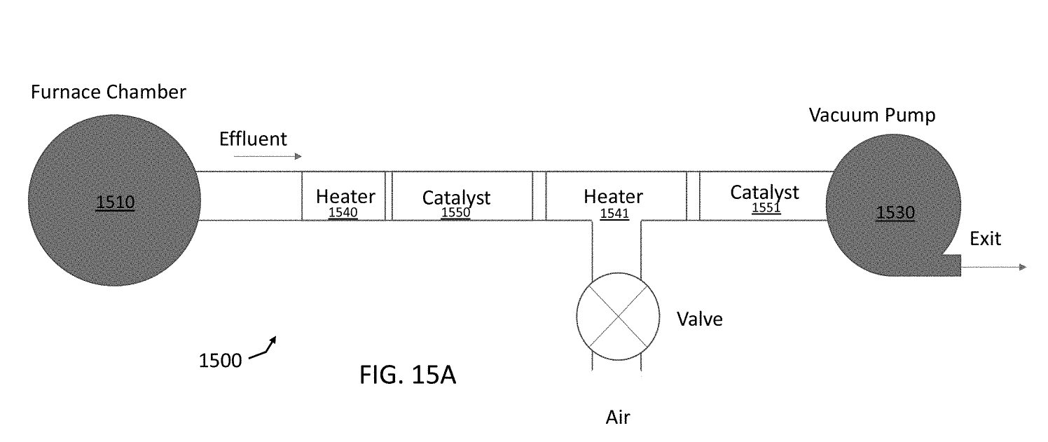

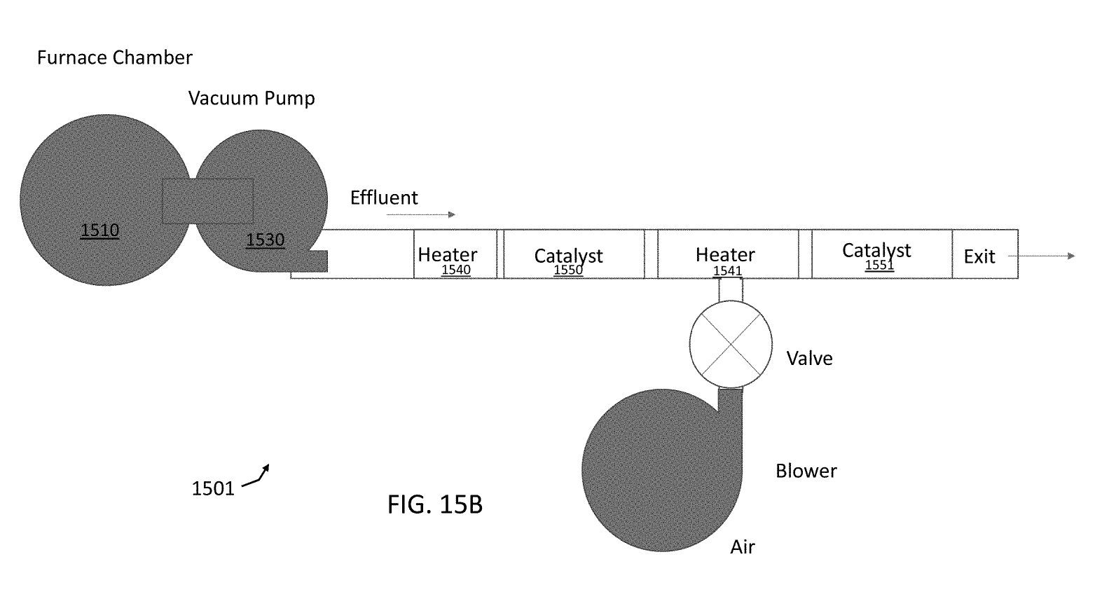

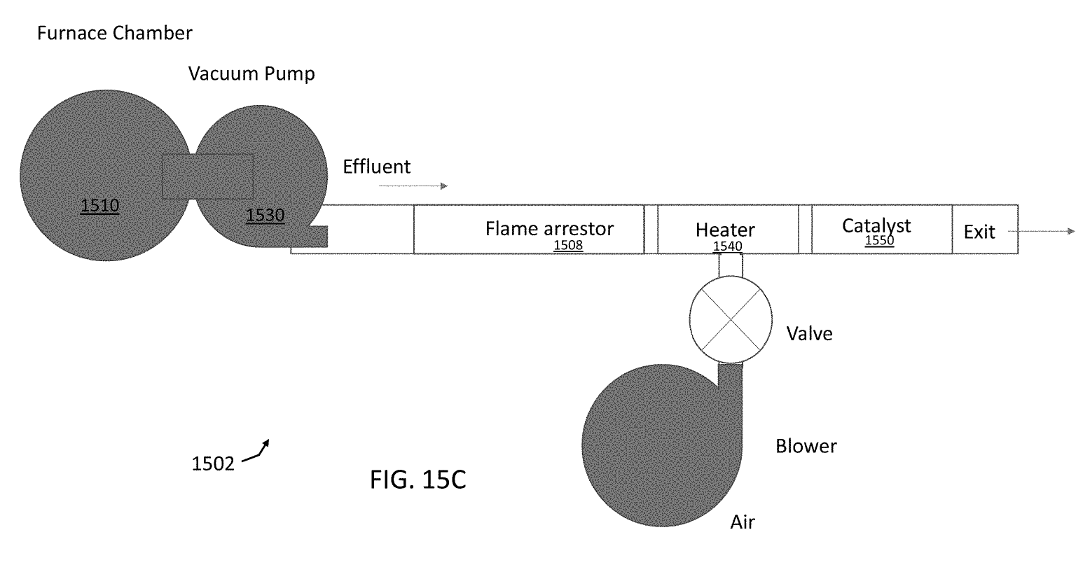

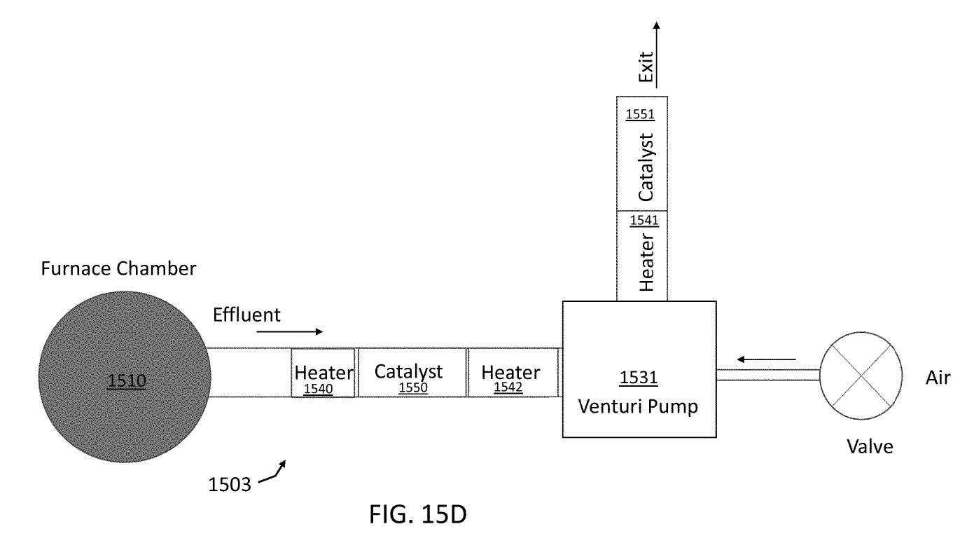

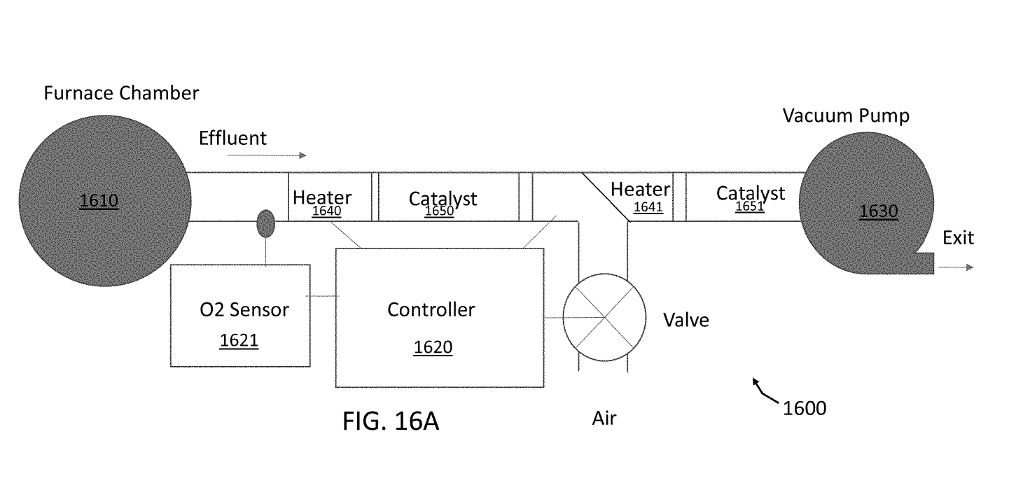

FIG. 15A illustrates an effluent treatment assembly 1500 in a further embodiment. Here, one or more vacuum-side catalysts 1550, 1551 and heaters 1540, 1541 may be configured and located to operate on the furnace side of the vacuum pump 1530, where the catalyst 1550 may be under vacuum at least during portions of an operating cycle. Such a configuration can facilitate the processing of gases at low pressure where more of the effluent is uncondensed, although an optional trap can be included in the processing stream, such as prior to a first heater 1540. Further, the hydrocarbons, which can react adversely with vacuum pump components and oils, can be converted before they can enter the vacuum pump. A challenge of a system combining a furnace 1510 and a catalytic converter is that catalytic conversion requires oxygen, yet it can be detrimental to product quality for oxygen to be present in the processing environment of the furnace at particular portions of the processing cycle. In a pipe flow, there is a boundary layer that is slow moving, which provides a place for diffusion of oxygen upstream. In a high vacuum, the mean free path becomes long and mixing is fast compared to the flow velocity. In both cases, injected oxygen can, under some conditions, flow back into the processing region, which under certain conditions can impair product quality.

In the assembly 1500, a catalyst system is located upstream of the air injection point as well as downstream. Some or all of the oxygen travelling upstream can react with effluent coming down stream and be converted into CO, CO2, or water, rather than travelling into the furnace chamber. If these reaction products continue to diffuse back into the furnace, they are less damaging than pure O2 would be.

FIGS. 15B and 15C illustrates effluent treatment assemblies 1501, 1502 comparable to the assembly 1500 of FIG. 15A, except that a vacuum pump is located immediately downstream of the furnace chamber and a blower is added to the air stream upstream of an optional valve prior to injection into the heater. The assembly 1502 also includes a flame arrestor 1508. In both assemblies 1501, 1502, an optional vacuum pump/blower at the discharge end of the effluent system that is shown in FIG. 15A is not shown.

The assembly 1502 also includes a variation of the assembly 1501 where the catalyst between the air introduction and the furnace chamber is replaced with a flame arrestor 1508, and the heater closest to the furnace chamber is replaced with a vacuum pump 1530. The flame arrestor can prevent the propagation of flame originating at the heater or catalyst upstream toward or into the furnace chamber and affecting vacuum components along that path (such as mist catchers) even if the O2 does propagate back upstream. It is also possible to include a flame arrestor between the heater and catalyst in case the heater ignites the gas stream. A flame arrestor can be included close to and on either side of any point of potential ignition and the other sections of the process for any of the embodiments described herein. Some catalyst designs also serve as a flame arrestor if they are at a sufficiently low temperature.

FIG. 15D illustrates an effluent treatment assembly 1503 connected to a furnace chamber, which in some embodiments can operate at a pressure near or above the ambient pressure with an effluent. The reactant can be combined with the effluent by way of a venturi pump 1531. In various embodiments, the furnace can be a tube furnace for which a flow of processing gas allows control of the venturi flow to ensure proper operation. Such an embodiment allows a system that can be operable without a mechanical pump. In some embodiments, the air valve shown can be eliminated. Additionally, some of the heaters and/or catalyst could be eliminated for some processes. In another embodiment, the system could replace the air valve with a pump or utilize a pump in addition to the air valve. In some embodiments, the air can be the motive fluid and in some embodiments, the effluent can be the motive fluid, depending, for example, on the relative flow rates, the pressure of the effluent and the pressure of the air (or oxygen or reagent). When the air is the motive fluid, the ejector of the venturi pump can evacuate gas from the furnace chamber and/or reduce the processing pressure therein. In some embodiments, the venturi pump may be eliminated, such as where both the effluent and the air have sufficient pressure for operation. Many of the embodiments illustrated and/or described herein can be applied to positive pressure furnaces.

In further embodiments of effluent treatment assemblies, assemblies with a pump and a valve, such as those shown in FIGS. 15A-D, can also be implemented with the pump and with the valve (optional) not being present. In some such embodiments where the valve is not present, it can be advantageous for the pump to be a positive displacement pump or one that can be utilized for controlling flowrate or limiting/controlling backflow.

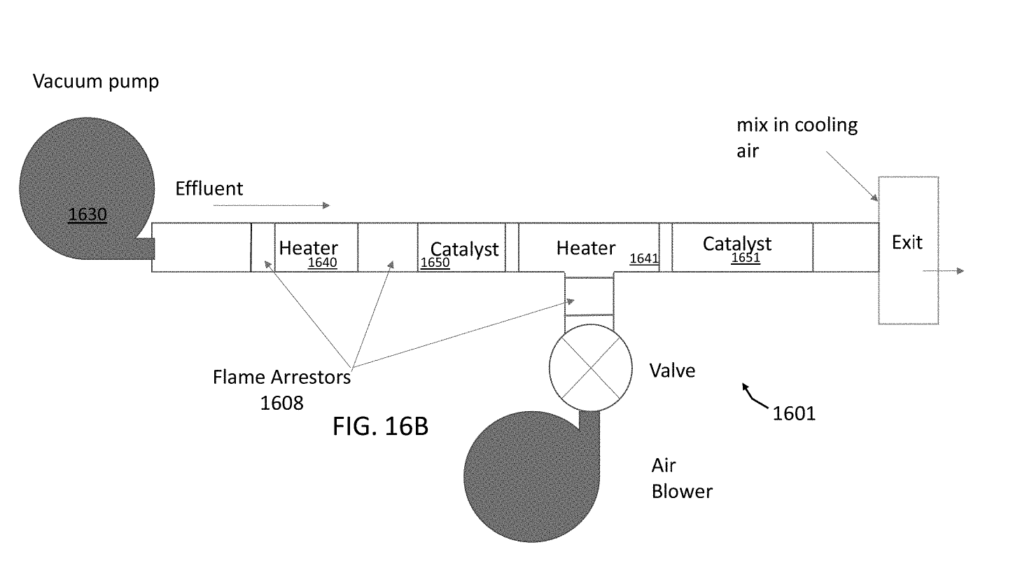

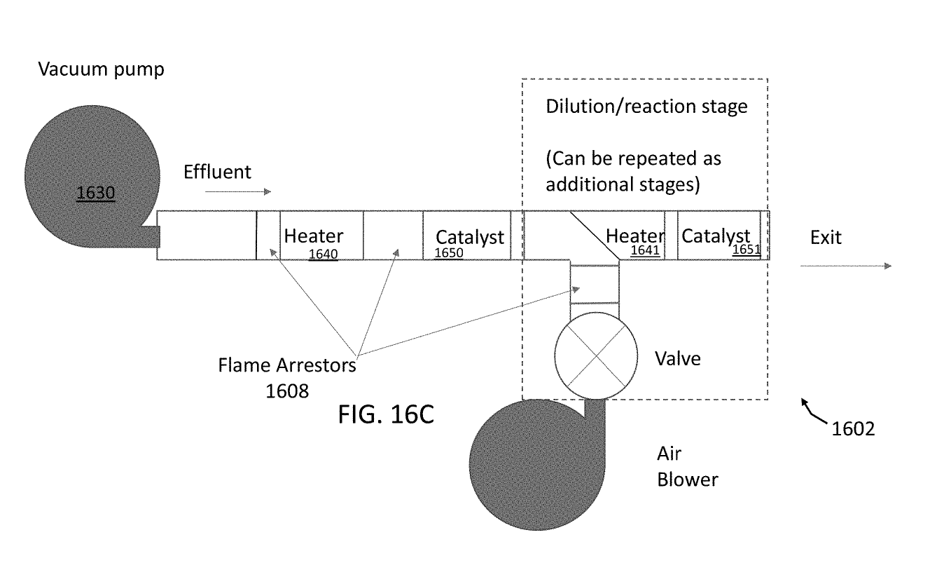

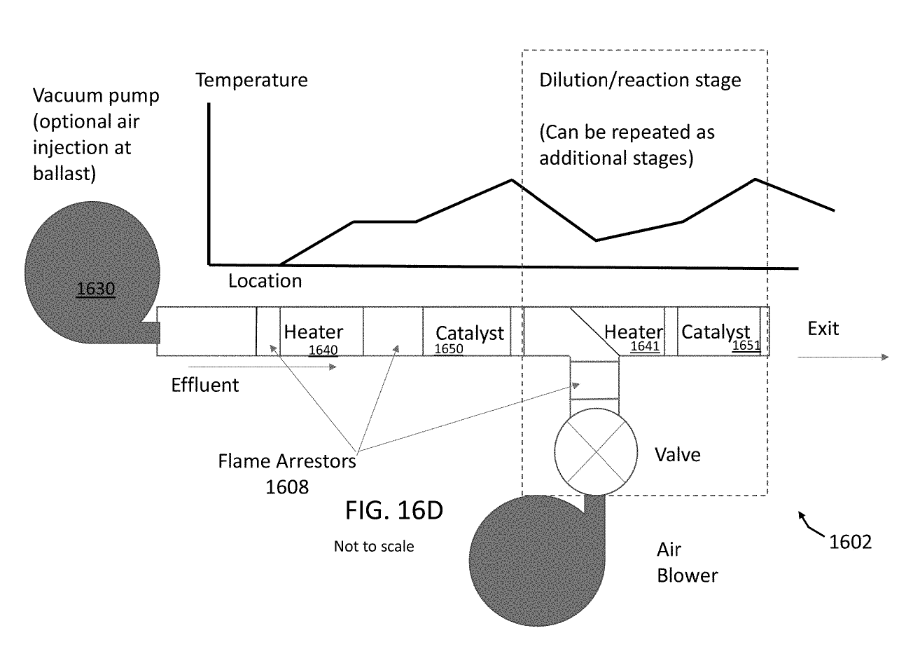

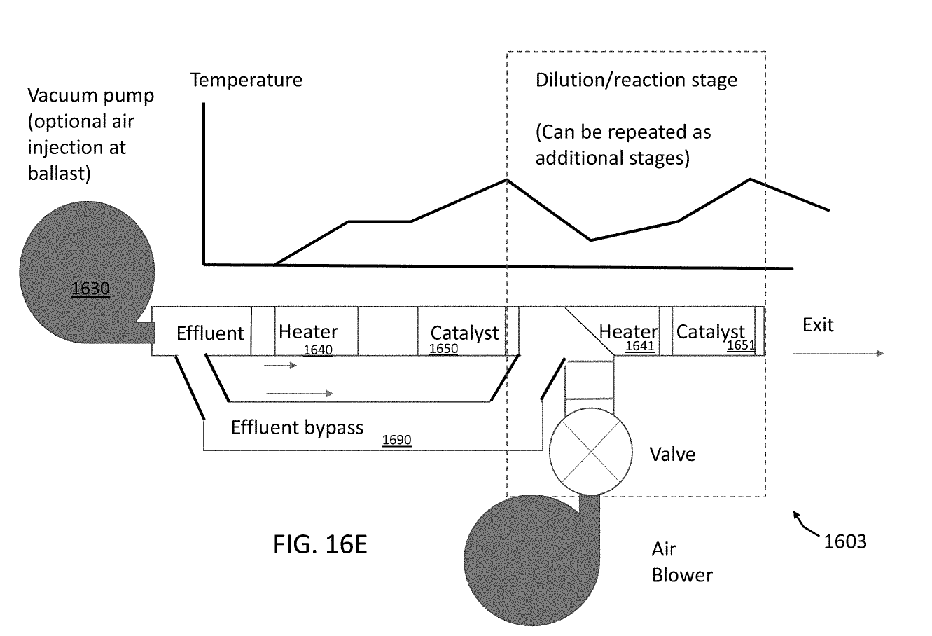

FIG. 16A illustrates an effluent treatment assembly 1600 connected to a furnace chamber 1610 in a further embodiment, which is comparable to the assembly 1500 of FIG. 15A, comprising a series of heaters 1640, 1641 and catalysts 1650, 1651 and a vacuum pump 1630. The assembly 1600 further includes a controller 1620 and oxygen (O2) sensor 1621. The O2 sensor 1621 may be positioned upstream of a first catalyst 1650, and a controller 1620 may provide feedback control on the air injection such that, if O2 is detected past the catalyst, the flow of O2 can be reduced accordingly.

In a variation on the embodiment of an effluent system shown in FIG. 16A, the O2 sensor can be replaced by another type of sensor, such as a temperature sensor after the first catalytic converter (catalytic converter closest to the furnace chamber), to serve as a control parameter. In operation, the temperature sensor signal can be used, for example, to control operating modes: when running at high air to effluent ratio (effluent limited condition), the temperature can be used to imply the amount of reactable effluent present in that as the amount or concentration of reactable effluent rises, the measured temperature would rise, and this temperature and/or temperature rise can be used to determine when to switch to a rich burn mode in the first stage (oxygen/oxidizer limited condition). In the rich burn mode, the temperature is an indicator of the amount of O2 present and can be used to adjust the ballast flow to achieve desired operation (for example, when the temperature drops, the amount of oxygen and ballast flow can be increased, and if the temperature rises, the amount of oxygen and ballast flow can be decreased).

FIG. 16B illustrates an effluent treatment assembly 1601 comparable to the assembly 1600, but incorporates flame arrestors 1608. For clarity, the control components of FIG. 16A are not shown in FIG. 16B. A catalyst can operate below the auto ignition point for many materials. For example, a catalyst operating at 300 C to 350 C can react the following materials listed by autoignition temperature and name that are commonly present in furnace effluent: 458 C for propene, 500 C for H2, and 609 C for CO. This attribute may be important when the mixture is locally within the explosive concentration range, as it allows the reaction to take place on the catalyst surface without propagating away from the surface as long as the temperature of the region is in the operating range but below the flame propagation temperature. Flame arrestors, which can be an inherent feature of the catalytic converter due to the high surface area to volume ratio of the passages, can prevent spreading of the ignition conditions outside the desired region.

Some embodiments of flame arrestors 1608 can be structures with flow passageways that provide a high surface area to volume ratio and a short distance to a surface completely spanning a flow passage. When a flame front enters an explosive mixture in the arrestor, there is close interaction of a small volume of the gas with solid matrix of the arrestor and the relatively high specific heat of the arrestor which brings gas below the reaction temperature, arresting the flame. This type of arrestor may be required to remain at a sufficiently low temperature to be able to cool the gas mixture sufficiently. Arrestors can be made, for example, of one or more capillary tubes in parallel, metal or ceramic foams with open cell structure, or wound or layered spaces sheets. Such structures are also often suited to holding catalyst materials.

The assembly 1601 illustrates how this ability of a catalytic converter to perform as a flame arrestor can allow multiple modes for a given configuration. For example, as described above and as the assembly 1601 illustrates, a small heater followed by a catalyst after the pump can efficiently catalyze small flows using ballast air from the pump. For high effluent flow rates for which more dilution air is required, the heater for the small catalyst can be turned off, the small catalyst cooled, and then the small catalyst may serve as a flame arrestor for any upstream combustible flows or events from the downstream converter. The ballast air injection can be turned off at high effluent flow rates for which the ballast air is inadequate dilution to prevent catalyst over heat. The second air inlet valve, fed by a blower, may provide enough dilution air for high flow conditions and the heater preheats to operational temperature.

In an alternative configuration of the assembly 1601, the first catalyst (closest to the vacuum pump) may have an active length short enough to prevent overheating due to the limited area and interaction time available even with the ballast flow on. The exit from this incomplete reaction provides a source of heat for the next stage of dilution air, reducing the demands on second heater or eliminating the need for the second heater. This approach of limited reaction area to limit temperature rise and provide a source of heat for a next stage of dilution, allowing elimination or reduction of heaters, can be repeated in multiple stages as shown in FIGS. 16C and 16D, described below.

FIG. 16C-D illustrate an effluent treatment assembly 1602 comparable to the assembly 1601, but highlights a dilution and reaction stage comprising a heater and a catalyst receiving both the exhaust gas and a reagent (e.g., air) from an air blower via a valve. This dilution and reaction stage may be duplicated, and two or more dilution and reaction stages may be assembled in a series configuration, thereby passing the effluent through multiple stages of air injection and catalyst. FIG. 16D further illustrates a non-scaled graph of the temperature profile across the assembly for one possible rich burn operating mode embodiment or short catalyst embodiments for which the catalyst system may be controlled to prevent overheating. At the first stage, the ballast flow (or effluent flow, or by design, the catalyst length) is controlled to provide a safe operating temperature for the first catalyst. Thus, the temperature rises through the heater and catalyst. The next stage injects dilution gas and/or cools the gas before the next stage of conversion. The process can be repeated to provide a wide range of operating conditions.

FIG. 16D illustrate an effluent treatment assembly 1603 comparable to the assembly 1603, but further includes a flow splitter to an effluent bypass conduit 1690 allowing a portion of the flow of effluent to flow bypass a first catalyst 1650, where the effluent flow is reacted and provides a hot input to a later stage (heater 1641 and catalyst 1651), which serves to preheat that stage. This configuration can be repeated for additional stages. In additional embodiments, the catalytic converter, either the first catalytic converter or that of a later stage, can have multiple effluent inlets arranged along its flow path.

In further embodiments of an effluent treatment assembly with an effluent bypass, the effluent and/or air can be distributed to different stages based on a balance of pressure drops, and in some embodiments, utilize fewer pumps. Such an embodiment can take advantage of the increased pressure drop from the expansion and acceleration of flow as the temperature increases. For example, with multiple parallel passages, passages that increase in temperature relative to similar cooler passages will produce a higher pressure drop, routing more of the flow to cooler regions, which provides a self-adjusting/compensation mechanism to distribute flow properly and limit thermal runaway. Embodiments can include pressure sensors to indicate the operating mode. A fast response pressure sensor can be advantageous in some such embodiments.

In the embodiments described above, and particularly in the assemblies illustrated in FIGS. 15B-D and 16B-D, the air injection at each injection point (including the pump ballast) can be controlled to be much less than a quantity needed for full reaction. Further, the peak temperature at any stage can be limited by the availability of O2 or reagent and the extra, unreacted effluent can serve as a temperature limiting medium. The catalytic material may be omitted from portions of the surface of the catalyst support in order to 1) control where and whether the reaction occurs, 2) to produce a flame arrestor feature in a cost effective integrated manner, and/or 3) to limit the reaction area available, and hence the reaction rate and heat produced to a level appropriate for the design conditions.

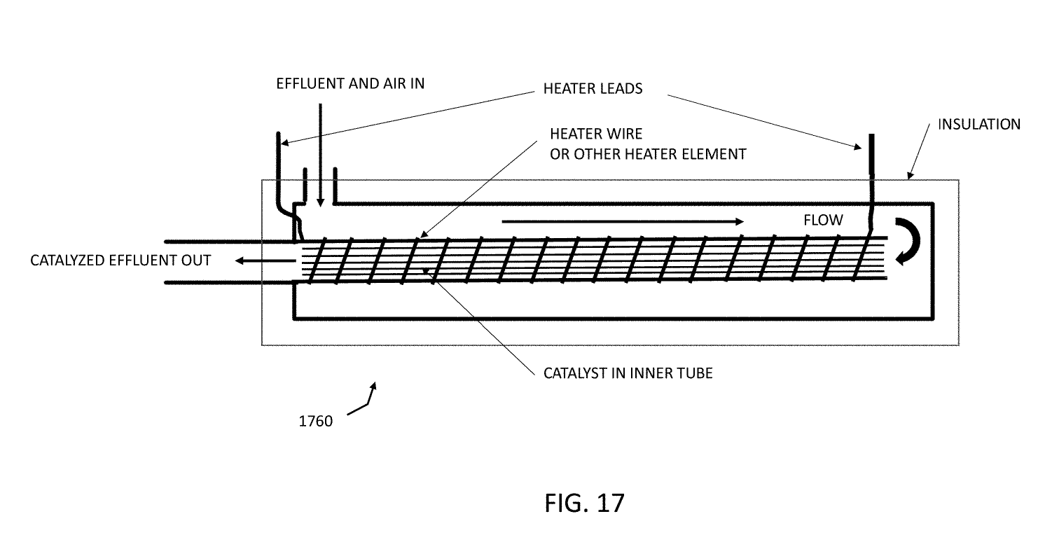

FIG. 17 is a diagram of a catalytic converter 1760 in a further embodiment, which can provide a counter flow near-stoichiometric system. The heater may be located outside the catalyst pipe so that the air/effluent mix coming in from the outside is preheated, as is the catalyst housing wall. The structure shown may be stretched into the page (or in another direction) to provide a very oval or thin slab construction with high surface area to volume ratio. This structure with a counter flow allows the heat to be used effectively and gives good surface area and residency time for heating. If the catalytic converter temperature rises beyond an acceptable level, then turning the heater off makes the effluent/air mix into a counter flow cooling system. This arrangement can be beneficial for applications where the effluent flow becomes larger relative to the ballast flow, for example if materials are processed in larger quantity. The system can then run with less ballast air, and feedback on the heater can be used to gain some more safe operating range. The central tube of the catalyst may be relatively small so that surface area to volume ratio is high and cooling can be fast and effective. The tube can also be flattened to allow a higher surface area to volume ratio. The system can be bent or otherwise shaped or part of a supporting framework to enhance space utilization.

In some embodiments, the counter flow feature can be reduced or eliminated, such as by shifting the inlet location toward the right side of FIG. 17. Elimination or reduction of the counter-flow provides a greater capacity to handle high effluent flow since the reaction products do not preheat the mixture, at least to the same extent. This switch in inlet could be done with a valve for example. Because the effluent flow rate is typically very low and the heat loss is typically high, a high surface area to volume ratio or a thin slab shaped catalyst system might be able to lose heat fast enough to protect itself during stoichiometric reaction. Such a catalyst (designed to dissipate generated heat and run sufficiently cool under peak loads with lateral heat transfer across the substrate layer(s)) could be heated by an external heater (rather than or in addition to heating the entering gas mixture) to operate correctly during the off-peak times such as when the heat generated is insufficient to maintain a desired reaction temperature without complex cooling system controls, excessive dilution air or relatively powerful heaters. A catalytic converter can also be provided with cooling jackets, passages, or another apparatus to provide with cooling as part of the design and that in some embodiments liquid or gas cooling medium can be utilized therein with potential a more compact local form factor.

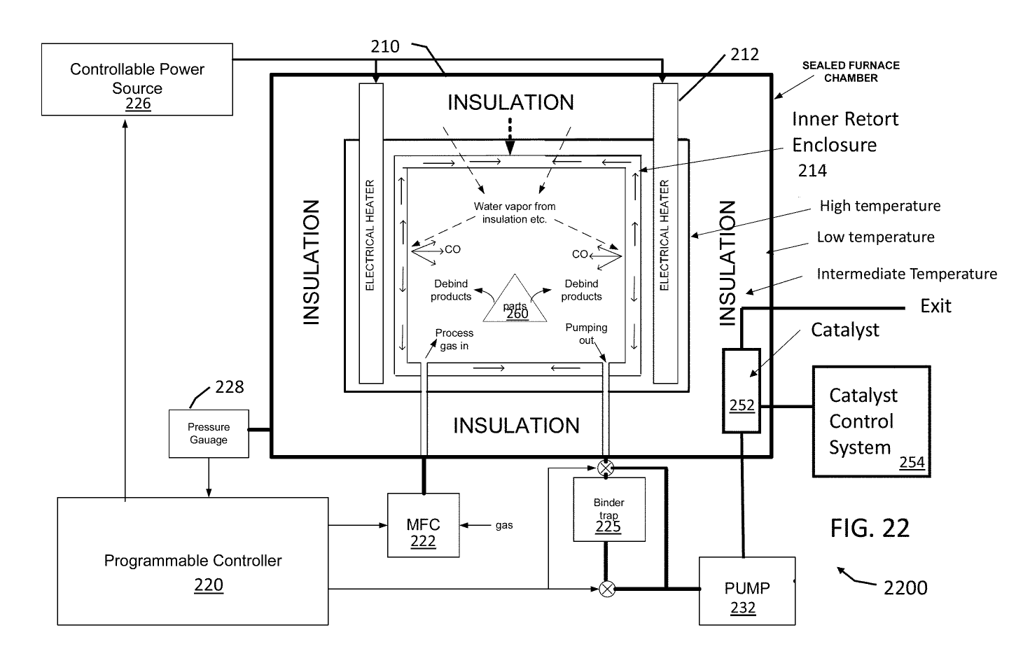

An additional embodiment relevant to embodiments including a binder trap, such as FIG. 4 or 22, is incorporation of catalyst as an aspect of the binder trap to allow conversion of the condensable species (before or after condensation, as a gas, liquid or solid) into harmless gaseous exhaust products to reduce or eliminate the need for removal/cleaning of such materials. Embodiments of each of the systems described herein can optionally include a binder trap, and these binder traps can optionally incorporate this catalyst feature.

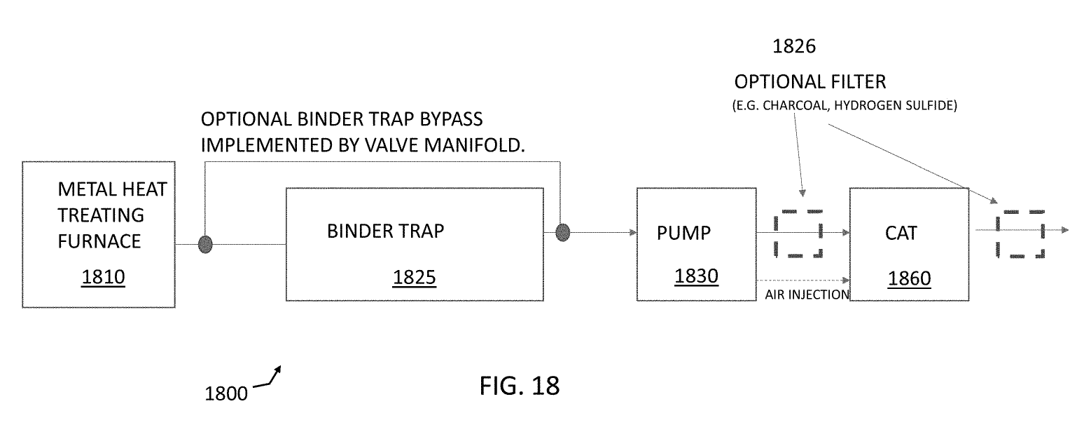

FIG. 18 illustrates a furnace system 1800 in a further embodiment, which incorporates filters 1826 (e.g., carbon filters) to filter components of the effluent before and/or after conversion at the catalytic converter 1860. A binder trap 1825 may also capture binder compounds of the effluent from the furnace chamber 1810 prior to receipt by a vacuum pump 1830. This arrangement can be suitable in cases where the catalyst is a room-temperature catalyst, and can be used to achieve improved performance in conjunction with a high temperature catalyst.

Many catalysts operate at temperatures well above room temperature (some embodiments operating up to approx. 300 to 600 C depending on catalyst and effluent). Alternatively, there are embodiments of catalysts that have sufficient activity at room temperature to catalyze reactions of CO (such as conversion of CO to CO2) at acceptable rates, but may not handle hydrocarbons adequately. It may be advantageous in some situations to utilize such different catalyst types for different parts of the cycle. For example, a room temperature catalyst might be used for the CO production phase (such as during sintering) which would reduce the heat load required from the power supply and heat to the environment during the key high-power sinter phase, and a higher temperature or a different catalyst might be used for portion(s) of the cycle that generate hydrocarbons (such as during debinding). Additionally, there are cases where debind is performed in air rather than under inert conditions. For air debind, the resulting products may contain significant amounts of CO and lesser amounts of hydrocarbon, and in some embodiments, a room temperature CO catalyst can be utilized for the entire operation cycle including both debinding and sintering. Although the focus in this description is generally on high temperature catalyst, due to their wide range of processing capabilities, catalyst technology is under constant development and the focus is not a limit, but rather on providing greater description of issues related to heated catalysts in furnace effluent systems. In some embodiments of effluent systems utilizing room-temperature catalysts, additional filters can optionally be included such as is shown in FIG. 18. For example, adsorbent filters such as charcoal, activated charcoal, or a molecular sieve, can be employed. Such filters can also be used in a system including a high-temperature catalyst. In various embodiments, a charcoal filter can adsorb many effluent components, such as noxious components. There are other adsorption and reactive filters for specific species. These filters may be replaced or rejuvenated as needed. The furnace system may utilize charcoal (activated carbon) or other systems along with or as a substitute for the catalytic converter. An example of use along with a catalytic converter is use of a charcoal prefilter to remove sulfur or other catalyst poisons such as halogens.

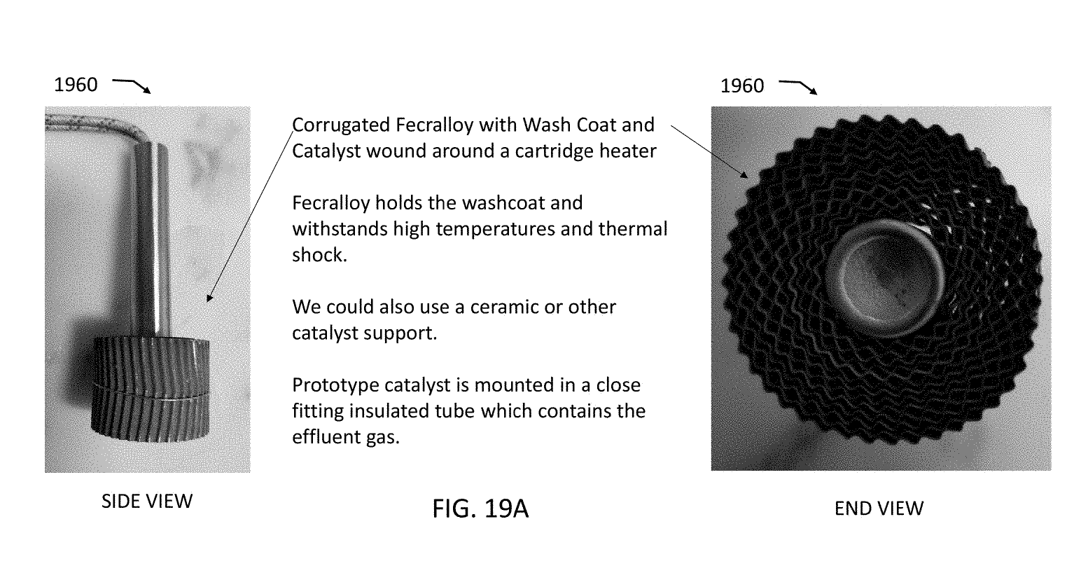

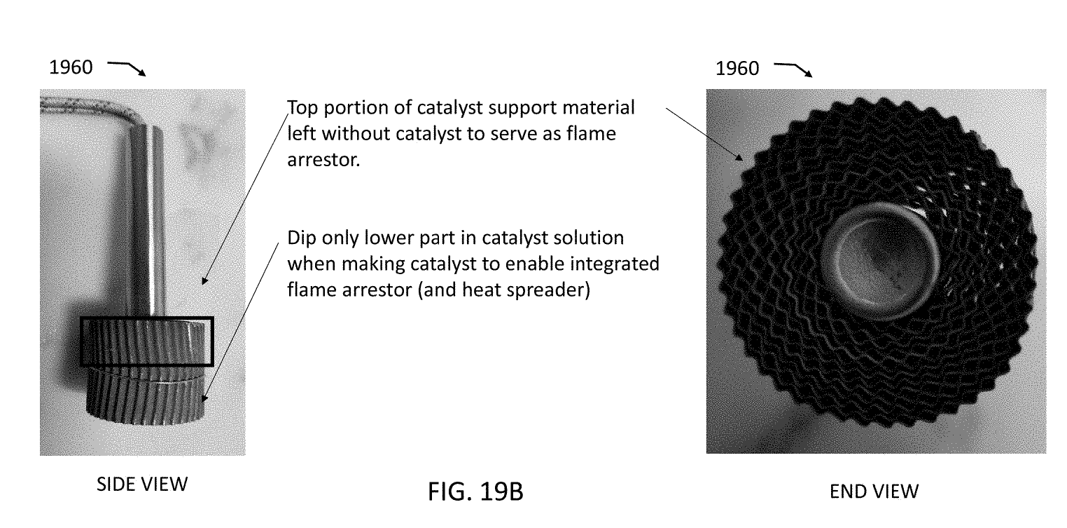

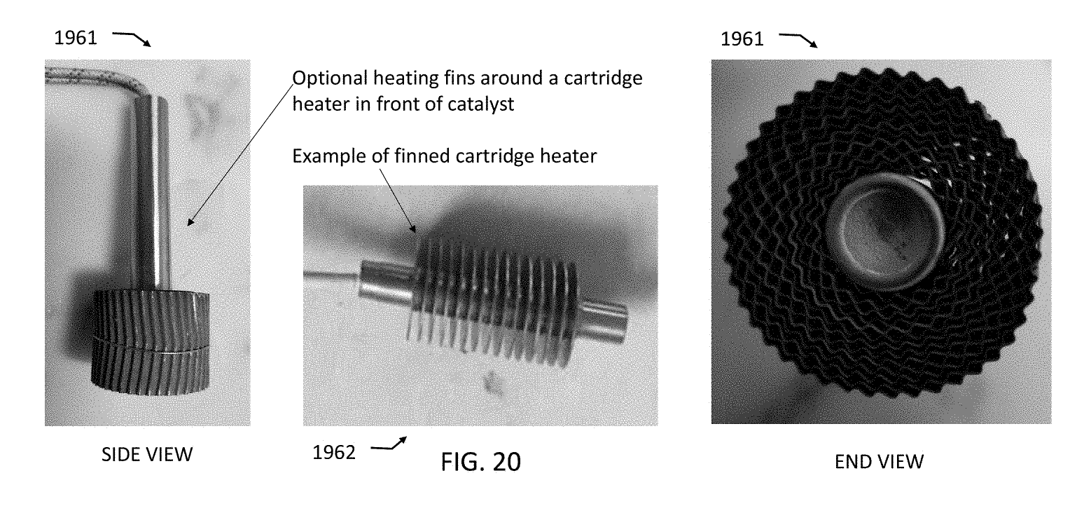

FIGS. 19A, 19B, and 20 are schematic diagrams illustrating example catalytic converters 1960-1962. As shown in FIG. 19A, the catalytic converter 1960 may include layers of corrugated fecralloy (an alloy developed for high temperature catalytic converters) or another support material (such as a ceramic material) with, in some embodiments, a wash coat and catalyst wound around a form or heater such as a cartridge heater. FIG. 19B shows an embodiment that integrates a flame arrestor to the catalytic converter by eliminating catalytic material from a portion of the substrate. The flame arrestor/heat spreader feature can be upstream or downstream or both. An embodiment of a catalyst having both ends not catalyst coated could be fabricated, for example, by dip wash coating fully or partially followed by washing or otherwise removing catalyst wash coat as desired. FIG. 20 illustrates two further catalytic converters 1961, 1962, which include finned cartridge heaters to efficiently heat the air passing through the catalyst.

In one embodiment, the catalytic converters 1960-1962 can include a catalyst material of palladium and platinum, as palladium can be efficient at catalyzing reactions of CO, while platinum is effective at catalyzing reactions of hydrocarbons. The catalyst substrate can be ceramic and/or metal, and the wash coat can include the metallic matrix, being porous and/or highly textured for high surface area doing the actual catalyzing. Wash coats can be bonded to the substrate by an oxide. Wash coat materials can include inorganic base metal oxides such as Al₂O₃ (aluminum oxide or alumina), SiO₂, TiO₂, CeO₂, ZrO₂, V₂O₅, La₂O₃ and zeolites.

In example embodiments, a furnace system as described above can be configured to optimize performance and minimize risk of contamination outside of the furnace system. For example, the wash coat can be configured to achieve more optimal tradeoffs between catalysis and tolerance of catalyst poisons. The size of the catalyst bed can be varied to provide more or less catalytic material, for example depending on the operation of the furnace and the rate of production of effluent, and may be sized to reduce risk of exhaustion of unreacted/undecomposed furnace effluent. This approach can also involve additional external heating such as for larger catalyst beds and to heat a higher air flow when greater flows of effluent are present. Further, manufactured parts to be sintered (e.g., 3D printed parts) can be preconditioned for the furnace by undergoing a process to remove certain binders prior to being placed in service. The gas feed to the catalyst during operation can also be preconditioned, such as via a filter, prior to entry into the catalyst. Filters may include an adsorber filter (e.g., charcoal) and/or chemisorbers or physisorbers. (As used herein, each of “adsorp” and “absorb” and variations on thereof can be used to refer to adsorption or absorption, except where the context clearly indicates a specific meaning is intended.) The filters can reduce the requirements for the catalyst, possibly enabling the use of a room-temperature catalyst.

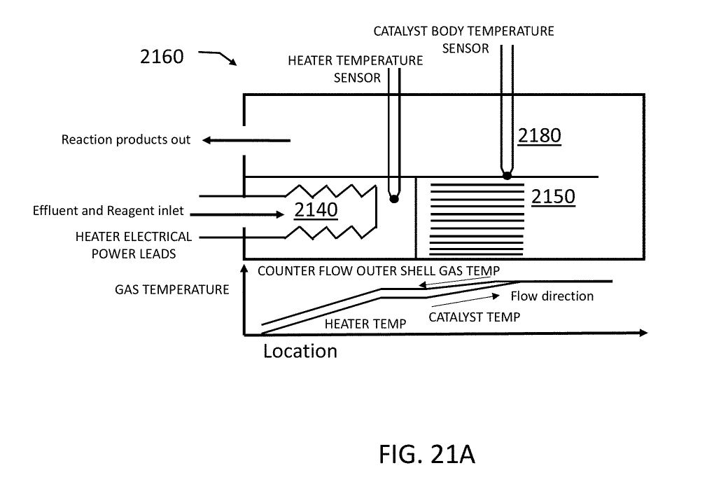

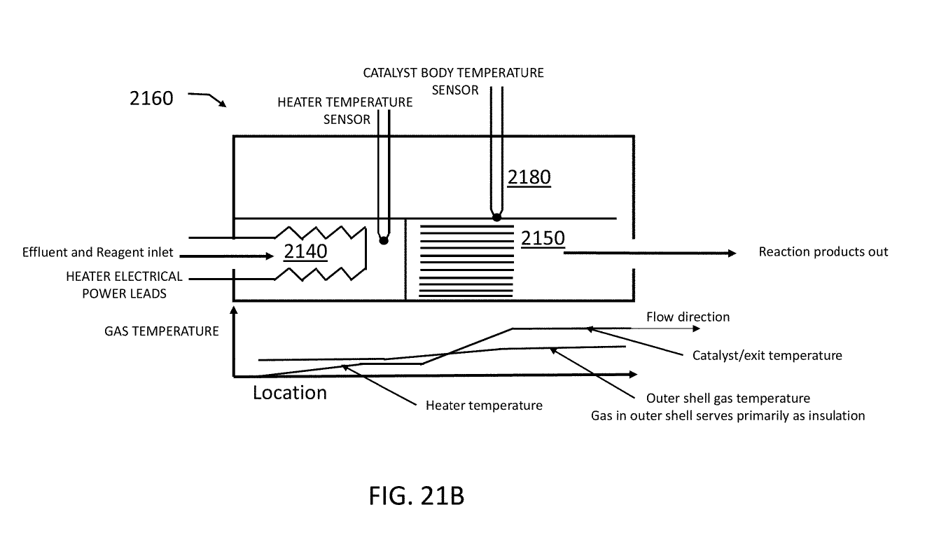

FIG. 21A illustrates a cross-cut side view of a catalytic converter 2160 in a further embodiment. Here, a heater 2140 receives the gas input and heats the gas before entry into a catalyst zone 2150. The heater 2140 and catalyst 2150 can be positioned in-line such that the air follows a path through both. A temperature profile, shown immediately below the catalytic converter, illustrates the rising temperature of the gas through the heater, followed by a sustained higher temperature at the catalyst zone (with the temperature through catalyst zone in some embodiments varying somewhat from constant due to the heat of reaction and/or heat transfer occurring). The higher temperature at the catalyst may be maintained by conduction from the heater, convection via the heated gas, and exothermic catalysis. After flow through the catalyst zone 2150, the gas follows a path in a reverse direction through an outer conduit 2180 adjacent to the heater/catalyst arrangement. This configuration produces a counter-flow arrangement in which the gas travelling back outside the inner catalyst is already hot and thus maintains the operational temperature effectively. A further catalyst can be put in this outer conduit 2180. After passing adjacent to the catalyst region 2150, the gas passes adjacent to the heater 2140. In this region, the exit gas and heater flow are in a counter-flow heat exchanger arrangement, which utilizes some of the heat from the exit gas to heat the gas entering and in the heater. This not only allows the gas to cool before exiting the catalytic converter, but recovers some of the heat to the gas flowing into the heater/catalyst, reducing the heater power requirements. A counter point to the counter flow arrangement is that the heat of reaction is transferred to the inlet flow, so there is less sensible cooling (Cₚ×Δ T) from dilution air. A “perfect” counterflow exchanger would continuously increase in temperature under exothermic reaction as energy is recovered from the exit stream and continuously added from the reaction; hence, the use of counterflow is primarily of interest at low flow rates when the objective is to keep the catalyst hot enough. Switching the flow configuration from counter flow over heater, to counterflow over just catalyst to no counterflow is a possibility for wide range operation.

In further embodiments, the outer conduit can surround the heater/catalyst arrangement such that the heater/catalyst occupy a central core of the catalytic converter. A layer of insulation (not shown) can encompass the outer conduit to retain heat within the catalytic converter. This configuration can be advantageous because the hot air exiting the catalyst can contribute to heating the catalyst as it travels through the outer conduit, transferring its heat to the catalyst through the shared wall between the outer conduit and catalyst, or at least reducing or eliminating the heat loss from the outer wall of the catalyst. If the exothermic reactions at the catalyst are substantial, then the heat from the far end of the catalyst can contribute to heating the cooler end as the gas flows back through the outer conduit. Because gas flow may be low and the catalyst may be relatively small, the catalyst surface area-to-volume ratio may to be high. Thus, heat conservation is a substantial advantage in the embodiment shown. In contrast, a typical automotive catalytic converter is large, has higher flow, and thus has a much lower surface area to volume ratio, which ensures adequate temperature of the catalytic converter.

FIG. 21B illustrates a cross-cut side view of a catalytic converter 2161 in a further embodiment. Here, a heater 2140 receives the gas input and heats the gas before entry into a catalyst zone 2150. The heater 2140 and catalyst 2150 can be positioned in-line such that the air follows a path through both. An outer conduit 2180 may be located adjacent to heater 2140 and catalyst 2150 comparably to the embodiment of FIG. 21A, and may optionally form a shell encompassing some or all sides of the heater 2140 and catalyst 2150. However, a conduit extension 2181 terminates in an exit away from the outer conduit 2180. Thus, after flow through the catalyst zone 2150, the gas follows a path in a direction through a conduit extension 2181, and substantially avoids flow through the outer conduit 2180. As a result, the outer conduit 2180 provides a degree of heat retention to the heater 2140 and catalyst 2150, but retains less heat than the catalytic converter 2160 of FIG. 21A. Such an embodiment may assist retaining proper temperature at the catalyst 2150, preventing it from overheating.

Referring again to FIG. 19A, the radial heat transfer of the catalytic converter 1960 can be poor due to the layering of foils and air passages. The energy available from the small amount of reactant on the outer channel is easily extracted by conduction, and if the outer channel is too cool, effluent will escape unprocessed. Thus, very good insulation or a means of reducing the temperature difference from the inside to outside is important. One way to achieve this is by flowing or exposing outside of the catalyst container to the hot exit gas. Another means is by applying heat to the outside, which can be helpful with low flow settings and the heat can be turned off at high flow.

In various embodiments, catalyst heating can be accomplished by any suitable technique, such as by electrical resistance heating, electrical induction heating, interaction with a burner (or hot burner gasses), heat from the catalytic reaction, and/or use of a heat transfer medium such as a fluid (gas, water, oil, liquid metal, or other heat transfer fluid). Cooling can be accomplished by any suitable technique, such as by use of a heat transfer medium, by radiation, conduction and/or natural convection.

In some embodiments, heat from catalytic conversion can be directed to the binder trap (and/or nearby components) to heat the material caught in the binder trap and change the phase of the trapped solid and/or liquid trapped debind products. This transfer of heat cools the catalyst and/or catalytic converter outlet flow and reduces or eliminates additional heat required to vaporize the trapped debind products. While this disclosure has presented methods and equipment in the context of gaseous processing, this disclosure including its methods and equipment can also be applied to liquid, powder and solid systems, including the interaction of catalysts with these different phases and forms of materials including different phases and forms of effluent, such as effluent that has been trapped in a binder trap, whether present in a solid, powder, melted or gasified form to be processed through effluent systems as described herein.

Heat transfer medium can be, for example, circulated through jackets or through conduits placed in contact with the gasses to be heated or the catalyst structure. Heating with electrical heaters (e.g. resistive, capacitive, dielectric, inductive, microwave, RF, arc) can be by direct interaction with the gas, or by heating the wall of a channel or a portion of the catalyst structure. In some embodiments, a heat pipe or other heat conductor can thermally couple a heating or cooling source to the catalyst bed.

FIG. 22 illustrates a furnace system 2200 in a further embodiment. The furnace may be configured comparably to the furnace system 401 described above with reference to FIG. 4B, and may further include a catalytic converter 252 located within the furnace, such as in an area between an outer wall of the furnace chamber 252 and insulation, within a portion of the insulation, between the insulation and a retort, within the retort, or a combination thereof, so as to provide an acceptable operating temperature or when combined with additional heating and/or cooling to provide an acceptable operating temperature. In some embodiments, the cooling (and/or heating) of the catalytic converter can be provided by a part of a furnace cooling system which is otherwise used to reduce cycle time. A catalyst control system 252 may incorporate catalyst controls as described above, and may operate in conjunction with the controller 220.

In some embodiments, a catalytic converter can be oriented so that some or all liquid created from accumulated condensable material flows to the catalyst, where at least a portion of it can be reacted to CO2 and water. One possible mode of operation is to vary the temperature of the heater, first starting at low temperature so that condensable material is collected, then, at an appropriate time in the cycle, perhaps when there is little else to catalyze, raise the temperature so that the materials is liquefied or gasified and can drip, flow or otherwise enter the catalyst region. If a greater region upstream needs to be melted to keep the passage clear, it may be necessary to extend the heater or place an additional heater in the feed line.

Some embodiments of a catalytic converter described herein can utilize a heater including a heater wire. A heater wire can have a high thermal coefficient of resistance and can be used to determine the flow rate and temperature of the effluent and reagent mixture as it flows through the heater by measuring changes in resistance and current that are being used to power the wire. In various embodiments, there can be several modes of operation using the heater wire in this manner, such as those used for hot wire and hot film anemometry. Utilization of a heating wire (or other element) that increases in resistance as the temperature rises for hot wire anemometry include:
a) Constant voltage operation: as flow increases, the temperature of the element falls as does resistance; current increases. This mode of operation can require measurement of operating current and a steady and consistent supply voltage.
b) Constant current operation: as flow increases, the temperature of the element falls as does the resistance, and the voltage required to drive the constant current falls. This mode of operation can require a sufficient constant current supply and voltage measurement.
c) Constant temperature (resistance) operation: as the flow increases, the resistance falls, a feedback circuit adjusts the current and voltage up to increase the heating so that the temperature and resistance rises back to the target value. The constant temperature method is often favored. Because the objective of the heater for the furnace catalytic converter application is typically to hold a desired temperature, this operating mode can be effective for sensing flow as well as maintaining temperature. The control circuit can include a resistor bridge and amplifier circuit.

There are many ways to size and control the catalytic system. One embodiment incorporates a very large catalyst, very large dilution air pump, and very large catalyst preheater. If such a system is large enough to handle any effluent production rate, then it can be operated with the heater temperature set to ensure the catalyst is at operational temperature and the catalyst will always have enough dilution air to stay below the maximum temperature.

Another embodiment might be preferred, for example, in situations where the heat of reaction due to the effluent flow rate combined with the heater input has potential for causing the catalyst to overheat. In some such embodiments, the inlet heater power can be turned down or turned off as the heat of reaction maintains the temperature of the catalyst. Reducing the inlet heater temperature lowers the catalytic converter inlet temperature and thus allows a greater temperature rise before the catalyst overheats. In some further embodiments, the heat of reaction for the flowrate of effluent with no additional heat input can result in overheating the catalyst. In such situations, a furnace operational profile can be utilized as described below with reference to FIGS. 23 and 24.

FIG. 23 is a plot illustrating operational parameters and measured properties of a furnace system following a sintering process in an example embodiment, and may be referred to as an operational profile. The furnace may be as described in the section below titled “Example ‘Office Friendly’ Vacuum Furnace,” with the effluent and control system as shown in FIG. 11C, with temperature sensors (thermocouples) measuring the heater temperature at the outlet of the heater and measuring the catalyst temperature at the body of the catalytic converter. Temperature control in this example includes a cascade arrangement with an inner loop control for heater temperature to modulate the heater power, where the heater temperature setpoint is adjusted by an outer control loop based on the catalyst body temperature. The catalyst controller can also supply a control signal to the furnace control system, which controls the power to the furnace heating elements to control/maintain the temperature of the furnace as measured by the furnace temperature measurement system.

In this example, the furnace was loaded with 3 kg of brown parts (approximately 25 parts, total), where the brown parts are formerly green parts that have undergone a chemical debinding process to remove at least a portion of the binder material. The process illustrated begins after pump down and purge to clear atmosphere from the furnace, and after a period of heating the furnace to a point where the debind phase begins to enter the active gas generation phase of debinding. The debind was performed with no process gas added, and the vacuum valves were completely open for maximum vacuum, and the ballast was set to maximum for the Edwards Rv8 pump used in the test (approx. 16 slpm of air injection as ballast.) In one embodiment of a control system, and as utilized for this example, the catalyst heater temperature can be controlled with a cascade controller which can utilize a fast inner loop controlling the heater temperature with the setpoint set by the catalyst temperature controller, and a slow outer loop controlling the catalyst temperature. Here, a setpoint of 315 C was used for the catalyst temperature. Initially, (beginning of debind) the heater was operated to hold the desired catalyst temperature (315 C) which resulted in a heater temperature of 410 C.

As debind gas (effluent) was generated, the effluent reacted with the vacuum pump ballast air in the catalyst, which increased the catalyst temperature. The catalyst temperature increase is the feedback input to the catalyst inlet heater control, which reduces the heater temperature set point to reduce the catalyst temperature back towards the 315 C target. As the effluent flow increases, much of the heat required to keep the catalyst at operating temperature is produced by the effluent reaction and the heater power/temperature is dropped (by the outer loop control adjusting the heater temperature setpoint to hold the catalyst body temperature at 315 C) so that cooler effluent/air mixture enters, which helps keep the catalyst cool. When the temperature of the heater temperature sensor falls below about 330 C an additional air pump, (not shown in FIG. 11C) is switched on, suppling approximately 12 slpm flow additional air flow upstream of the heater now being added to the 16 slpm of the vacuum ballast flow, which may help keep the catalyst temperature within a specified range. (A deadband on the additional dilution air pump on off control is set to keep the additional dilution air pump on until the heater temperature set point rises to 380 C to prevent cycling of the additional dilution air pump and ensure the additional dilution air is not stopped prematurely.) This additional air initially cools the catalyst which results in a brief increase in heater temperature at approximately 3 hours as shown in FIG. 23. This transition to higher air flow rate for cooling is followed by a further drop in heater temperature as effluent reactivity continues to increase until, at approximately 4 hours as shown in FIG. 23, the catalyst temperature rises and the heater temperature stops falling at roughly 210 C, which is the temperature under these conditions with the heater power off (The temperature is higher than the inlet to the heater because the heater is in close proximity to the catalyst and the thermocouple and heater outlet are heated radiatively and by conduction from the high catalyst temperature.) At this point, the heater is off and reduction in heater power is inadequate for maintaining catalyst temperature at 315 C and catalyst temperature rises as reactive effluent flow increases. When the catalyst body temperature rises above ˜400 C, the furnace temperature ramp is put on hold to reduce effluent production/flow and limit catalyst temperature rise. (There is a deadband on this trigger to maintain the hold until the catalyst temperature falls to 320 C.) The furnace ramp stop/hold eventually slows the production of debind effluent and reduces the catalyst temperature rise rate, which peaks at approximately 5.5 hours. After the peak, effluent production is falling as does catalyst temperature. When the catalyst temperature falls to 320 C, the furnace ramp is activated again and the debind ramp/cycle continues from where it stopped.

In this test, the interruption of the furnace temperature ramp only occurred once, but in additional embodiments or with different furnace loads, the furnace temperature ramp can be interrupted more than once if desired or if beneficial in controlling the temperature. The ramp continues and, in this case the catalyst continues to stay under the control of the inlet heater throughout the sinter cycle.

At the end of the debind cycle (the end of the hold at ˜550 C at ˜11 hours), the sinter process gas flow of 0.4 slpm is initiated as the sinter cycle begins. The reduction in effluent production due to end of debind and the additional dilution cooling due to process gas flow causes the catalyst temperature to fall and the heater temperature to rise above the 380 C deadband limit for the additional dilution air pump, causing that pump to turn off. The catalyst temperature rises due to the large step reduction in dilution air, which also causes the heater setpoint temperature to fall. In this case, it does not fall enough to retrigger the additional dilution air pump. The system reaches a new operating point with just the ballast air and process gas flow for dilution for the remainder of the sinter cycle.

The reactivity of the effluent over the sinter cycle is apparent from the catalyst heater temperature. When the heater temperature falls it indicates increased production of reactive effluent is heating the catalyst. This increase occurs between 1000 and 1100 C where the first sinter hold occurs. The effluent production/reactivity then falls causing the heater temperature to rise. At 1200 C the heater temperature again falls indicating increase in reactive species and then rises as sinter completes. Note that the evolution of water from the furnace insulation reacting with the graphite in the retort provides a source of H2 and CO for the catalyst to react over most of the sinter cycle above the debind temperature of ˜550 C and sintering of the metal releases reaction products.

At completion of the sinter cycle, the furnace cooling cycle starts. First the heater power is cut. After a period of time, the furnace is valved off from the vacuum pump and is backfilled with (inert) gas to enhance the cooling rate. This is marked by the broken line that is near vertical at approximately 32 hours, which is the output of the high-pressure sensor (pressure in the furnace chamber). Because no effluent flows when the furnace is valved off from the pump, the catalyst is shut down (effluent is not reacted in the catalytic converter); however, the furnace still has effluent contained in the furnace chamber, and it is now at an elevated pressure. It can be advantageous for this effluent to be purged and processed by the catalyst before the furnace is opened, so, in some embodiments, near the end of the cooling cycle, the flow to the catalyst is turned on again.

FIG. 24 is a plot illustrating the cycle pattern at the right side of FIG. 23 where the furnace is purged before opening. In this case, the effluent is at a high pressure in the furnace chamber and opening the valve for a brief time allows enough effluent and air from the pumps to flow that the catalyst temperature climbs rapidly and the valve may be shut off to prevent overheating of the catalyst. (In the test run shown in FIG. 24, an on/off valve was used, however a throttling valve or control valve of an appropriate size and design can also be used to provide greater control. In additional embodiments, an orifice, a variable orifice or a flow restriction of a different type, such as a snubber or fritted disk, can be used to achieve greater control and reduce or eliminate the need for repeated opening and closing of the valve).

As shown in FIG. 24, the catalyst heater is turned on as the furnace approaches safe opening temperature so that the catalyst can reach reaction temperature. The valve can then be opened to allow the effluent to flow from the furnace chamber to the pump and then catalyst. This inflow initially causes a blip in the catalyst heater temperature as the added flow increased the temperature at the location of the temperature sensor just downstream from the heater. Shortly after opening the valve, the catalyzed reaction of the effluent begins and the catalyst temperature climbs and the heater temperature is reduced. If the valve were left open, the catalyst might over-heat, and so the valve is closed to allow the catalyst to cool. Once the catalyst has reacted the pulse of effluent and has cooled enough, the valve can be opened again, typically briefly, as the process may be repeated several times to avoid overheating of the catalyst. Once the furnace chamber effluent is cleared and the catalyst heater temperature shows no or low enough catalyst heating from effluent, the catalyst operation can be ceased and the furnace can be opened. This embodiment, as described above and shown in FIGS. 23 and 24, is just one of many possibilities for furnace operation and control for operation with a catalyst. Different methods of temperature control and effluent control can be used with aspects of this operational description.

The features shown in this case include use of vacuum pump ballast flow and an inlet heater. Use of additional dilution air to cool the system occurs as heater power/temperature falls due to exothermic reaction of effluent. When the inlet temperature can no longer control catalyst temperature, the furnace heating power/temperature is controlled to maintain the catalyst in the proper operating range. This example also includes using pulses of effluent well above any safe, steady operating capacity of the system. In this mode, the specific heat of the catalyst is a primary means of keeping the temperature rise slow enough to allow the effluent valve to be closed. Then the catalyst can cool, and once cool enough, another spike of effluent can be processed. This process is repeated until the furnace effluent is small, at which point the furnace can be safely opened.

The catalyst operating characteristics, such as temperature and dilution flow, can be an indication of effluent production rate. When effluent production stops entirely, debind is complete and the next step in the process can proceed. This approach of monitoring effluent production and controlling the process can be used to speed the process.

In some embodiments, it is possible to measure effluent production rate by catalytic converter operating conditions. The catalyst operating parameters can be observed over time to determine the state of the part or process. An example is to monitor the heat generation rate in the catalytic converter, with this rate being related to the effluent production rate, and when the heat generation rate is too high, the furnace operation can be reduced (such as by reducing the furnace temperature ramp rate and/or increasing pressure in the furnace chamber) for example to avoid damage to parts being processed when the gas production is too rapid. Under some conditions, parts can break apart or explode under such conditions. In some cases, the damage might affect surface finish of the parts being produced.

Control solutions to limit debind rate as described herein include a description of keeping the catalyst in a particular temperature range. However, in some embodiments, where the catalyst is well within its temperature range, the operating parameters such as temperature rise and heater power indicate effluent production rate, which can be related to the state of the part/process, can be used to adjust furnace operating conditions to control the process. (For example, integration of the reaction energy associated with catalyst operating condition can provide a measure of the state of debind). In some embodiments, when the characteristics of the parts being processed (e.g. size, thickness, mass, binder fraction, binder type, surface area, density, metal type, particle size), and the furnace load are taken into account, the catalyst operating condition can be used as a real time furnace process control parameter, allowing the process cycle and/or conditions to be adjusted, speeded up or slowed down to produce the best performance or to determine and modify the characteristics of the process during development. In some embodiments, the process gas flow can be modulated based upon the measured catalyst operating parameters.

For application to additive manufacturing, where the characteristics of the parts and furnace load can vary over a wide range and might not be repeated, application of real time furnace control combined with predictive parameters related to surface areas, volume, and/or heating characteristics, can be an important tool in furnace process control and for development of systems to predictively match process control to part parameters.

The features described above regarding furnace control in debind can also be applied to sinter ramp and hold. Sintering can produce effluent based on process reactions. For example, in a reducing environment oxygen can be released from the material being processed. This release can be related to temperature distribution in the part. The oxygen reacts with the active reducing agent in the process, typically hydrogen. This reaction of the oxygen can take place prior to the catalytic converter, such as within the furnace itself, and can reduce the temperature rise in the catalyst since now some of the hydrogen is already reacted. This information can be used to control ramp rates and hold times to prevent part cracking due to differential contraction or as an indication of a process that is not proceeding as expected, indicating a problem with the furnace or the algorithm used to determine part behavior. Whereas the gas composition might be measured with expensive instrumentation to similar effect, use of the catalyst for this reduces cost and increases reliability of implementing real time furnace feedback control, such as by allowing the control scheme to be more account for more parameters than operating at a fixed temperature for a fixed time, a process that often requires experimentation and experience. Additive manufacturing can often be used to produce parts that vary, sometimes in unanticipated ways, from previous experience, such as for prototyping or modeling. Thus, the use of catalyst behavior as a furnace control can enable a significant enhancement in process performance and avoidance of broken parts or otherwise wasted or unusable product runs.

Furnace effluent generally contains a mix of gases. Particularly in debind, several species can be present and there are therefore several reactions possibly occurring in the catalytic converter. For the sake of illustration, one such reaction is described herein, but the use of the furnace or furnace effluent system is not limited to this illustrative example, and in use, the illustrative example might not even be present in a particular operation. The reaction used here as an example is that of propene and air:

2 C₃H₆+9 O₂→6 CO₂+6 H₂O+Heat

Or, on a per Propene basis: C₃H₆+4.5 O₂→3 CO₂+3 H₂O+Heat

Frequently, the O2 can be supplied by air, which is roughly 20% O2 and 80% N2, so supplying 4.5:1 O2 to propene also supplies 4*4.5=18 N2 per propene, which is a diluent. The stoichiometric air for Propene is thus ˜22.5:1. Using the lower heating value of Propene of 45.3 MJ/kg, the theoretical stoichiometric adiabatic reaction temperature rise is on the order of 1900 C. Given a catalyst/gas starting temperature of 300 C as typical, it is apparent that very high temperatures, leading to failure, can occur in a catalytic converter system. For this reaction, reaction/dilution air on the order of 130:1 (molar or volumetric ratio) is required to keep the temperature in range of safe catalyst operation (based upon 750 C maximum temperature and ignoring heat loss through the sides of the catalytic converter) using the specific heat of the unreacted air as the primary means of reducing the temperature rise. For other reactions the details vary; the system can be designed to accommodate variable conditions, and it is apparent that significant cooling, whether via dilution air or another cooling source, is required for high effluent flow and concentration.

One embodiment of a simply controlled system utilizes a very high dilution air flow heated to the operating point of the catalyst, mixed with the effluent (the order can be reversed) and introduced to the catalyst, where it is reacted and the temperature, due to the high dilution, never exceeds safe operating temperature. In the mixed air ratios described herein, the mixture is typically below the lower explosive limit (LEL) of typical effluent compositions, and if the dilution ratio is raised to 150:1 or greater, the concentration would be further below the LEL of the lowest listed common hydrocarbon herein (Turpentine at 0.7% LEL). As an example case, assuming a design for peak effluent flow rate of 1 Liter/minute and 150:1 dilution ratio, the heater power required to heat the dilution air from room temperature to ˜300 C for catalyst operation is ˜850 W, which is similar to a hair dryer. Additional power can be required to drive the air supply pump, so it is apparent that for an office furnace that operates off a power supply that might be limited to roughly 10 kW, it may be desirable to utilize some of the converter's heat production in a useful manner, such as to provide some of the heater power as shown by the recirculation system of FIG. 13-b. However, in general, debind occurs at low furnace power, so there is power available, and the simple embodiment is practical in most cases as long as sinter ramp (peak furnace power) is not a time requiring peak catalyst flow.

Additional embodiments in which small amounts of air are added to higher amounts of effluent are possible as well. For the case of propene and air, the higher specific heat of propene allows ˜50% reaction air to be added to product a very rich reaction condition which would produce a safe operating temperature and be safely above the Upper Explosive Limit (UEL) of propene. The resulting very hot, mostly unreacted gas exiting can then be cooled and mixed with more air at a similar (slightly higher) air to effluent ratio. This can be repeated in steps as a means of reducing the heater requirements at the expense of complexity, as to operate over a range of conditions, the system can in some embodiments require several temperature feedback loops and flow controls to ensure proper operation. (For example, the mix in air can be reduced as the effluent flow rate is reduced to limit the extent of reaction based upon the amount of reaction air, and appropriately limiting the temperature rise.

In some embodiments of control systems effluent systems presented herein, the control system can relate a flowrate of effluent to a flowrate of reagent/oxidizing agent/air/oxygen, with the flowrates being determined, compared and corrected during operation. In some embodiments, one or more of the flowrates might not be determined or one or more of the flowrates might be implied from other process parameters, such as temperatures, temperature changes, heating rates, heat transfer rates, pressure(s) and the like. In some embodiments, the system(s) presented here can be controlled based upon temperatures, pressures and times, such as where the temperature of the catalyst bed increases within its operating range, the air flowrate (under oxidizer limited operation) can be reduced to control the temperature of the catalyst bed or the effluent flowrate can be reduced (such as by reducing the furnace temperature or be restricting the flow out of the furnace chamber to the catalyst bed) (under effluent limited operation) and increasing the relevant flowrate as the temperature decreases within the operating range.

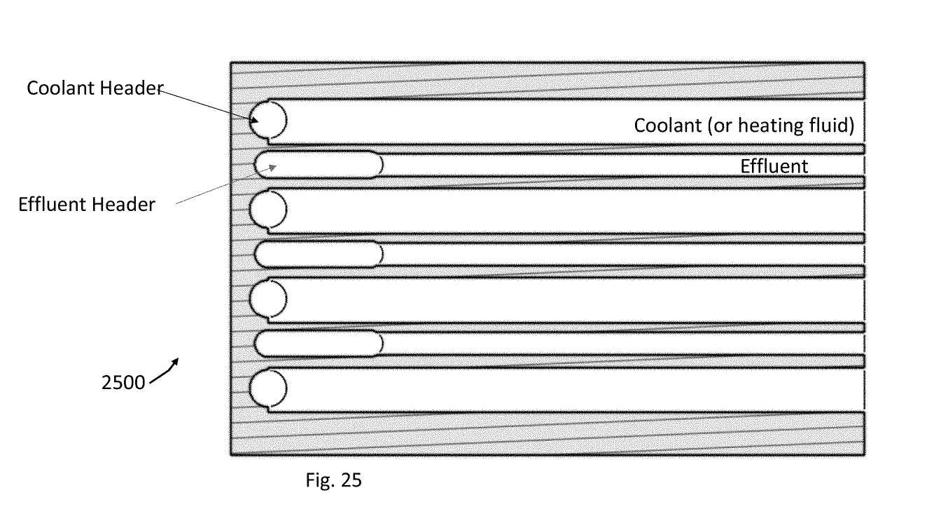

FIGS. 25, 26, and 27 illustrate channel blocks 2500, 2501 in an example embodiment. The channel block 2500 may define a set of catalyst conduits and heating and/or cooling channels, which may be located in close proximity in a support structure of the channel block. Embodiments in which the heating or cooling channels and conversion channels are in close proximity in a supporting structure. The catalyst can be heated or cooled, typically cooled, by the cooling channels. In this embodiment the cooling can be via a gas or liquid or even a conductive solid. The specific geometry need not be as shown.

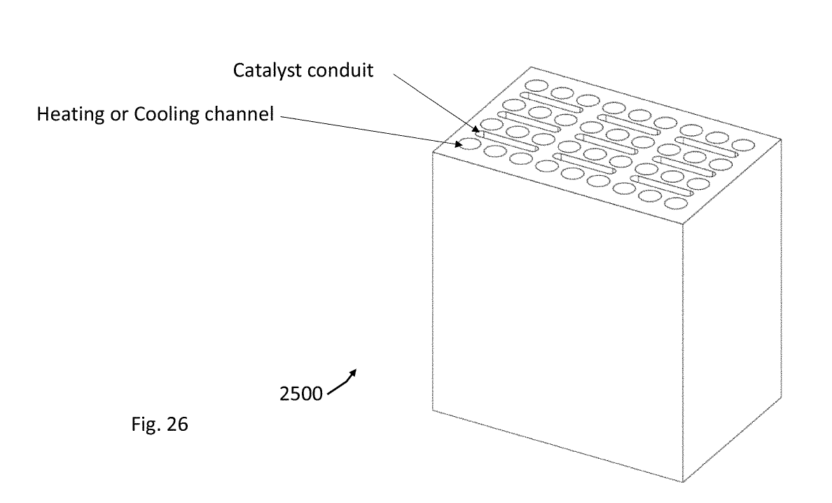

The circular cooling channels shown in the embodiment of FIG. 26 are suited to containing high pressure, such as would be the case for a water based heat pipe, which, to run at 300 C, would need to operate at 1400 psi. A benefit of a heat pipe cooling system is the ability to run high heat transfer rates at a targeted nearly constant temperature, whereas gas, with relatively low Cp, typically will experience a large temperature change to accommodate a large exothermic reaction power. Additional embodiments of catalytic converters with cooling channels interspersed with process channels can utilize phase change to control temperature. An embodiment of an effluent system can incorporate a heat pipe for cooling, and could utilize a working fluid that makes a solid to liquid or gas or liquid to gas transition at a temperature to achieve a desired operating temperature range or as a limit or indicator of operating conditions. For example, an embodiment of a heat pipe or other phase-change cooler can have heat transfer channels incorporating a material that condenses/evaporates at the lower operating limit and can be used to maintain temperature in the operating range when conditions are rapidly changing. An embodiment of a heat pipe or other phase-change cooler can utilize a material that changes phase in the range near the maximum operating point of the catalyst system can provide a stabilizing energy sink, preventing overheating and allowing time for control systems to modify operation to match the changing conditions.

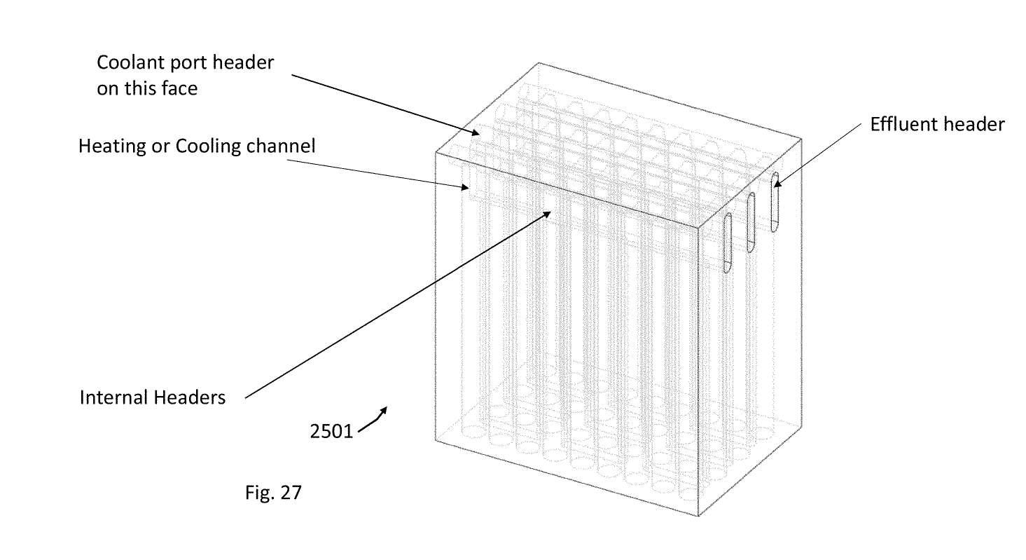

FIG. 27 illustrates the channel block 2501, which includes integrated headers and adjacent flow passages. Additive manufacturing is a means of fabricating such structures with fine features such as built in fins, integrated headers and interleaved flow passages. Additive manufacturing, as well as other methods, allow for porous walls and intermittent mixing zones and high surface area to volume ratios well suited to catalytic converter applications.

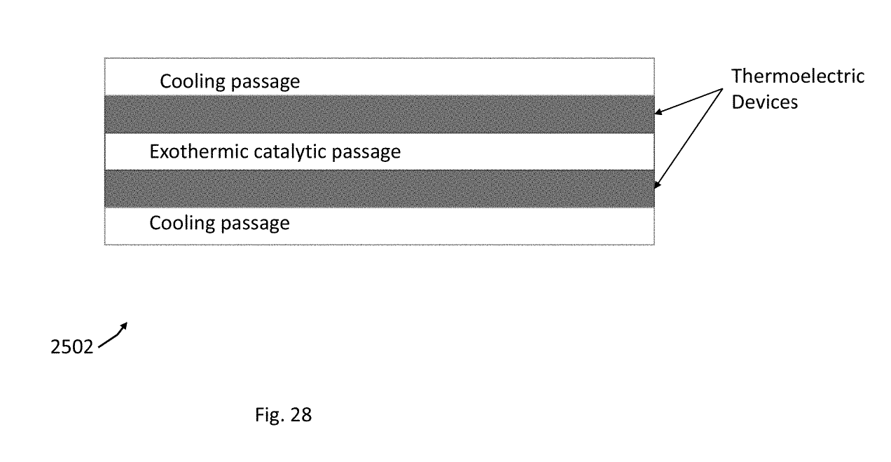

FIG. 28 is a cross-cut side vies of a channel block 2502 in a further embodiment, which incorporates one or more thermoelectric devices between the reaction zone and cooling zone to extract power; however, embodiments of thermoelectric devices can have relatively low efficiency. A typical small furnace might produce 1 to 3 kW or more thermal power in the catalyst of which perhaps 8% could be recovered thermoelectrically. The thermoelectric can also be used to heat the conversion zone to operating temperature, and embodiments of thermoelectric devices can be more efficient as a heater than a cooler, however, frequently other types of heaters can be preferable.

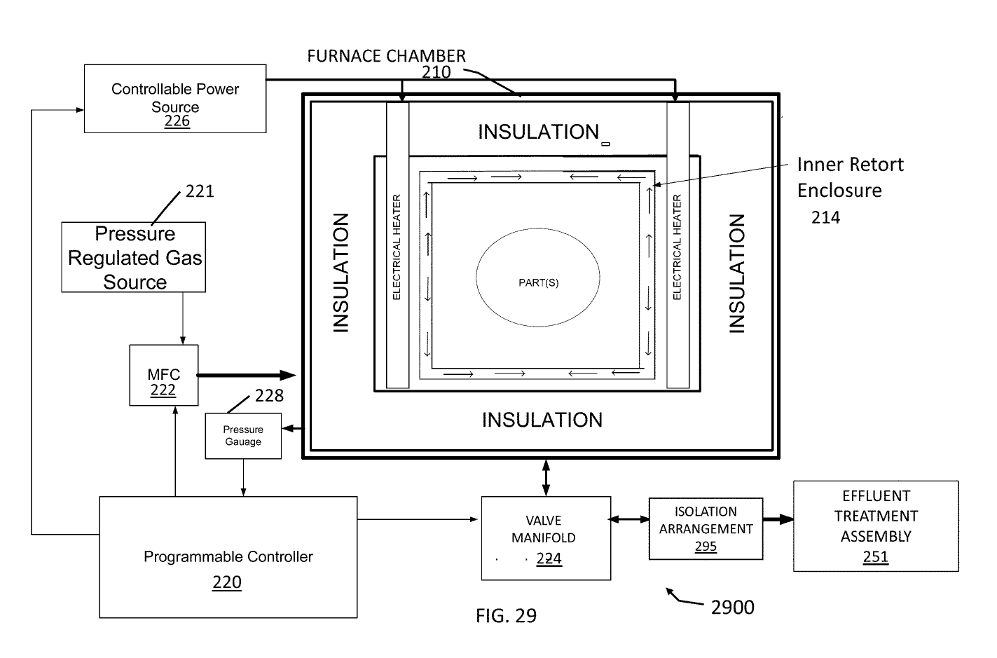

Having described various embodiments of catalytic converters, it is again emphasized that many inert gas and/or controlled atmosphere furnace embodiments (such as tube furnaces and box furnaces) may be configured and/or operated for operation at or near atmospheric pressure and/or positive pressure (as well as under vacuum). FIG. 29 illustrates an embodiment of a metal sintering furnace having no vacuum pump but with an effluent treatment assembly with an isolator arrangement disposed between (i) the furnace chamber and (ii) a first oxygen/air/oxidizer source (at the inlet of the effluent treatment assembly) the isolation arrangement being configured to limit or prevent oxygen (or other oxidizing agent) from traveling upstream (such as by diffusion or by convection, either during passage of gas through the portion of the system between the furnace chamber to a first oxygen/air/oxidizer source or during interruptions of such passage of gas) to the furnace chamber. In some embodiments, the isolation arrangement between the furnace chamber and a first oxygen/air/oxidizer source can be configured to limit or prevent oxygen from traveling upstream to the furnace chamber. As described above, the isolation arrangement can include an isolator, or a plurality of isolators, such as a series arrangement one or more of tube, a choked flow orifice, a porous medium such as a fritted disk or a flow snubber, a valve, a check valve or various displacement or dynamic pumps and/or blowers that may or may not be configured as vacuum pumps. Gas displacement pump embodiments can include piston, diaphragm and/or rotary pumps designed for vacuum or not designed for vacuum, and gas dynamic pump embodiments could include axial flow, mixed flow peripheral, jet and electromagnetic gas pumps, blowers, and can be designed for vacuum or not designed for vacuum. In various embodiments, the flow path between the furnace chamber and a first oxygen/air/oxidizer source can include an isolation arrangement that comprises a reactor such that in operation is configured to react oxygen flowing toward the furnace chamber. In some embodiments, the isolation arrangement can also comprise other features of an isolation arrangement, such as a tube, a valve, or a pump, wherein in operation the isolation arrangement can limit oxygen in the furnace chamber to an acceptable level as discussed herein, and in preferred embodiments, can limit the concentration of oxygen to less than 15 ppm (molar) of oxygen.

For metal powder sintering at or near atmospheric pressure and for operation at positive pressure, various embodiments can include a furnace chamber that is sealed at least sufficiently for maintaining controlled atmosphere having very low oxygen content. For example, many atmospheric, near atmospheric and positive pressure sintering furnaces and processes often are configured to maintain controlled atmosphere with oxygen content of less than 15 ppm. In some embodiments, it is possible to run with higher oxygen content. In various embodiments, a desired oxygen content can be determined based upon various factors such as the type of material to be sintered, but for many applications it can be desirable to operate with an oxygen level less than 100 ppm. For a sealed chamber with an isolation arrangement between a sealed furnace chamber and a first oxygen/air/oxidizer source, the quality of desired sealing may depend at least in part on an amount of processing gas flow such that for lower gas flow better sealing may be required to maintain sufficiently low oxygen content.

FIG. 29 is a block diagram of a furnace system 2900 in a further embodiment. The furnace system 2900 may include one or more features of the furnace systems described above, and particularly the furnace systems 400-402 described above with reference to FIGS. 4A-4C. The furnace system 2900 may include an isolation arrangement 295, comparable to one or more of the isolation arrangements described above, which carries effluent to an effluent treatment assembly 251. The effluent treatment assembly 251 can include at its inlet various ones of the embodiments described above that include air injection including but not limited to those provided in FIG. 13A, 13B, 13C, 14A and 14B.

The catalysts described herein can be regarded as oxidizing and/or oxygen catalysts least for the reason that these embodiments utilize oxygen as a reagent (or that they catalyze oxidation of the process stream). Similarly, while the terms of art are not utterly uniform, persons of ordinary skill in the art can refer to the catalytic converters described herein as oxidizing catalytic converters and/or oxygen catalytic converters. This particular terminology can, in some cases, be adopted to distinguish a given catalyst and/or catalytic converter from other categories such as “reducing” catalysts that do not necessarily employ or rely upon oxygen as a reagent (or that they catalyze reduction of the process stream). In this regard many of the embodiments described above can be regarded as oxygen catalytic converters. In the nonvacuum embodiments described above a sealed furnace chamber can be configured to receive a process gas for sintering metal parts while employing an oxidizing catalyst to catalyze reaction of the exhaust that has passed from the furnace chamber to the catalyst through an isolating arrangement disposed therebetween and configured to sufficiently isolate the furnace from oxygen that is injected into the oxygen catalyzer for maintaining oxygen content at or below a desired concentration. It is noted that in the context of vacuum and/or partial pressure furnaces that utilize a vacuum pump, that vacuum pump can be considered and/or described as an isolation arrangement in that it prevents and/or restricts back flow of oxygen from a catalyzer to an associated sintering furnace chamber to maintain the oxygen level within the furnace chamber below a desired level.

Additionally, in some embodiments described herein, a furnace can be run at positive or negative pressure during one or more portions of the operation or during the entirety of the operation, and/or can be manually or automatically reconfigured to operate at atmospheric and/or positive pressure. Reconfiguring could include permanently or semi-permanently removing components (such as a vacuum pump) or it could include using system of valves to isolate a vacuum pump while re-routing exit flow through some other arrangement such as an isolation arrangement. Some embodiments described herein with a vacuum pump can be operated at atmospheric or higher pressure. For example, the embodiment of FIG. 3 incorporates a vacuum pump and utilizes positive chamber pressure during the cooling cycle as part of the normal operational cycle. In this and many of the other embodiments shown, it is also possible to configure the system without a vacuum pump.

In some embodiments, non-vacuum operation could be desired for a variety of reasons for one or more portions of a processing cycle or for the entirety of processing cycle. As an example of one process embodiment, post-process cooling can be accelerated by operation at positive pressure to enhance heat transfer. Although embodiments described herein at times refer to equipment in reference to a particular pressure regime (e.g. vacuum furnace) or to operation occurring at a particular pressure regime (e.g. vacuum, pressure, atmospheric, near atmospheric), it should be understood that this disclosure includes the equipment being related to and the operation occurring at other pressure regimes as well, such as at atmospheric pressure (such as where the relevant equipment is utilized at or the processing step occurs at atmospheric pressure), at positive pressure (such as where the relevant equipment is utilized at or the processing step occurs at pressures above atmospheric pressure), under vacuum (such as where the relevant equipment is utilized at or the processing step occurs at pressures below atmospheric pressure), and at near-atmospheric pressure (such as where the relevant equipment is utilized at or the processing step occurs within a range of a slight vacuum to a slight positive pressure, and therefore near-atmospheric systems and operation can overlap with the other pressure regime designations), and the other pressure regimes can be implemented into the embodiments described herein and the embodiments described herein can utilize these other pressure regimes.

For example, it should be appreciated that a single given system with one single furnace chamber could be configured to operate in two or more modes of operation with each mode operating in accordance with different embodiments described above. For example, a system of valves and tubing can serve as part of an overall gas and vacuum manifold such that the same furnace could be operated at times as a vacuum furnace including a vacuum pump, and at other times as an atmospheric and/or positive pressure furnace such as the furnace system 2900 of FIG. 29. This system 2900 could, in some cases, be controllably toggled from one of the aforementioned modes of operation during the course of a single processing run. For example, a system could be configured and operated in an atmospheric pressure mode during thermal debinding and then for at least a portion of a subsequent sintering cycle could be configured and operated in a vacuum sintering mode of operation.

A number of embodiments described above include blowers or pumps to push air or effluent into and through catalysts. Further embodiments may implement other solutions for moving the air and/or effluent. The pressure difference required to produce flow can be produced by a blower or pump at the exit which allows air or effluent to be pulled into the active regions in a distributed manner. Means of achieving pressures for flow include fans, blowers, pumps, positive displacement pumps, chimney effect, vortex devices (pumps, heaters, coolers), and venturi pumps.

Further, more than one catalytic converter can be used. For example, a first catalytic converter, such as a small catalytic converter, can be used at low flow rates while a second catalytic converter, such as a larger catalytic converter can be used at high flow rates. The outflow from the first converter can be used as a heat source for the second catalytic converter. In some embodiments, the entire flow can pass through the first and second catalytic converters in sequence, and in some embodiments a portion of the flow can pass through the first catalytic converter and a portion of the flow bypasses the first catalytic converter and is combined with the exhaust from the first catalytic converter for processing in the second catalytic converter.

### First Stage Reactor

In some embodiments, a first stage reactor can be located upstream of the catalytic converter to provide a location for a first stage of reaction. In some such embodiments, the first stage reaction chamber can be fed with a combination of effluent and a reagent such as an oxidizing agent (such as air or oxygen), which under conditions present within the first stage reaction chamber react with one another to convert at least a portion of the effluent to other molecules.

In some embodiments of a first stage reactor, the first stage reactor can be heated to a temperature that allows at least a portion of the effluent to react with the reagent. In various such embodiments, the effluent and/or the reagent can be heated to temperature(s) where the mixture of reagent and effluent will react. In some embodiments, a heater can be present within the first stage reactor that provides a heated surface of an appropriate temperature to allow reaction of the effluent and the reagent. In some embodiments of a heater with a heated surface in contact with the reagent and/or effluent, the temperature of the heated surface is sufficient to react at least a portion of the effluent and reagent when in the vicinity of or in contact with the heated surface, but the heat input from the heater is not sufficient to heat the entire mixture of effluent and reagent to a temperature to sustain the reaction, resulting in a localized reaction.

In a preferred embodiment of a first stage reactor, the heater can be a resistive heating element with a surface temperature of the resistive heating element of about 400-500 C, 500-600 C, 600-700 C, 700-800 C, 800-900 C, or higher. In some such embodiments, the surface temperature is sufficient to react oxygen with a hydrocarbon or a halogenated organic compound present in the effluent. In some embodiments, the hydrocarbon can be propylene. In some embodiments, the halogenated organic compound can be a component of a solvent used for chemical debinding of parts being processed in the furnace. In some embodiments, the first stage reactor reacts at least a portion of a halogenated organic compound present in the effluent to reduce the potential or actual poisoning (or reduction in activity) of the catalyst present in the catalytic converter.

### Catalyst Regeneration

In some embodiments of effluent processing systems for furnaces, when in use some compounds present in the effluent can reduce the activity of the catalyst present in the catalytic converter. Various types of compounds that can result in reduction of activity can include halogenated organic compounds, organosulfur compounds, metalorganic compounds, and/or compounds that deposit on the surface of the catalyst. In some embodiments of processing parts in a furnace, such as additive manufactured parts, it can be desirable to utilize a compound that can reduce the activity or poison the catalyst present in an effluent treatment system for a furnace. In some such situations, it can be desirable for some embodiments to utilize a material, such as a solvent, in a chemical debinding step that comprises a compound that can reduce the activity of or poison the catalyst. In some particular embodiments, the material can comprise a halogenated organic compound. In such situations, there can be carryover of the activity reducing material. In some situations, an activity reducing material can be a part of the binder or can be present in the parts loaded into the furnace for other reasons, or can be present in the furnace for reasons other than being associated with the parts.

In particular embodiments of processes for processing parts in a furnace, the furnace can be operated to transfer most or all or substantially all of the activity reducing material to the effluent in one processing step and to transfer a substantial portion of the hydrocarbon (or non-activity reducing compounds) in another step.

In various embodiments of such processes, the step with the activity reducing material can be followed by the step with the hydrocarbon (or non-activity reducing compounds). In some further embodiments, the furnace operation can be controlled to limit the concentration (or partial pressure) of the activity reducing material in order to limit the extent of activity reduction that occurs to the catalyst. In some embodiments, the furnace operation can be controlled to provide a sufficiently high concentration (or partial pressure) of hydrocarbon (or non-activity reducing compounds) to at least partially regenerate the catalyst activity reduced by the activity reducing material. In some embodiments, the step with hydrocarbon or non-activity reducing compounds that follows the step with activity-reducing material can be in a process cycle that takes place after the process cycle with the activity-reducing material and with a different load of parts in the furnace.

In further embodiments, the example embodiments described above can be configured according to other configurations and operational parameters. For example, by increasing the size of the catalyst and the quantity of dilution air, the catalyst may be able to catalyze any quantity of effluent. In such a configuration, a powered heater can heat the air and effluent. Alternatively, the effluent production rate can be made to fit the catalyst by utilizing control of furnace parameters. For example, the catalyst properties (e.g., temperature) may be monitored as an indication of the catalyst state. Optionally, the catalyst properties may be compared with other parameters to determine the health of the catalyst system, and. For example, too great a mismatch between measured and modeled behavior may indicate a system health issue.

In still further embodiments, the effluent may be stopped and stored (e.g., in furnace or elsewhere, such as a receiver, trap, or in plumbing), and then may be run through the catalyst in pulses so that the catalyst can cool between pulses. The catalyst may be run in a rich burn mode, which can reduce the catalyst heater power requirement. Other cooling means may be implemented base on catalyst geometry. For example, embodiments can utilize heat pipes or other cooling systems in between catalyst sections to reduce temperature. A catalyst bed may be implemented at a first stage of an effluent treatment assembly, where the catalyst bed is configured to limit the extent of reaction (such as reaction due to reduced catalytic area and time in contact with the catalyst) at high effluent concentrations such that the extent of reaction in this first stage is not sufficient to surpass a high threshold temperature. Dilution air may then be added to reduce the temperature followed by one or more additional stages of catalytic reaction. Further, multiple catalytic converter systems may be implemented in series and/or parallel to accommodate the full range of furnace operating modes.

### EXAMPLE

### “Office Friendly” Vacuum Furnace

Shown in FIG. 3 is an embodiment of an “office-friendly” furnace 300 that can be configured for vacuum operation. In various embodiments of an “office-friendly” furnace, various effluent systems and various pressure operation profiles such as those described herein (vacuum, atmospheric, near atmospheric, positive pressure) can be used. In addition, various embodiments of systems for limiting oxygen concentration (or partial pressure) in the furnace chamber, such as the isolation arrangements described herein can be used as well as the various effluent systems described herein. In one embodiment, the effluent system 1102 shown schematically in FIG. 11C was used with the “office-friendly” furnace 300 and operated through a cycle to produce the plots shown in FIGS. 23 and 24, with the operation described above.

In some embodiments of the “office-friendly” furnace, the furnace can be configured with a leak tight welded steel furnace chamber 32″×25″×25″ with 5″ of ceramic and/or graphite fiber board insulation arrangement, although in some embodiments, the dimensions can be varied and the amount of insulation can be varied. In some embodiments, an “office-friendly” furnace size can be limited by the size of the doorway through which a furnace will need to pass, such as a single door or a double door, the height of the doorway, or the load bearing rating of the floor. The major opening of the furnace can be sealed with a vacuum grade elastomeric O-ring and/or gasket or by other suitable means. Minor openings can be sealed using standard KF and/or CF flanges using vacuum grade O-rings, such as viton O-rings and/or metal gaskets such as copper gaskets and/or by other suitable means. In some embodiments, the furnace chamber can include a water cooling system, such as a closed cycle water cooling system, to maintain furnace chamber wall temperatures below 200 C. A vacuum manifold can be utilized having manually, electrically and/or pneumatically controlled valves sealed utilizing suitable connections, such as KF or CF flanges and/or flanges of a different design, and can be sealed with vacuum grade O-rings, such as Viton, or other suitable seals. In some embodiments, the hot zone temperature can be up to 1500 C. The size chamber stated above, can have a work zone volume of 8″×10″×14″ and can utilize a graphite retort having optional removable shelves that can support one or more brown parts (processed by chemical debind but not yet thermally debound) with a loading ranging of from 0.1 Kg to 6 Kg of brown parts.

Operation of the furnace can be customized for different time-temperature profiles with process gas added at particular times at particular flowrates, depending upon the materials of the parts being processed, the total load of parts, and the dimensions of the parts, such as the part thickness and the part surface area (or specific surface area, surface area divided by mass or volume).

In one embodiment of an “office-friendly” furnace, with dimensions as shown above, the furnace can be operated according to the profile shown in and described for FIGS. 23 and 24. In additional embodiments of the operation of an “office-friendly” furnace, the times and temperatures and pressures can be varied to achieve such things as a desired thermal debind rate, sintering of particles into a solid part, and carbon reduction.

For one embodiment of an operation for stainless steels, the furnace profile can have temperature setpoints as follows:
a) Thermal Debind, temperature ramped from 200 C to 550 C, with a 2 hr hold at 550 C
b) Sinter temperature ramp from 550 C to 1360 C, with an intermediate hold for 1 hr at 1100 C and peak hold for 2 hr at 1360 C
c) Cool down from 1360 C to 200 C, with a backfill of the occurring below 1000 C to decrease time to cool to room temperature

Process gas flow rate can typically be between 0.1-1 slpm of forming gas (97% Ar, 3% H₂) as the process gas during different portions of the furnace profile, with the addition of hydrogen aiding in the reduction of carbon. In additional embodiments, higher hydrogen content can be utilized, and in some particular embodiments, higher hydrogen content (in some cases, up to 100% hydrogen) can provide improved product characteristics over lower concentrations of hydrogen. In some embodiments of hydrogen concentration, it can be desirable to provide isolation or destruction of hydrogen vented from the system, and system design and/or operation can be modified to reduce risks associated with hydrogen gas.

In some embodiments of the operation of an “office-friendly” furnace, the utilization of of process gas can be varied based upon the size of the load of parts placed into the furnace for processing. Two such embodiments are shown below for the furnace with dimensions shown above:
a) Load Size 1—any loads below 3 kg of brown parts
   i. flow rate is set at 0.4 slpm during sinter ramp and holds
   ii. flow rate of 0.2 slpm during cool down, until backfilling to positive pressures (930 torr)
b) Load Size 2—above 3 kg and up to a maximum load of 6 kg
   i. flow rate of 0.7 slpm during sinter ramp and holds
   ii. flow rate of 0.2 slpm during cool down, until backfilling to positive pressures (930 torr)

However, in some embodiments, the conditions for Load Size 2 can also be utilized for loads of up to 3 kg (Load Size 1).

For all portions of the furnace profile, the operation can maintain the pressure inside the chamber below 2 torr, with the actual pressure typically in the range of 0.1-0.5 torr, and being limited by the vacuum pump capability. Pressure deviations above 10 torr should be avoided. Generally, a two stage rotary vane oil pump of an appropriate size can be used to achieve the desired flowrate (process gas and/or effluent gas). In some embodiments, an Edwards RV2, or an RV8 or an RV12 (Edwards Vacuum LLC, Sanborn, N.Y., USA) can be used as well as equivalents to these.

In some embodiments, the thermal debinding can occur under vacuum and with no process gas flowing. In additional embodiments, process gas can be used during thermal debind (during the entire step or just portions of the debinding step), such as to assist in sweeping out the effluent/debind products and/or to provide greater control over carbon content and uniformity, at various rates, such as from 0.05-0.2 slpm with a preferred rate at approximately 0.1 slpm.

In some embodiments, the flow rate of process gas can be increased or decreased depending upon the size of the reservoir being used. In some embodiments, somewhat higher gas flow rates can provide improved product quality, such as by improving the appearance and other properties of sintered parts. In some embodiments, flowrates can be increased by an order of magnitude or even somewhat higher.

For tool steels and mid-carbon alloy steels, the operational parameters can be those for stainless steel shown above, except that the process gas can be nitrogen or another inert gas and generally does not include hydrogen in order to preserve the carbon within the material.

In some embodiments of furnaces, including furnaces that are larger or smaller than an “office-friendly” furnace describe above, the flow rates can be scaled, such as proportionally to the relative sizes of the furnaces, or the gas-fillable spaces of the furnaces or the working volumes of the furnaces. In some embodiments the gas flow rate can be scaled based upon the size or dimensions of the load in the furnace.

The effluent rates and volumes can vary with different loads in the furnace. For example, generally, a larger load can lead to a greater amount of effluent and a higher rate of production. However additional factors can also affect the rate of effluent production such as the number, size, and surface area of the parts in the furnace, when the total mass of the load is held constant. For a similar net mass in the furnace, many small parts will generally have a greater surface area and faster heating, and can result in faster effluent production than fewer large parts of similar net mass. The net debind product for equal masses can be equal, but the difference in surface area and heating can cause a higher effluent production rate and therefore can in some cases benefit from a reduction in the size of the load to reduce the rate of effluent production to allow for better control of the effluent system, or to interrupt the heating ramp of the debind portion of the cycle to slow the rate of effluent production, such as to protect the catalyst from over temperature operation, while fewer large parts generally require lower ramp rate to allow for the poor heat transfer and the resulting effluent flow is more spread out over time.

Furnace loads less than 3 kg can generate less effluent. For some furnace loads, the operation of the furnace can vary from that described for the test run of FIG. 23, such as with some loads (e.g. some small loads) allowing completion of the debind heating ramp without interruption of the cycle with a ramp hold for catalyst protection, or with some combinations of furnace loads and furnace operation where the effluent on its own will not provide sufficient energy to maintain the temperature of the catalyst without operation of the heater, or with some furnace loads (e.g. small loads), the effluent rate will be sufficiently low to avoid the need to increase the air flowrate during debinding, or with some large or high surface area loads, a longer interruption of the debind ramp or multiple interruptions can be required, or in some embodiments, effluent flow during sintering can require an interruption of the sintering ramp to avoid overheating the catalyst.

For operation at atmospheric pressure, near-atmospheric pressure, or positive pressure, a similar operation as that described above can be utilized, except that, in some embodiments, the flow rate of the process gas can be somewhat higher, such as with a flow rate of about 5 slpm during the sinter ramp and hold, with the other flowrate(s) being scaled accordingly. As with the vacuum operation, some embodiments will have improved quality for higher process gas flow rates, and in some embodiments, rates up to an order of magnitude higher and even somewhat higher can also be successfully employed.

While example embodiments have been particularly shown and described, it will be understood by those skilled in the art that various changes in form and details may be made therein without departing from the scope of the embodiments encompassed by the appended claims.

What is claimed is:

1. A materials processing furnace, comprising:
a sintering chamber configured to maintain a controlled atmosphere, the controlled atmosphere being substantially free of oxygen;
an exhaust assembly configured to 1) evacuate effluent from the sintering chamber, the effluent including at least one compound produced by sintering an object within the sintering chamber, and 2) limit oxygen backflow from the exhaust assembly into the sintering chamber; and
an oxidizing catalyst configured to 1) receive a mixed gas comprising the effluent and oxygen, and 2) catalyze the at least one compound.

2. The furnace of claim 1, wherein the exhaust assembly includes a vacuum pump configured to evacuate the effluent from the sintering chamber, the evacuating contributing to limiting the oxygen backflow.

3. The furnace of claim 1, wherein the controlled atmosphere has a pressure of approximately 1 atm.

4. The furnace of claim 1, wherein the controlled atmosphere has a pressure of greater than 1 atm.

5. The furnace of claim 1, wherein the exhaust assembly includes a channel configured to convey the effluent at a range of flow rates, the channel having a length and cross-sectional area sufficient to limit the oxygen backflow by preventing the oxygen backflow during the evacuation of the effluent at least for the range of flow rates.

6. The furnace of claim 1, further comprising a process gas injection arrangement configured to inject a process gas into the sintering chamber, the exhaust assembly evacuating the process gas with the effluent from the sintering chamber.

7. The furnace of claim 1, wherein the exhaust assembly includes an isolator configured to 1) convey the effluent from an entrance to the exhaust assembly toward the catalyst, and 2) limit the oxygen backflow by preventing flow of the mixed gas into the sintering chamber.

8. The furnace of claim 1, wherein the controlled atmosphere has an oxygen content below 1000 ppm.

9. The furnace of claim 1, wherein the controlled atmosphere has an oxygen content below 100 ppm.

10. The furnace of claim 1, wherein the controlled atmosphere has an oxygen content below 10 ppm.

11. The furnace of claim 1, wherein the controlled atmosphere has an oxygen content below 1 ppm.

12. The furnace of claim 1, further comprising an injector configured to add the oxygen to the effluent to form the mixed gas.

13. The furnace of claim 1, further comprising a heater configured to heat the mixed gas prior to entry into the oxidizing catalyst.

14. The furnace of claim 13, further comprising a controller configured to control the heater as a function of a temperature of the mixed gas before entry into the oxidizing catalyst.

15. The furnace of claim 14, wherein the controller is further configured to detect the temperature of the mixed gas based on a measured property of a heating element of the heater.

16. The furnace of claim 1, further comprising an insulated housing at least partially encompassing the oxidizing catalyst.

17. The furnace of claim 1, further comprising a vacuum pump having a pump inlet into which the effluent is evacuated, a pump outlet, and a ballast arrangement disposed therebetween, the ballast being configured to introduce ballast gas including the oxygen within the pump.

18. The furnace of claim 1, further comprising:
a gas sensor configured to detect a quantity of oxygen in the mixed gas; and
a flow controller configured to control a volume of the oxygen added to the effluent as a function of a quantity of the oxygen detected by the gas sensor.

19. The furnace of claim 1, further including a condensate trap configured to condense and collect at least one binding agent from the effluent.

20. The furnace of claim 19, further comprising a flow controller configured to selectively direct the effluent through the condensate trap.

21. The furnace of claim 1, further comprising at least one filter configured to trap at least one additional compound of the effluent.

22. The furnace of claim 1, further comprising a vacuum pump is configured to output the effluent at a maximum rate of 2 CFM.

23. The furnace of claim 1, further comprising a vacuum pump configured to receive the effluent at a temperature of less than 300 C.

24. The furnace of claim 23, further comprising a heater configured to increase the temperature of the mixed gas to at least 200 C.

25. The furnace of claim 1, further comprising a heater configured to heat the oxygen prior to addition to the effluent.

26. The furnace of claim 1, wherein the oxidizing catalyst is configured to receive the mixed gas at a temperature of less than 50 C and catalyze the at least one compound.

27. The furnace of claim 1, wherein the oxidizing catalyst is a first oxidizing catalyst, and further comprising a second oxidizing catalyst configured to receive the effluent before the effluent is mixed with the oxygen.

28. The furnace of claim 1, further comprising a controller configured to adjust a temperature of the controlled atmosphere based on a temperature at the oxidizing catalyst.

29. The furnace of claim 1 further comprising a catalytic converter including the oxidizing catalyst, the catalytic converter being configured to store the oxygen and release the oxygen into the effluent.

30. A catalytic converter, comprising:
an entrance channel configured to receive an effluent from a furnace;
a heater configured to heat the effluent;
a catalyst channel in fluid communication with the entrance channel and configured to 1) receive a mixed gas comprising the oxygen and the effluent and 2) catalyze at least one compound of the effluent, the catalyst channel conducting heat from the entrance channel via a lateral edge adjacent to the entrance channel and the catalyst channel; and
an outlet configured to expel an exhaust gas from the catalyst channel.

31. The catalytic converter of claim 30, wherein the catalyst channel extends parallel to a lateral portion of the entrance channel.

32. The catalytic converter of claim 31, wherein the catalyst channel surrounds the lateral portion of the entrance channel.

33. The catalytic converter of claim 30, wherein the catalyst channel includes:
an inner channel extending adjacent to the entrance channel at the lateral wall; and
an outer channel extending adjacent to the inner channel at an outer wall opposite of the lateral wall.

34. The catalytic converter of claim 33, wherein the inner channel includes a first catalyst to catalyze the at least one compound of the effluent.

35. The catalytic converter of claim 34, wherein the outer channel includes a second catalyst to catalyze an additional compound of the effluent.

36. The catalytic converter of claim 33, wherein the outer wall is further configured to conduct heat from the inner channel to the outer channel.

37. The catalytic converter of claim 33, wherein the inner channel directs the mixed gas in a first direction parallel to the lateral wall, and wherein the outer channel directs the mixed gas in a second direction opposite of the first direction.

38. The catalytic converter of claim 30, further comprising an insulated housing encompassing the heater and the catalyst.

39. The catalytic converter of claim 30, wherein the catalytic converter includes a catalyst upstream of the oxygen injection point.

40. The catalytic converter of claim 30, further comprising an exhaust assembly configured to 1) evacuate the effluent from the furnace to the entrance channel, and 2) limit oxygen backflow from the exhaust assembly into the furnace.

41. A catalytic converter, comprising:
an inner channel configured to receive a mixed gas including an effluent from a furnace and oxygen;
a heater configured to heat the mixed gas in the inner channel;
a catalyst configured to catalyze at least one compound of the effluent in the inner channel;
an outer channel surrounding at least a portion of the inner channel; and
an outlet configured to expel an exhaust gas from the outer channel.

42. The catalytic converter of claim 41, wherein the outer channel directs the exhaust gas along at least a portion of a wall common to the inner channel and outer channel.

43. The catalytic converter of claim 41, wherein the outer channel directs the exhaust gas in a direction counter to a direction of the mixed gas through the inner channel.

44. The catalytic converter of claim 41, wherein the outer channel forms a shell around the inner channel and defines a volume adjacent to the inner channel, and wherein the outer channel directs the exhaust gas substantially away from the volume and toward the outlet.

45. The catalytic converter of claim 41, further comprising an exhaust assembly configured to 1) evacuate the effluent from the furnace to the entrance channel, and 2) limit oxygen backflow from the exhaust assembly into the furnace.
